(19) United States
(12) Patent Application Publication
(10) Pub. No.: US 2021/0266535 A1
(43) Pub. Date: Aug. 26, 2021

(54) DATA PROCESSING APPARATUS AND DATA PROCESSING METHOD

(71) Applicant: SONY CORPORATION, TOKYO (JP)

(72) Inventors: TAKURO KAWAI, TOKYO (JP); KENICHIRO HOSOKAWA, TOKYO (JP); KEISUKE CHIDA, TOKYO (JP); TAKAHIRO NAGANO, TOKYO (JP)

(21) Appl. No.: 17/045,354

(22) PCT Filed: Mar. 28, 2019
(86) PCT No.: PCT/JP2019/013533

§ 371 Date: Oct. 5, 2020

(30) Foreign Application Priority Data
Apr. 11, 2018 (JP) 2018-075806

(51) Int. Cl. H04N 19/117; H04N 19/82; H04N 19/159; H04N 19/182

(52) U.S. Cl. CPC H04N 19/117; H04N 19/182; H04N 19/159; H04N 19/82

(57) ABSTRACT

The present technology relates to a data processing apparatus and a data processing method that make it possible to perform a filter process having a high degree of freedom. A coefficient conversion section converts a first filter coefficient into a second filter coefficient different from the first filter coefficient. A filter section performs a filter process using the second filter coefficient. The present technology can be applied to a filter and so forth by which a filter process, for example, of an image or sound is performed.

### TECHNICAL FIELD

The present technology relates to a data processing apparatus and a data processing method and particularly to a data processing apparatus and a data processing method that make it possible to achieve a filter process having a high degree of freedom, for example.

### BACKGROUND ART

Work for starting standardization of FVC (Future Video Coding) as a successor standard of HEVC (High Efficiency Video Coding) is being proceeded, and, as an ILF (In Loop Filter) to be used for prediction encoding (encoding for encoding residuals between an image and a prediction image of the image) and decoding of an image, a bilateral filter (Bilateral Filter) and an ALF (Adaptive Loop Filter) are examined in addition to a deblocking filter and an adaptive offset filter (for example, refer to NPL 1).

Further, as a filter for improving an existing ALF, a GALF (Geometry Adaptive Loop Filter) is proposed (for example, refer to NPL 2).

### CITATION LIST

### Non Patent Literature

### [NPL 1]

Algorithm description of Joint Exploration Test Model 7 (JEM7), 2017 Aug. 19

### [NPL 2]

Marta Karczewicz, Li Zhang, Wei-Jung Chien, Xiang Li, “Geometry transformation-based adaptive in-loop filter,” IEEE Picture Coding Symposium (PCS), 2016.

### SUMMARY

### Technical Problem

For existing ILFs and other filters, there is a demand for performance of a filter process having a high degree of freedom.

The present invention has been made in view of such a situation as just described and makes it possible to perform a filter process having a high degree of freedom.

### Solution to Problem

The first data processing apparatus of the present technology is a data processing apparatus including a coefficient conversion section configured to convert a first filter coefficient into a second filter coefficient different from the first filter coefficient and a filter section configured to perform a filter process by using the second filter coefficient.

The first data processing method of the present technology is a data processing method including converting a first filter coefficient into a second filter coefficient different from the first filter coefficient and performing a filter process by using the second filter coefficient.

In the first data processing apparatus and data processing method of the present technology, a first filter coefficient is converted into a second filter coefficient different from the first filter coefficient, and a filter process is performed using the second filter coefficient.

The second data processing apparatus of the present technology is a data processing apparatus including a coefficient conversion section configured to convert a tap coefficient included in a prediction expression that is a polynomial for predicting second data from first data into a seed coefficient included in a coefficient approximate expression that is a polynomial for approximating the tap coefficient, and a filter section configured to perform a filter process for applying, to data, a prediction expression for performing a product sum calculation with the tap coefficient obtained from the coefficient approximate expression including the seed coefficient.

The second data processing method of the present technology is a data processing method including converting a tap coefficient included in a prediction expression that is a polynomial for predicting second data from first data into a seed coefficient included in a coefficient approximate expression that is a polynomial for approximating the tap coefficient and performing a filter process for applying, to data, a prediction expression for performing a product sum calculation with the tap coefficient obtained from the coefficient approximate expression including the seed coefficient.

In the second data processing apparatus and data processing method of the present technology, a tap coefficient included in a prediction expression that is a polynomial for predicting second data from first data is converted into a seed coefficient included in a coefficient approximate expression that is a polynomial for approximating the tap coefficient and a filter process for applying, to data, a prediction expression for performing a product sum calculation with the tap coefficient obtained from the coefficient approximate expression including the seed coefficient is performed.

It is to be noted that the first data processing apparatus and the second data processing apparatus may individually be an independent apparatus or may individually be an internal block configuring one apparatus.

Further, the first data processing apparatus and the second data processing apparatus can be implemented by causing a computer to execute a program. The program can be provided by transmission through a transmission medium or by recording on a recording medium.

### Advantageous Effect of Invention

With the present technology, a filter process having a degree of freedom can be achieved.

It is to be noted that the effect described here is not necessarily limitative, and any effect described in the present disclosure may be provided.

### BRIEF DESCRIPTION OF DRAWINGS

FIG. 1 is a block diagram depicting an example of a configuration of a classification prediction filter.

FIG. 2 is a view illustrating a classification prediction process in which tap coefficients having different levels of performance are used.

FIG. 3 is a view illustrating a classification adaptive filter in which a filter section is implemented by a flexible hardware configuration.

FIG. 4 is a view illustrating a method for calculating a conversion coefficient for converting a certain tap coefficient into a different tap coefficient.

FIG. 5 is a view illustrating coefficient conversion for converting a tap coefficient PA into (a prediction value of) a tap coefficient PB by using the conversion coefficient.

FIG. 6 is a view illustrating a classification prediction process using a tap coefficient PB′ obtained using the conversion coefficient.

FIG. 7 is a view illustrating an overview of the classification prediction filter as a data processing apparatus to which the present technology is applied.

FIG. 8 is a view illustrating conversion coefficient learning and coefficient conversion using a conversion coefficient obtained by the conversion coefficient learning.

FIG. 9 is a view illustrating a coefficient conversion expression for converting a tap coefficient PA into a tap coefficient PB having the number of taps different from that of the tap coefficient PA.

FIG. 10 is a view illustrating a coefficient conversion expression for converting a tap coefficient PA into a tap coefficient PB included in a prediction expression different from that configured using the tap coefficient PA.

FIG. 11 is a view illustrating a coefficient conversion expression for converting a tap coefficient PA into a tap coefficient PB′ having the number of classes different from that of the tap coefficient PA.

FIG. 12 is a view illustrating a coefficient conversion expression when a tap coefficient PA is converted into (a prediction value of) a seed coefficient β.

FIG. 13 is a block diagram depicting an example of a detailed configuration of a classification prediction filter 30.

FIG. 14 is a flowchart illustrating a process of the classification prediction filter 30.

FIG. 15 is a block diagram depicting a first example of a configuration of an image processing system to which the classification prediction filter 30 is applied.

FIG. 16 is a block diagram depicting an example of a detailed configuration of an encoding apparatus 101.

FIG. 17 is a block diagram depicting an example of a detailed configuration of a decoding apparatus 102.

FIG. 18 is a block diagram depicting a second example of a configuration of an image processing system to which the classification prediction filter 30 is applied.

FIG. 19 is a block diagram depicting an example of a detailed configuration of an encoding apparatus 401.

FIG. 20 is a block diagram depicting an example of a detailed configuration of a decoding apparatus 402.

FIG. 21 is a block diagram depicting a third example of a configuration of an image processing system to which the classification prediction filter 30 is applied.

FIG. 22 is a block diagram depicting an example of a configuration of a decoding apparatus 531.

FIG. 23 is a block diagram depicting a fourth example of a configuration of an image processing system to which the classification prediction filter 30 is applied.

FIG. 24 is a block diagram depicting a fifth example of a configuration of an image processing system to which the classification prediction filter 30 is applied.

FIG. 25 is a block diagram depicting a sixth example of a configuration of an image processing system to which the classification prediction filter 30 is applied.

FIG. 26 is a view illustrating filter controlling information regarding a filter process as a classification prediction process.

FIG. 27 is a block diagram depicting an example of a configuration of a computer.

### DESCRIPTION OF EMBODIMENT

<Literature, Etc. Supporting Technical Contents and Technical Terms>

The scope disclosed in the present application includes not only contents described in the present specification and the drawings but also contents described in the following pieces of literature publicly known at the time of filling of the present application.
Literature 1: AVC Specifications (“Advanced video coding for generic audiovisual services,” ITU-T H.264 (April 2017))
Literature 2: HEVC Specifications (“High efficiency video coding,” ITU-T H.265 (December 2016))
Literature 3: FVC Algorithm Manual (Algorithm description of Joint Exploration Test Model 7 (JEM7), 2017-08-19)

In other words, the contents described in the pieces of literature described above also serve as grounds in determining the support requirement in description. For example, also in the case where the Quad-Tree Block Structure described in Literature 1 and the QTBT (Quad Tree Plus Binary Tree) and the Block Structure described in Literature 3 are not directly described in the embodiment, they fall within the scope of the disclosure of the present technology and satisfy the support requirement in description for the claims. Further, for example, in regard to the technical terms such as parse (Parsing), syntax (Syntax), and semantics (Semantics), also where there is no direct description in the description of the embodiment, they fall within the scope of the disclosure of the present technology and satisfy the support requirement in description for the claims.

Further, in the present specification, the term “block” (not a block indicative of a processing section) used for description as a partial region or a processing unit of an image (picture) indicates any partial region in a picture unless specified specifically, and the size, shape, characteristic and so forth of the partial region are not restricted. For example, the “block” includes any partial region (processing unit) such as TB (Transform Block), TU (Transform Unit), PB (Prediction Block), PU (Prediction Unit), SCU (Smallest Coding Unit), CU (Coding Unit), LCU (Largest Coding Unit), CTB (Coding Tree Block), CTU (Coding Tree Unit), conversion block, sub block, macro block, tile, slide or the like described in the pieces of Literature 1 to 3 described hereinabove.

Further, when a size of such a block as described above is to be designated, the block size may be designated not only directly but also indirectly. For example, a block size may be designated using identification information for identifying a size. Further, for example, a block size may be designated by a ratio with or a difference from a size of a block (for example, an LCU, an SCU or the like) used as a reference. For example, in the case where information for designating a block size is transmitted as a syntax element or the like, such information for designating a size indirectly as described above may be used as the information. This makes it possible to reduce the information amount of the information and improve the encoding efficiency. Also, a designation of a range of a block size (for example, a designation of a range of a permissible block size or the like) is included in the designation of the block size.

### Definition

In the present application, the following terms are defined as described below.

Encoded data is data obtained by encoding an image, and is data obtained, for example, by orthogonally transforming and quantizing (residuals of) an image.

An encoded bit stream is a bit stream including encoded data and includes encoded information relating to encoding as occasion demands. The encoded information at least includes information necessary to decode encoded data, that is, for example, a quantization parameter QP in the case where quantization is performed in encoding, a motion vector in the case where prediction encoding (motion compensation) is performed in encoding and so forth.

Acquirable information is information that can be acquired from the encoded bit stream. Accordingly, the acquirable information is information that can be acquired by any of an encoding apparatus that encodes an image to acquire an encoded bit stream and a decoding apparatus that decodes the encoded bit stream into an image. As the acquirable information, for example, encoded information included in an encoded bit stream and an image feature amount of an image obtained by decoding encoded data included in the encoded bit stream are available.

A prediction expression is a polynomial for predicting second data from first data. In the case where the first data and the second data are, for example, images (data), the prediction expression is a polynomial for predicting a second image from a first image. Each term of the prediction expression in the form of a polynomial includes the product of one tap coefficient and one or more prediction taps, and, accordingly, the prediction expression is an expression for performing a product sum calculation between the tap coefficient and the prediction tap or taps. Suppose that (a pixel value of) a pixel as an ith prediction tap to be used for prediction that is among pixels of a first image, an ith tap coefficient, and (a prediction value of a pixel value of) a pixel of a second image are represented by xᵢ, wᵢ, and y′, respectively, and a polynomial including only first-order terms is adopted as the prediction expression, then, the prediction expression is represented by an expression y′=Σwᵢxᵢ. In the expression y′=Σwᵢxᵢ, represents a summation regarding i. The tap coefficient wᵢ included in the prediction expression is calculated by learning that statistically minimizes the error y′−y of a value y′ obtained by the prediction expression from a true value y. As a method of learning for calculating a tap coefficient (hereinafter also referred to as tap coefficient learning), a least-squares method is available. In the tap coefficient learning, a normal equation is obtained by performing addition of coefficients of terms configuring a normal equation (summation of coefficients), for example, by using a student image as student data (input xᵢ to the prediction expression) that becomes a student of learning equivalent to a first image to which the prediction expression is to be applied and a teacher image as teacher data that becomes a teacher of learning (true value y of a prediction value obtained by calculation of the prediction expression) equivalent to a second image intended to be obtained as a result when the prediction expression is applied to the first image, and the tap coefficient is calculated by solving the normal equation.

A prediction process is a process for applying the prediction expression to first data to predict second data. In the case where the first data and the second data are, for example, images, the prediction process is a process of applying the prediction expression to a first image to predict a second image. In the prediction process, by performing a product sum calculation as calculation of the prediction expression with use of (a pixel value of) a pixel of the first image, a prediction value of the second image is calculated. Performance of a product sum calculation using a first image can be regarded as a filter process for applying a filter to the first image, and a prediction process in which a product sum calculation of the prediction expression (product sum calculation as calculation of the prediction expression) is performed using the first image can be regarded as a kind of a filter process.

A filter image signifies an image obtained as a result of the filter process. By the filter process as a prediction process, (prediction values of) the second image obtained from the first image is a filter image.

A tap coefficient is a coefficient configuring each term of a polynomial that is a prediction expression, and is equivalent to a filter coefficient to be multiplied with data regarding a filtering target in a tap of a digital filter.

A prediction tap is data regarding (a pixel value of) a pixel to be used for calculation of the prediction expression and is to be multiplied with a tap coefficient in the prediction expression. The prediction tap includes not only (a pixel value of) a pixel itself but also a value calculated from the pixel, for example, a sum total or an average value of (pixel values of) pixels in a certain block.

Here, since selection of a pixel or the like as a prediction tap to be used for calculation of the prediction expression is equivalent to stretching (distributing) a connection line for supplying a signal used as an input to a tap of a digital filter, selection of a pixel as a prediction tap to be used for calculation of the prediction expression is also referred to as “stretching a prediction tap.” This similarly applies to a class tap.

Classification signifies that data regarding a pixel or the like is classified into one of plural classes. The classification is performed using, for example, a class tap or the like.

The class tap is data regarding (a pixel value of) a pixel or the like used in the classification. The classification using the class tap can be performed, for example, by performing a threshold value process or the like for an image feature amount of (a pixel serving as) the class tap. In particular, in the classification using the class tap, for example, an ADRC code as an image feature amount of the class tap is obtained, and the ADRC code can be outputted as it is, as (a code representing) a class. Further, in the classification using the class tap, for example, it is possible to obtain a DR (Dynamic Range) as an image feature amount of the class tap and to output a code representing a size of the DR obtained by performing a threshold value process for the DR, as a class.

Here, the ADRC code of the class tap is obtained by performing L-bit ADRC targeting (a pixel of) a class tap. In the L-bit ADRC, a minimum value MIN of pixel values of the class taps is subtracted from pixel values of the pixels of the class taps and a subtraction value is divided (re-quantized) by DR/2^{L}. A bit string in which pixel values of pixels of L bits as the class taps obtained by the L bit ADRC are arranged in a predetermined order is an ADRC code. For example, in 1-bit ADRC, a pixel value of each pixel as a class tap is divided by an average value between a maximum value MAX and a minimum value MIN of pixel values of the class taps (rounded down), and, as a result, the pixel value of each pixel is given by 1 bit (binarized). It is to be noted that the DR of the class tap is a value equivalent to the difference between the maximum value MAX and the minimum value MIN of pixel values of the pixels as the class taps, and the difference itself or the difference+1 can be adopted as the DR.

The classification can be performed using not only the class tap but also encoded information included in the acquirable information. For example, the classification of a pixel can be performed by performing a threshold value process, for example, for a quantization parameter QP as the acquirable information that can be acquired in the encoding apparatus and the decoding apparatus.

A classification prediction process is a filter process as a prediction process performed for each class. A basic principle of the classification prediction process is disclosed, for example, in Japanese Patent No. 4449489 and so forth.

A higher-order term is a term having a product of (pixels as) two or more prediction taps among terms configuring a polynomial as the prediction expression.

A D-order term is a term having a product of D prediction taps among terms configuring a polynomial as the prediction expression. For example, a first-order term is a term having one prediction tap, and a second-order term is a term having a product of two prediction taps. Regarding a product of prediction taps configuring a D-order term, the prediction taps of the product may be the same prediction tap (pixel).

A D-order coefficient signifies a tap coefficient configuring a D-order term.

A D-order tap signifies (a pixel as) a prediction tap configuring the D-order term. In a higher-order prediction expression, one certain pixel is sometimes a D-order tap and a D′-order tap different from the D-order tap. Further, the tap structure of the D-order tap need not be the same as the tap structure of the D′-order tap different from the D-order tap.

A tap structure signifies placement of a pixel as a prediction tap or a class tap (for example, with reference to a position of a noticed pixel). The tap structure can also be regarded as a way of stretching a tap regarding the prediction tap or the class tap.

A DC prediction expression is a prediction expression including a DC term.

A DC term is a term of the product between a value representing a DC component of an image as a prediction tap and a tap coefficient among terms configuring a polynomial as the prediction expression.

A DC tap signifies a value representative of a prediction tap of the DC term, i.e., a DC component.

A DC coefficient signifies a tap coefficient of the DC term.

A first-order prediction expression is a prediction expression including only a first-order term.

A higher-order prediction expression is a prediction expression including a higher-order term, that is, a prediction expression including a first-order term and a second or higher-order term or a prediction expression including only second or higher-order terms. If an ith prediction tap (pixel value or the like) to be used for prediction among pixels of a first image, an ith tap coefficient, and (a prediction value of a pixel value of) a pixel of a second image calculated by the prediction expression are represented by xᵢ, wᵢ, and y, respectively, then, the first-order prediction expression can be represented by an expression y=Σwᵢxᵢ. The higher-order prediction expression including only a first-order term and a second-order term can be represented, for example, by an expression y=Σwᵢxᵢ+Σ(Σw_{j,k}xₖ)xⱼ. The DC prediction expression in which the DC term is included in the first-order prediction expression can be represented, for example, by an expression Σwᵢxᵢ+w_{DCB}DCB. Here, w_{j,k} represents a tap coefficient (second-order coefficient) configuring a second-order term w_{j,k}xₖxⱼ having the product xₖxⱼ of the pixels xₖ and x as second-order taps. Further, w_{DCB} represents a DC coefficient, and DCB represents a DC tap.

The tap coefficients of the first-order prediction expression, higher-order prediction expression, and DC prediction expression can each be obtained by performing tap coefficient learning using such a least-squares method as described above.

Volumization of a tap coefficient signifies to approximate a tap coefficient included in a prediction expression with a polynomial, i.e., to obtain a coefficient (seed coefficient) included in the polynomial.

The coefficient approximate expression is a polynomial that approximates a tap coefficient w in volumization. The coefficient approximate expression includes a term for which a seed coefficient βₘ and a parameter z are used and can be represented, for example, by an expression w=Σβₘz^{m-1}. In the expression w=Σβₘz^{m-1}, represents a summation regarding m, and the seed coefficient βₘ represents the mth coefficient of the coefficient approximate expression. According to the coefficient approximate expression w=Σβₘz^{m-1}, various tap coefficients w can be approximated using the parameter z as a variable. As the parameter z, for example, a value according to learning related information related to at least one of a teacher image or a student image as a set of teacher data and student data (hereinafter also referred to as a learning pair) that is used in tap coefficient learning for obtaining a tap coefficient w calculated from the coefficient approximate expression can be adopted. For example, in the case where a source image that is made an encoding target in the encoding apparatus is adopted as the teacher image and a decoded image obtained by decoding encoded data obtained by encoding the source image is adopted as the student image, a quantization parameter QP used in encoding of the source image in the encoding apparatus can be used as the learning related information.

Here, the coefficient approximate expression for calculating the ith tap coefficient wᵢ can be represented by an expression wᵢ=Σβₘz^{m-1}. Represented by is the mth seed coefficient used to obtain the ith tap coefficient wᵢ. Volumization of the tap coefficient wᵢ, i.e., learning for obtaining the seed coefficient βₘ (hereinafter also referred to as seed coefficient learning), is performed by calculating a seed coefficient that statistically minimizes the error between the prediction value of the tap coefficient wᵢ calculated from wᵢ=Σβ_{m,i}z^{m-1} and the true value of the tap coefficient wᵢ. In such seed coefficient learning, for example, in the case where the student image that configures the learning pair used in the tap coefficient learning for calculating the tap coefficient wᵢ is a decoded image obtained by decoding encoded data obtained by encoding the teacher image, encoded information included in an encoded bit stream including the encoded data, for example, a value corresponding to the quantization parameter QP used in encoding of the teacher image, can be adopted as the parameter z. On the other hand, in the seed coefficient learning, for example, in the case where the student image configuring the learning pair used in the tap coefficient learning for obtaining the tap coefficient wᵢ is an image with noise added to the teacher image, a value corresponding to the noise amount of the noise added to the teacher image can be adopted as the parameter z. Furthermore, in the seed coefficient learning, for example, an image feature amount of the student image configuring the learning pair used in the tap coefficient learning for obtaining the tap coefficient wᵢ, for example, a value corresponding to the DR of a pixel value in a local region, can be adopted as the parameter z.

In the case where the tap coefficient wᵢ is calculated from the coefficient approximate expression wᵢ=Σβ_{m,i}z^{m-1}, the tap coefficient wᵢ can be calculated using an image feature amount of a decoded image to which a prediction expression including the tap coefficient wᵢ is applied or a value corresponding to encoded information, as the parameter z. Further, the tap coefficient wᵢ can be calculated using a parameter z that is set (determined), for example, according to an operation of the user or the like.

The maximum value M of the variable m whose summation (Σ) is calculated in the coefficient approximate expression wᵢ=Σβ_{m,i}z^{m-1} can be determined to a fixed value in advance. Otherwise, the maximum value M of the variable m can be selected adaptively on the basis of a predetermined index such as to make the encoding efficiency best, for example.

The seed coefficient signifies a coefficient of a coefficient approximate expression used in volumization. The seed coefficient can be obtained by performing seed coefficient learning similar to tap coefficient learning. For example, in the seed coefficient learning for obtaining a seed coefficient β_{m,i} included in the coefficient approximate expression wᵢ=Σβ_{m,i}z^{m-1}, the seed coefficient that statistically minimizes the error between the prediction value of the tap coefficient wᵢ obtained from the coefficient approximate expression wᵢ=Σβ_{m,i}z^{m-1} and the true value of the tap coefficient wᵢ is obtained by a least-squares method. Such seed coefficient learning can be performed using the tap coefficient wᵢ of the prediction expression for predicting a source image from a decoded image obtained by encoding with a certain quantization parameter QP and decoding, as teacher data, and using the parameter z of a value corresponding to the quantization parameter QP, as student data.

The filter controlling information is information for controlling the filter process, and as the filter controlling information for a filter process as a classification prediction process, prediction related information and classification related information are available. The prediction related information is information related to a prediction process in a classification prediction process, and the classification related information is information related to classification in a classification prediction process. As the prediction related information, for example, information regarding a prediction expression used in a prediction process, a tap number of prediction taps (number of pixels that serve as prediction taps) and so forth are available. As the classification related information, a method of classification (what kind of image feature amount is to be used or what kind of rule is to be applied to perform classification and so forth), a class number of classes to be obtained by classification (total number of classes), a tap structure of class taps (how to stretch class taps) and so forth are available.

The filter coefficient is a coefficient that is to be multiplied by data regarding a target of filtering in taps of a digital filter. The prediction process of applying (calculating) a prediction expression is a kind of a filter process, and a tap coefficient used in such prediction process is a kind of a filter coefficient.

The filter process is a process of applying a digital filter to data regarding a target of filtering, and particularly, is a product sum calculation of data regarding a target of filtering and filter coefficients or the like.

The conversion coefficient is a coefficient for converting a first coefficient into a second coefficient. The coefficient conversion of converting a first coefficient into a second coefficient can be performed using a coefficient conversion expression including a conversion coefficient. In the first coefficient converted using the conversion coefficient and the second coefficient, a filter coefficient including a tap coefficient and a seed coefficient are included.

The coefficient conversion expression is any expression for converting a first coefficient into a second coefficient. As the coefficient conversion expression, for example, a polynomial that has a term of the product of the first coefficient and the conversion coefficient, i.e., an expression that includes a product sum calculation of the first coefficient and the conversion coefficient, can be adopted. The conversion coefficient included in a coefficient conversion expression can be obtained, for example, by learning that statistically minimizes the error between a (prediction) value of the second coefficient obtained by the coefficient conversion expression and the true value of the second coefficient. As the method of learning for obtaining a conversion coefficient (hereinafter also referred to as conversion coefficient learning), a least-squares method is available.

The coefficient conversion expression includes a filter coefficient conversion expression for converting a first filter coefficient into a second filter coefficient. Since the filter coefficient conversion expression includes a tap coefficient conversion expression for converting a certain tap coefficient into a different tap coefficient, the coefficient conversion expression includes a tap coefficient conversion expression. Further, the coefficient conversion expression includes a seed coefficient conversion expression for converting a tap coefficient into a seed coefficient.

Since, according to the coefficient approximate expression, the tap coefficient wᵢ is calculated from the seed coefficient β_{m,i} and the parameter z, the coefficient approximate expression is included in the coefficient conversion expression.

Accordingly, the coefficient conversion expression includes the filter coefficient conversion expression, seed coefficient conversion expression, and coefficient approximate expression. The filter coefficient conversion expression includes a tap coefficient conversion expression.

It is to be noted that the coefficient approximate expression and the tap coefficient conversion expression have in common that a tap coefficient is calculated by them. However, the coefficient approximate expression and the tap coefficient conversion expression are different from each other in that, by the coefficient approximate expression, the tap coefficient wᵢ is calculated from the seed coefficient βₘ and the parameter z and, by the tap coefficient conversion expression, a certain tap coefficient is converted into a different tap coefficient with use of a conversion coefficient.

The ILF coefficient is a filter coefficient of an existing ILF (In Loop Filter). As the existing ILF, for example, a deblocking filter, an adaptive offset filter, a bilateral filter and an ALF that are described above are available.

The prediction encoding is encoding of encoding residuals that are errors between a source image of an encoding target and prediction values of the source image (prediction image).

The decoded image is an image obtained by decoding encoded data that is obtained by encoding a source image. The decoded image includes, not only an image obtained by decoding encoded data by a decoding apparatus, but also an image obtained by local decoding of prediction encoding in the case where the source image is subjected to prediction encoding in an encoding apparatus. In particular, in the case where a source image is subjected to prediction encoding in an encoding apparatus, a prediction image and (decoded) residuals are added in local decoding, and an addition result of the addition is a decoded image. In the case where an ILF is used for local decoding of the encoding apparatus, a decoded image that is a result of addition of the prediction image and the residuals becomes a target of a filter process of the ILF, and the decoded image subjected to the filter process of the ILF is also a filter image. The filter image that is a decoded image subjected to the filter process of the ILF is hereinafter also referred to as an ILF image.

<Prediction Expression>

In the following, an example of a prediction expression used in a prediction process is described.

It is to be noted that, although the filter process as a prediction process in which a prediction expression is applied can be performed targeting (data regarding) an image, sound or the like, in order to simplify the description, the description here is given taking as an example a case in which, from an image, especially, from a decoded image, a source image corresponding to the decoded image is predicted.

As the prediction expression to be used in (a filter process as) a prediction process for predicting, from a decoded image, a source image corresponding to the decoded image, for example, a prediction expression of the expression (1) can be adopted.

y=Σwₙxₙ (1)

In the prediction expression y=Σwₙxₙ of the expression (1), y represents (a prediction value of a pixel value of) a corresponding pixel of the source image corresponding to a noticed pixel that is noticed in the decoded image, and Σ represents a summation where n is changed to integers within the range from 1 to N. Meanwhile, wₙ represents the nth tap coefficient, and xₙ represents (a pixel value of) a pixel of the decoded image selected as the nth prediction tap in regard to the noticed pixel. Represented by N is the number of tap coefficients wₙ (and prediction taps xₙ) included in the prediction expression y=Σwₙxₙ.

The prediction expression y=Σwₙxₙ is a first-order prediction expression including only a first-order term, and according to the first-order prediction expression, the picture quality of a filter image obtained by applying the first-order prediction expression to a decoded image can be improved with the tap number wₙ whose data amount is not so great. However, with the first-order prediction expression, it is sometimes difficult to restore details of a source image with high accuracy.

As the prediction expression to be used in a prediction process, not only a first-order prediction expression, but also a higher-order prediction expression that is a polynomial of a higher order equal to or higher than a second order, a DC prediction expression that is a polynomial including a DC term and so forth can be adopted.

As the higher-order prediction expression, any polynomial can be adopted if it is a polynomial that includes, as a term, the product of one tap coefficient and (a pixel value of) a pixel or pixels as one or more prediction taps and includes a higher-order term (a term of a higher order of equal to or higher than a second order). In particular, as the higher-order prediction expression, for example, a polynomial including only a first-order term (term of the first-order) and a second-order term (term of the second-order), a polynomial including a first-order term and higher-order terms of plural of different orders of second or higher order, a polynomial including higher-order terms of one or more of plural different orders equal to or higher than the second-order order and so forth can be adopted.

For example, the higher-order prediction expression including only a first-order term and a second-order term is represented by the expression (2).

y=Σwᵢxᵢ+(Σw_{i,k}xₖ)xᵢ (2)

In expression (2), wᵢxᵢ represents a first-order term, and w_{i,k}xₖxⱼ represents a second-order term. Accordingly, the higher-order prediction expression of expression (2) is a polynomial including only a first-order term and a second-order term. In the following description, the higher-order prediction expression of expression (2) including only a first-order term and a second-order term is also referred to as a second-order prediction expression.

In expression (2), the summation (Σ) of the first-order term wᵢxᵢ is calculated changing the variable i to integers in the range from 1 to N1. Represented by N1 is the number of pixels xᵢ as first-order taps (prediction taps of the first-order term) among the prediction taps and represents the number of first-order coefficients (tap coefficients of the first-order term) wᵢ among the tap coefficients. Represented by wᵢ is the ith first-order coefficient among the tap coefficients. Represented by xᵢ is (a pixel value of) a pixel as the ith first-order tap among the prediction taps.

Further, in expression (2), the first summation from between the two summations of the second-order term w_{j,k}xₖx is calculated changing the variable j to integers within the range from 1 to N2, and the second summation is calculated changing the variable k to integers within the range from j to N2. Represented by N2 is the number of pixels x (xₖ) as second-order taps (prediction taps of the second-order term) among the prediction taps. Represented by w_{j,k} is the (j×k)th second-order term among the tap coefficients. Represented by xⱼ and xₖ are pixels as the jth and kth second-order taps (k>=j) among the prediction taps.

It is to be noted that, although the first-order taps here are represented by xᵢ and the second-order taps here are represented by xⱼ and kₓ for the explanation of expression (2), in the following description, a first-order tap and a second-order tap are not specifically distinguished from each other by a suffix added to x. In particular, any of a first-order tap and a second-order tap is referred to, for example, using xₙ or the like, as first-order tap xₙ, second-order tap xₙ, prediction tap xₙ or the like. This similarly applies to the first-order coefficient wᵢ and the second-order coefficient w_{i,k} that are tap coefficients.

It is assumed now that a higher-order prediction expression that uses, as prediction taps, all of candidate pixels determined in advance as candidates for pixels that become prediction taps and has, as a D-order term, a term of the product of (pixel values of) D pixels in all combinations where D pixels are selected allowing duplication from among the candidate pixels is referred to as an all-ways prediction expression.

The higher-order prediction expression of expression (2) is an all-ways prediction expression in the case where the number of candidate pixels for the first-order tap is N1 and the number of candidate pixels for the second-order tap is N2.

In the case where the number of pixels as the first-order tap is N1, the number N1′ of the first-order terms (and the first-order coefficients) of the all-ways prediction expression is equal to the number N1 of the first-order taps. In the case where the number of pixels as the second-order taps is N2, the number N2′ of the second-order items (and the second-order coefficients) of the all-ways prediction expression is represented by an expression N2′=_{N2}C₂+N2. Represented by _{N2}C₂ is the number of combinations where two are selected from among N2 without duplication.

According to such a higher-order prediction expression as expression (2), details of a source image whose restoration with a first-order prediction expression is difficult in a filter image obtained by applying the higher-order prediction expression to a decoded image can be restored with high accuracy. However, since, in the higher-order prediction expression, the number N2′ of second-order coefficients is represented by the expression N2′=_{N2}C₂+N2, if the number N2 of the candidate pixels of the second-order taps is great, then, the number N2′ of the second-order coefficients becomes huge.

The DC prediction expression is represented, for example, by expression (3).

y=WX (3)

In expression (3), W represents a row vector in which tap coefficients are elements (vector obtained by transposition from a column vector), and X represents a column vector in which prediction taps are elements.

Here, although the DC prediction expression of expression (3) is a prediction expression in which a DC term is included in a first-order prediction expression, as the DC prediction expression, a prediction expression in which a DC term is included in a higher-order prediction expression can be adopted.

For example, the DC prediction expression of expression (3) includes, as elements of W, i.e., as tap coefficients, N first-order coefficients w₁, w₂, . . . , w_{N} and N′ DC coefficients w_{DC1}, w_{DC2}, . . . , w_{DC#N′}. Further, the DC prediction expression of expression (3) includes, as elements of X, i.e., as prediction taps, N first-order taps xᵢ, x₂, . . . , x_{N} and N′ DC taps DC1, DC2, . . . , DC#N′.

In this case, the DC prediction expression of expression (3) is represented by expression (4).

y=Σwₙxₙ+Σw_{DC#i}DC#i (4)

In expression (4), the first summation on the right side represents a summation where n is changed to integers within the range from 1 to N, and the second summation on the right side represents a summation where i is changed to integers within the range from 1 to N′.

In the DC prediction expression of expression (4), w_{DC#i}DC#i is the DC term. As the DC tap DC#i included in the DC term w_{DC#i}DC#i, for example, an average value (or a sum total) of pixel values in four blocks adjacent vertically and horizontally to a block including a noticed pixel of a decoded image (such block is hereinafter also referred to as a noticed block) can be adopted. In this case, the number of DC terms is four. As the blocks from which an average value of pixel values as the DC tap DC#i is calculated, for example, a block for which a deblocking filter can be applied can be adopted.

Further, as the DC tap DC#i, an interpolation value which is obtained by performing interpolation according to the distance between a noticed pixel and each of the blocks adjacent vertically and horizontally to the noticed block with use of an average value (or a sum total) of the pixel values in each of the blocks adjacent vertically and horizontally to the noticed block can be adopted. In this case, the number of DC terms is one. As the interpolation, linear interpolation, bilinear interpolation, and some other interpolation can be adopted.

According to the DC prediction expression, by an effect of the DC term, it is possible to significantly reduce encoding distortion such as block distortion in a filter image obtained by applying the DC prediction expression to a decoded image.

<Volumization>

In the following, volumization of a tap coefficient is described.

In the volumization, a seed coefficient in the case where a tap coefficient included in a prediction expression is approximated with a polynomial, i.e., a coefficient of a coefficient approximate expression that is a polynomial for approximating a tap coefficient, is obtained.

In the volumization, a coefficient approximate expression for calculating (approximating) a tap coefficient wₙ is represented, for example, by expression (5).

wₙ=Σβ_{m,n}z^{m-1} (5)

Here, in expression (5), wₙ represents the nth tap coefficient, and Σ represents a summation where m is changed to integers within the range from 1 to M. Represented by ⊖_{m,n} is the mth seed coefficient of the coefficient approximate expression for calculating the nth tap coefficient wₙ, and represented by z is a parameter (volume) used to obtain the tap coefficient wₙ with use of the seed coefficient β_{m,n}. According to the coefficient approximate expression, by applying various parameters z, a tap coefficient wₙ suitable for a decoded image of various natures (picture quality, movement amount, scene or the like) (for example, a tap coefficient wₙ with which a filter image whose error from a source image is small can be generated in regard to decoded images of various natures) can be obtained from the seed coefficient β_{m,n}.

It is to be noted that the seed coefficient can be obtained not only for tap coefficients of a first-order prediction expression but also for tap coefficients for a higher-order prediction expression, a DC prediction expression, and any other prediction expressions.

Since the tap coefficient is used in a filter process (as a prediction process) in which a prediction expression including the tap coefficient is applied, it is a filter coefficient itself. On the other hand, since the seed coefficient is used to calculate a tap coefficient, it cannot be considered as being a filter coefficient itself. In this regard, the tap coefficient and the seed coefficient are different.

In the case where the encoding apparatus and the decoding apparatus adopt a prediction process that uses a prediction expression including tap coefficients obtained from seed coefficients, in place of a filter process of an existing ILF, the parameter z of the coefficient approximate expression can be generated, for example, using acquirable information that can be acquired from an encoded bit stream, i.e., a value according to the acquirable information can be adopted for the parameter z.

As the acquirable information, for example, encoded information regarding a quantization parameter QP and so forth included in an encoded bit stream and an image feature amount of a decoded image obtained by decoding encoded data included in an encoded bit stream are available.

Here, the acquirable information can be acquired from an encoded bit stream not only by the encoding apparatus but also by the decoding apparatus. Accordingly, in the case where a value according to the acquirable information is adopted as (a value of) the parameter z, there is no necessity to transmit the parameter z from the encoding apparatus to the decoding apparatus.

Further, the parameter z can be generated not only according to the acquirable information but also according to a source image. For example, a value according to an image feature amount of a source image, a value according to a PSNR (Peak signal-to-noise ratio) or the like of a decoded image obtained using a source image and so forth can be adopted as the parameter z. However, since the source image cannot be obtained by the decoding apparatus, in the case where the parameter z is to be generated according to the source image, for example, it is necessary to transmit the parameter z generated according to the source image from the encoding apparatus to the decoding apparatus by placing the parameter z into the encoded bit steam or by like means.

<Overview of Present Technology>

In the following, an overview of the present technology is described.

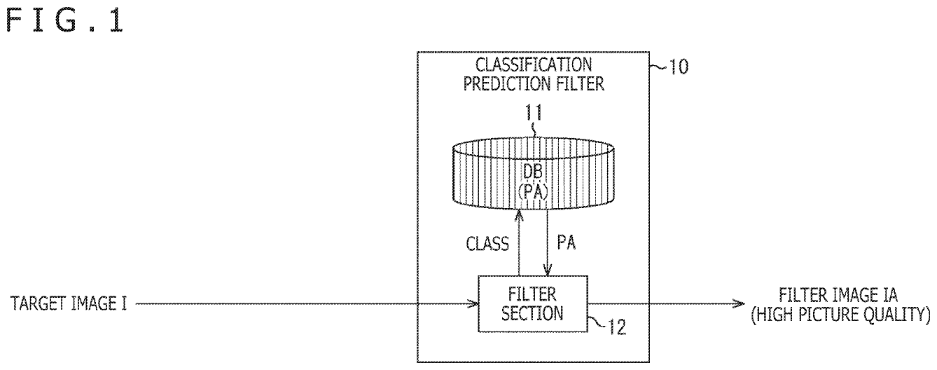

FIG. 1 is a block diagram depicting an example of a configuration of a classification prediction filter.

Referring to FIG. 1, a classification prediction filter 10 includes a DB (Database) 11 and a filter section 12 and performs a classification prediction process, which is a filter process, for a target image I that is a target of a filter process, to generate and output a filter image IA of high picture quality in which the picture quality of the target image I is improved.

Here, the target image I is, for example, a decoded image, and the filter image IA is prediction values of a source image corresponding to the decoded image.

The DB 11 has tap coefficients PA for individual classes stored therein. For example, the DB 11 has stored therein tap coefficients PA for individual classes obtained by performing tap coefficient learning using a decoded image and a source image corresponding to the decoded image as a learning pair.

The filter section 12 performs, for the target image I, a filter process for applying a prediction expression including tap coefficients PA for individual classes stored in the DB 11 and outputs a filter image IA generated by the filter process.

In particular, the filter section 12 sequentially selects pixels of the target image I as a noticed pixel and performs classification of the noticed pixel. For example, the filter section 12 selects, for example, a plurality of pixels in the proximity of the noticed pixel among the pixels of the target image I, as class taps of the noticed pixel, and performs a process for an image feature amount of the class taps with a threshold value or a like process to obtain the class of the noticed pixel.

Further, the filter section 12 supplies the class of the noticed pixel obtained by the classification of the noticed pixel to the DB 11 and requests for a tack coefficient of the class of the noticed pixel. The DB 11 acquires (selects) a tap coefficient of the class of the noticed pixel from among the tap coefficients PA for the individual classes in accordance with the request of the filter section 12 and supplies the tap coefficients to the filter section 12.

Further, the filter section 12 selects, for example, a plurality of pixels in the proximity of the noticed pixel among the pixels of the target image I, as prediction taps of the noticed pixel. Furthermore, the filter section 12 calculates a prediction value of (a pixel value of) a pixel of the source image corresponding to the noticed pixel by performing a prediction process of applying a prediction expression including the tap coefficient of the class of the noticed pixel to the target image I, i.e., by calculating the prediction expression including (the pixel values of) the pixels as prediction taps of the noticed pixel and the tap coefficient of the class of the noticed pixel. Then, the filter section 12 generates an image whose pixel values are given by such prediction values and outputs the image as the filter image IA.

The degree of improvement of the picture quality of the filter image obtained by the classification prediction process differs depending upon the substance of the classification prediction process.

The substance of the classification prediction process differs, for example, depending upon the tap coefficient used in the classification prediction process.

For example, if attention is now paid to tap coefficients used in the classification prediction process in order to simplify the description, then, the degree of improvement of the picture quality of a filter image obtained by the classification prediction process differs depending upon the tap coefficients used in the classification prediction process.

Here, as a case in which a certain first tap coefficient and a different second tap coefficient are different from each other, for example, such following cases are available.

In particular, there is a case where the first tap coefficient and the second tap coefficient differ from each other because a learning pair used in tap coefficient learning for calculating the first tap coefficient and another learning pair used in tap coefficient learning for calculating the second tap coefficient are different from each other.

Further, there is a case where, even if a learning pair used in tap coefficient learning for calculating the first tap coefficient and another learning pair used in tap coefficient learning for calculating the second tap coefficient are the same as each other, the first tap coefficient and the second tap coefficient differ from each other because a prediction expression in which the first tap coefficient is used and another prediction expression in which the second tap coefficient is used are different from each other. As a case in which the prediction expressions are different from each other, for example, a case in which the prediction expressions are different in type from each other like a first-order prediction expression and a higher-order prediction expression and a case in which, although the prediction expressions are of the same type, the prediction taps are different in tap structure or tap number (this is also the number of tap coefficients) are available.

Furthermore, there is a case where the first tap coefficient and the second tap coefficient are different from each other because they are different in the method of classification, tap structure or tap number of class taps, or class number.

Then, roughly speaking, the degree of improvement of the picture quality of a filter image obtained by the classification prediction process is higher, for example, in regard to tap numbers of a greater class number than in regard to tap numbers of a smaller class number.

Here, the concept of “performance” is introduced into the tap coefficient. The performance of a tap coefficient being good (high) signifies that the degree of improvement of the picture quality of a filter image obtained by a classification prediction process in which the tap coefficient is used is high (the error of a prediction value is small).

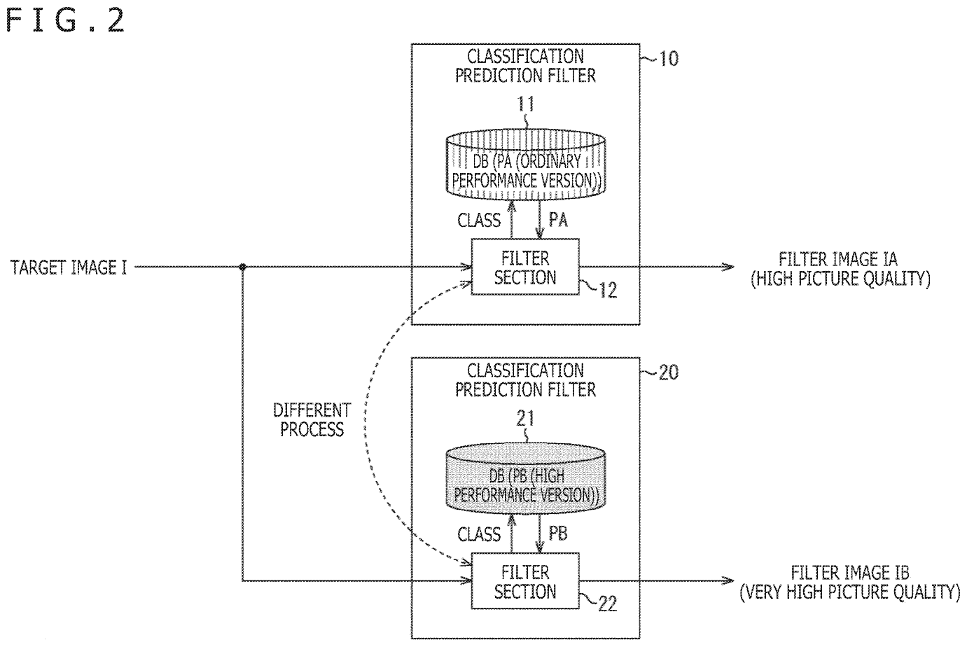

FIG. 2 is a view illustrating a classification prediction process in which tap coefficients of different levels of performance are used.

Referring to FIG. 2, a classification prediction filter 10 includes a DB 11 and a filter section 12 similarly as in the case of FIG. 1. Note that it is assumed that tap coefficients PA stored in the DB 11 are tap coefficients of ordinary performance that is predetermined performance.

In FIG. 2, a classification prediction filter 20 includes a DB 21 and a filter section 22.

The DB 21 has tap coefficients PB for individual classes stored therein. However, the tap coefficients PB stored in the DB 21 are tap coefficients of higher performance than the ordinary performance because, for example, a prediction expression including the tap coefficients PB and a prediction expression including the tap coefficients PA are different from each other.

The filter section 22 performs, with respect to the target image I, a filter process in which the prediction expression including the tap coefficients PB for the individual classes stored in the DB 21 is applied, and outputs a filter image IB generated by the filter process.

The filter image IB is an image of very high picture quality obtained by improving the picture quality of the target image I. Here, the very high picture quality signifies that the picture quality is better than what is merely meant as being high picture quality.

In the case where the classification prediction filter 20 performs a classification prediction process for the target given as a target image I (of the picture quality) that is the same as the classification prediction filter 10, a filter image IB of higher picture quality than that of the filter image IA obtained by the classification prediction filter 10 is obtained.

Incidentally, in technology development of the classification prediction process, the classification prediction filter 10 in which tap coefficients PA of the ordinary performance are used is developed first, and then, the classification prediction filter 20 in which tap coefficients PB of the high performance are used is developed.

Therefore, in the case where a function for improving the picture quality is incorporated into a product, after the classification prediction filter 10 is developed, the classification prediction filter 10 continues to be incorporated in products until the classification prediction filter 20 is developed.

While the classification prediction filter 10 continues to be incorporated in products, update of the classification prediction process to be performed by the classification prediction filter 10 can be performed by fine adjustment (update) of the tap coefficients PA used in the classification prediction filter 10 or filter parameters such as threshold values used for classification.

Here, the fine adjustment of a filter parameter signifies adjustment within a range within which, in the case where the filter section 12 includes hardware for exclusive use that performs a classification prediction process using tap coefficients PA, the classification prediction process can be performed without changing the hardware for exclusive use. For example, in regard to the tap coefficients PA, performing adjustment of only the value of tap coefficients PA without changing any of the class number, prediction expression, tap number of the prediction taps, tap structure and so forth is equivalent to fine adjustment of filter parameters.

In the case where fine adjustment of filter parameters of the classification prediction filter 10 is performed, although the picture quality of the filter image IA obtained by the classification prediction filter 10 changes according to the fine adjustment of the filter parameters, it is difficult to change the taste and so forth of the filter image IA significantly.

Thereafter, for example, in the case where the classification prediction filter 20 that uses tap coefficients PB of high performance with which the filter image IB whose taste and so forth are much different from those of the filter image IA obtained by a classification prediction process in which tap coefficients PA of the ordinary performance are used is obtained is developed, the classification prediction filter 20 starts to be incorporated into products in place of the classification prediction filter 10.

In this case, also with products in which the classification prediction filter 10 is incorporated, it is desirable to update the classification prediction process to be performed by the classification prediction filter 10 such that a filter image of a taste and so forth similar to those of products in which the classification prediction filter 20 is incorporated can be obtained.

As a method for performing such update, a method by which, for example, the tap coefficients PA of the ordinary performance stored in the DB 11 are updated to the tap coefficients PB of the high performance stored in the DB 21 is available.

However, in the case where the prediction expression including tap coefficients PA and the prediction expression including tap coefficients PB are different from each other as described above, the calculation of the prediction expression including tap coefficients PA and the calculation of the prediction expression including tap coefficients PB are processes different from each other. Therefore, in the case where the filter section 12 includes hardware for exclusive use that performs the calculation of the prediction expression including tap coefficients PA, merely updating the tap coefficients PA of the ordinary performance stored in the DB 11 to the tap coefficients PB of the high performance stored in the DB 21 does not allow the filter section 12 to perform the calculation of the prediction expression including the tap coefficients PB, i.e., a filter process as a classification prediction process using the tap coefficients PB.

Therefore, there is a method by which the filter section 12 that performs a filter process as a classification prediction process can have a flexible hardware configuration capable of performing a classification prediction process using tap coefficients with variations (in performance).

By configuring the filter section 12 in a flexible hardware configuration, before the tap coefficients stored in the DB 11 are updated from the tap coefficients PA of the ordinary performance to the tap coefficients PB of the high performance, a classification prediction process using the tap coefficients PA can be performed, but after the tap coefficients stored in the DB 11 are updated from the tap coefficients PA of the ordinary performance to the tap coefficients PB of the high performance, a classification prediction process using the tap coefficients PB of the high performance can be performed.

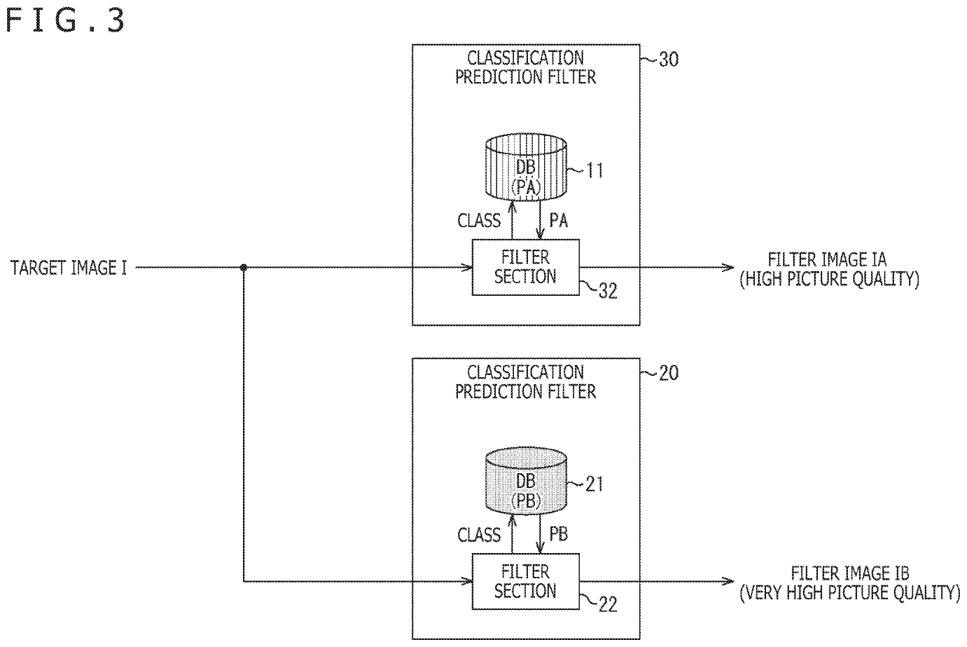

FIG. 3 is a view illustrating a classification adaptive filter in which the filter section is implemented by a flexible hardware configuration.

It is to be noted that, in FIG. 3, portions corresponding to those in the cases of FIGS. 1 and 2 are denoted by identical reference signs, and in the following description, description of them is omitted suitably.

Referring to FIG. 3, a classification prediction filter 30 includes a DB 11 and a filter section 32.

The filter section 32 is implemented by a flexible hardware configuration that can perform a classification prediction process using various tap coefficients. For example, the filter section 32 includes a DSP (Digital Signal Processor) and so forth such that it can perform calculation of various prediction expressions by the DSP executing a program.

As described above, tap coefficients PA of the ordinary performance are stored in the DB 11, and in the classification prediction filter 30, the filter section 32 can generate a filter image IA of the high picture quality by performing a classification prediction process using the tap coefficients PA stored in the DB 11.

Further, in the classification prediction filter 30, in the case where the tap coefficients stored in the DB 11 are updated from the tap coefficients PA to the tap coefficients PB stored in the DB 21, the filter section 32 can perform a classification prediction process using the post-update tap coefficients PB. As a result, by the classification prediction filter 30, a filter image of very high picture quality similar to that of the filter image IB obtained by the classification prediction filter 20 can be obtained.

Incidentally, if the classification prediction filter 30 can convert the tap coefficients PA stored in the DB 11 into tap coefficients of various levels of performance instead of updating the tap coefficients PA stored in the DB 11 to other tap coefficients, then, it can perform a filter process as a classification adaptive process of a high degree of freedom by using tap coefficients of various levels of performance including the tap coefficients PA stored in the DB 11 from the beginning.

Therefore, in the following, coefficient conversion of converting a certain tap coefficient (of a certain level of performance) into a different tap coefficient (of a different level of performance) will be described.

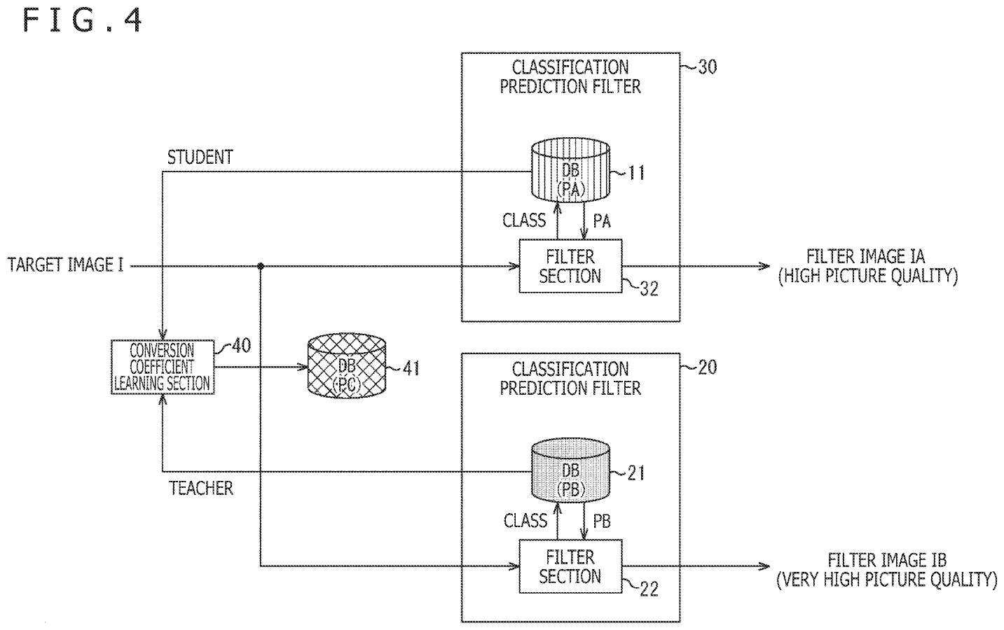

FIG. 4 is a view illustrating a method of calculating a conversion coefficient for converting a certain tap coefficient into a different tap coefficient.

It is to be noted that, in FIG. 4, portions corresponding to those in the case of FIG. 3 are denoted by identical reference signs, and in the following description, description of them is omitted suitably.

Referring to FIG. 4, a conversion coefficient learning section 40 performs conversion coefficient learning using tap coefficients PA and PB as a learning pair, i.e., using the tap coefficients PA stored in the DB 11 as student data and using the tap coefficients PB stored in the DB 21 as teacher data.

In particular, the conversion coefficient learning section 40 performs conversion coefficient learning of adopting, as a coefficient conversion expression for converting the tap coefficients PA into the tap coefficients PB, for example, a polynomial whose terms are given by the products of the tap coefficients PA and conversion coefficients and calculating a conversion coefficient that statistically minimizes the error between the prediction value of the tap coefficient PB obtained by the coefficient conversion expression and the true value of the tap coefficient PB.

Since the coefficient conversion expression for converting a tap coefficient PA into a tap coefficient PB is a tap coefficient conversion expression and a tap coefficient is a filter coefficient, the coefficient conversion expression for converting a tap coefficient PA into a tap coefficient PB is also a filter coefficient conversion expression.

The conversion coefficient learning section 40 supplies a tap coefficient PC obtained by the conversion coefficient learning to a DB 41 so as to be stored into the DB 41.

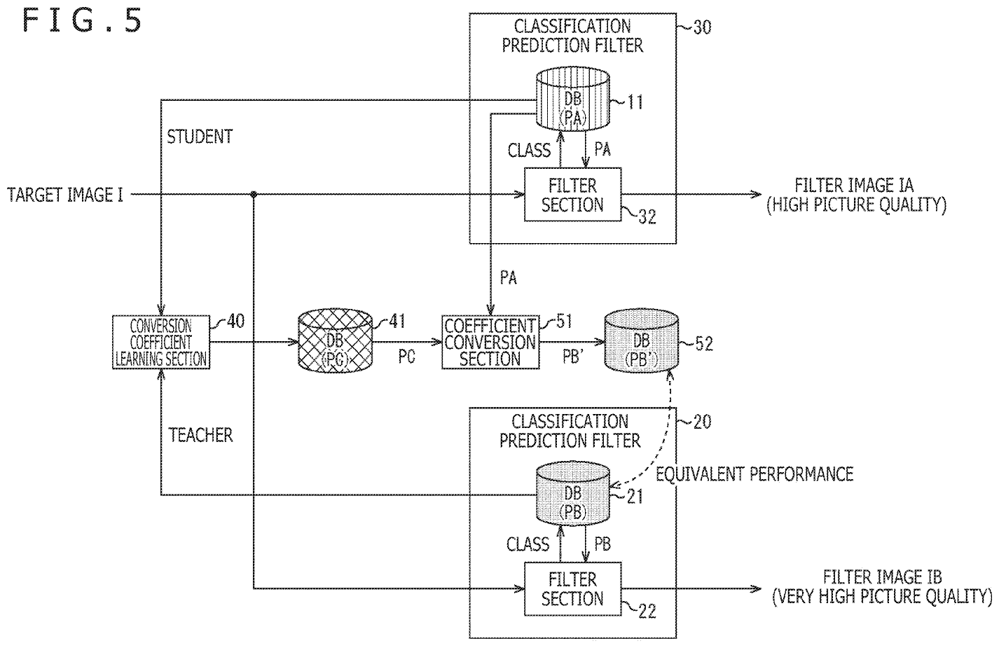

FIG. 5 is a view illustrating coefficient conversion of converting a tap coefficient PA into (a prediction value of) a tap coefficient PB by using a conversion coefficient.

It is to be noted that, in FIG. 5, portions corresponding to those in the case of FIG. 4 are denoted by identical reference signs, and in the following description, description of them is omitted suitably.

Referring to FIG. 5, a coefficient conversion section 51 converts a tap coefficient PA stored in the DB 11 into a tap coefficient PB′, which is a prediction value of a tap coefficient PB stored in the DB 21, by using a tap coefficient PC stored in the DB 41, for example, according to a coefficient conversion expression of expression (6). It is to be noted that the coefficient conversion expression is not limited to expression (6) and any expression (function) can be adopted.

PB′=A·PA+B (6)

Here, in a strict sense, PA represents a set of the tap coefficients stored in the DB 11, that is, for example, a column vector whose elements are the individual tap coefficients stored in the DB 11. In a strict sense, PB′ is a set of prediction values of the tap coefficients PB obtained by conversion using the tap coefficient PC, that is, for example, a column vector whose elements are prediction values of the individual tap coefficients stored in the DB 21. Similarly, in a strict sense, PB represents a set of the tap coefficients stored in the DB 21, that is, for example, a column vector whose elements are the individual tap coefficients stored in the DB 21.

In a strict sense, PC represents a set of conversion coefficients included in the coefficient conversion expression of expression (6). In expression (6), “A” represents a set of conversion coefficients with which the product with the tap coefficients PA is calculated and that is within the set PC of the conversion coefficients, and “B” represents a set of conversion coefficients that become what are generally called constant terms within the tap coefficient PC of conversion coefficients. From the foregoing, the set PC of conversion coefficients having (the set of) the conversion coefficients “A” with which the product with the tap coefficients PA is calculated and (the set of) the conversion coefficients “B” that become constant terms is represented by the expression PC=[A B].

The coefficient conversion section 51 supplies the tap coefficients PB′, which are prediction values of the tap coefficients PB obtained by conversion of the tap coefficients PA according to the coefficient conversion expression of expression (6), to a DB 52 so as to be stored into the DB 52.

Since the tap coefficients PB′ are prediction values of the tap coefficients PB generated from the tap coefficients PA according to expression (6) including the conversion coefficient PC=[A B] that statistically minimizes (statistically optimizes) the error between the prediction value and the true value of the tap coefficients PB, they are tap coefficients having a level of performance equivalent to that of the tap coefficients PB.

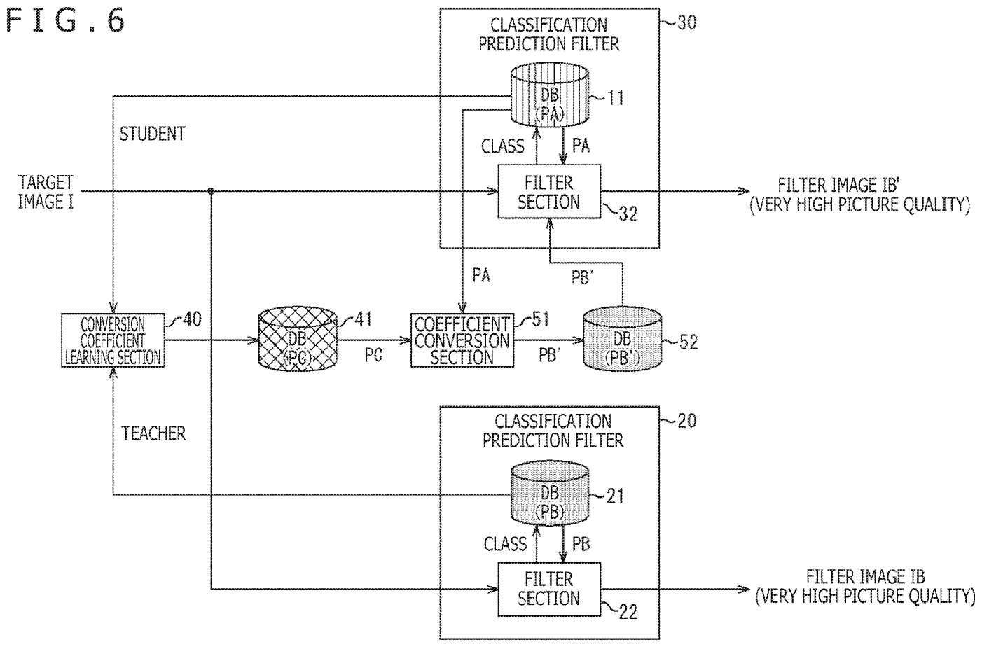

FIG. 6 is a view illustrating a classification prediction process that uses a tap coefficient PB′ obtained using a conversion coefficient.

It is to be noted that, in FIG. 6, portions corresponding to those in the case of FIG. 5 are denoted by identical reference signs, and in the following description, description of them is omitted suitably.

Referring to FIG. 6, a filter section 32 can perform a classification prediction process using, in addition to the tap coefficients PA of the ordinary performance stored in the DB 11, the tap coefficients PB′ of a level of performance equivalent to that of the tap coefficients PB stored in the DB 52.

In the case where the filter section 32 performs a classification prediction process using the tap coefficients PB′ stored in the DB 52, a filter image IB′ obtained by the classification prediction process is an image of very high picture quality similar to that of a filter image IB obtained by the classification prediction filter 20 performing a classification prediction process using the tap coefficients PB.

It is to be noted that the filter section 32 can also perform a classification prediction process using the tap coefficients PA stored in the DB 11.

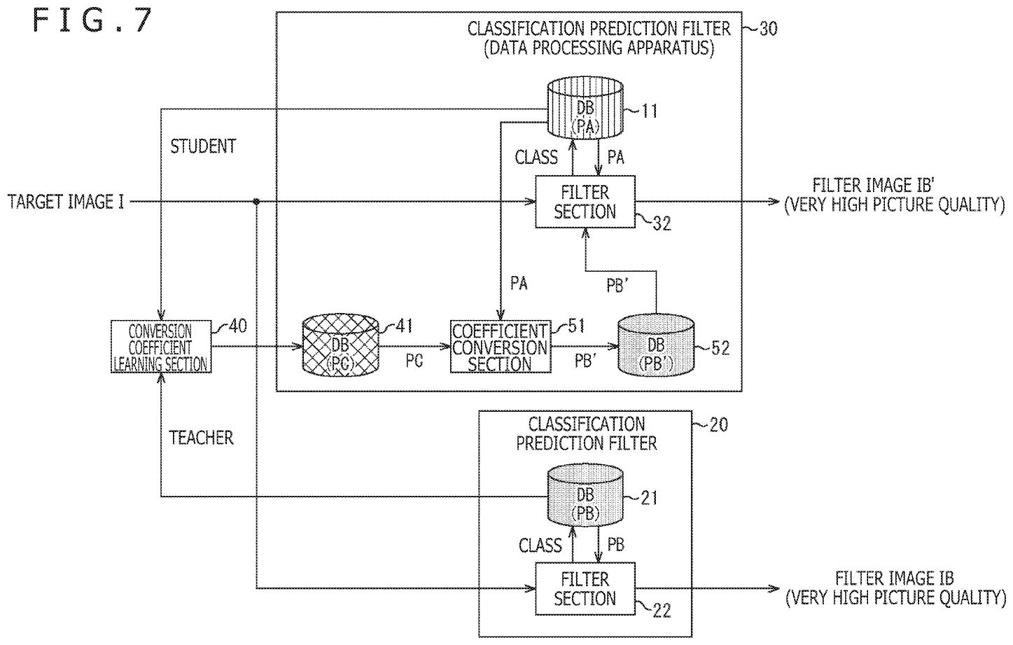

FIG. 7 is a view illustrating an overview of a classification prediction filter as a data processing apparatus to which the present technology is applied.

It is to be noted that, in FIG. 7, portions corresponding to those in the case of FIG. 6 are denoted by identical reference signs, and in the following description, description of them is omitted suitably.

The classification prediction filter 30 as a data processing apparatus to which the present technology is applied can include a DB 11, a filter section 32, a DB 41, a coefficient conversion section 51, and a DB 52.

In the classification prediction filter 30 configured in such a manner as just described, the filter section 32 can perform a filter process as a classification prediction process using tap coefficients PA of ordinary performance stored in the DB 11.

Further, in the classification prediction filter 30, the coefficient conversion section 51 converts a tap coefficient PA of the ordinary performance into a tap coefficient PB′ of high performance similar to that of the tap coefficient PB according to the coefficient conversion expression of the expression (6), by using the tap coefficient PC stored in the DB 41, and stores the tap coefficient PB′ into the DB 52.

Further, in the classification prediction filter 30, the filter section 32 can perform a filter process as a classification prediction process using the tap coefficients PB′ of high performance stored in the DB 52.

Accordingly, the classification prediction filter 30 can perform a filter process of a high degree of freedom and a high degree of improvement in picture quality.

It is to be noted that, since the coefficient conversion expression of the expression (6) converts a tap coefficient PA into a tap coefficient PB′ (prediction value of a tap coefficient PB), it also is a tap coefficient conversion expression and a filter coefficient conversion expression.

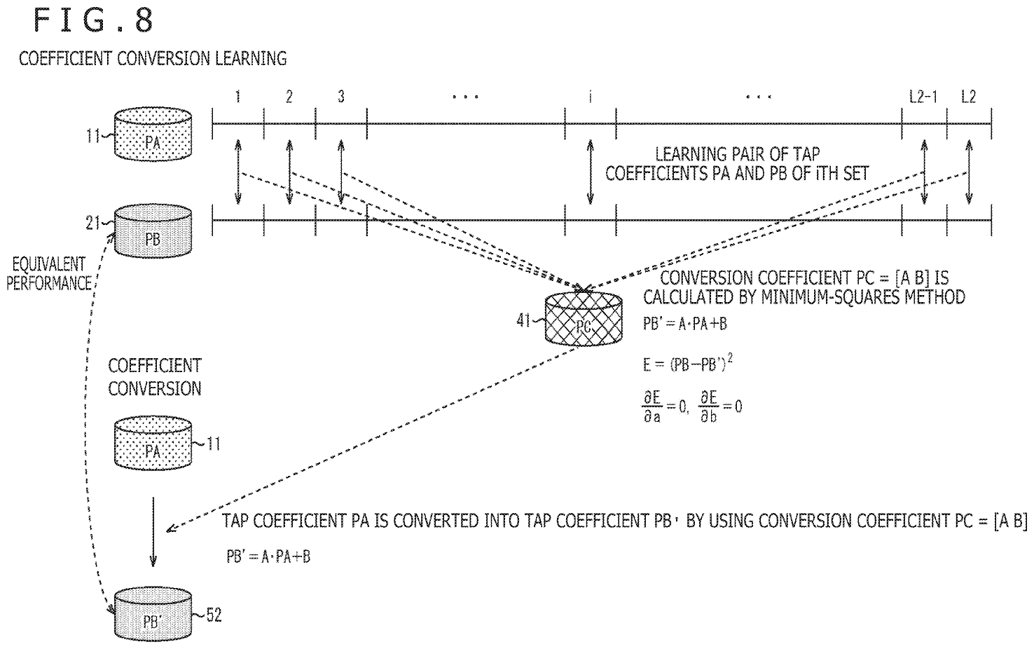

FIG. 8 is a view illustrating conversion coefficient learning and coefficient conversion using a conversion coefficient obtained by the conversion coefficient learning.

In particular, FIG. 8 is a view illustrating an example of conversion coefficient learning for learning a tap coefficient PC for converting a tap coefficient PA of ordinary performance into a tap coefficient PB′ that is a prediction value of a tap coefficient PB of high performance and coefficient conversion for converting the tap coefficient PA into the tap coefficient PB′ with use of the tap coefficient PC.

In the conversion coefficient learning, tap coefficient learning for obtaining tap coefficients PA and PB is performed first. In the tap coefficient learning, for example, learning pairs of a teacher image and a student image of L1 frames, L1 being a plural number, are prepared for L2 sets, L2 being a plural number, and, for each of the L2 sets of learning pairs, tap coefficient learning using the set of learning pairs is performed to calculate L2 sets of tap coefficients PA and L2 sets of tap coefficients PB.

In the conversion coefficient learning, the tap coefficients PA and PB of the ith set among the L2 sets of tap coefficients PA and the L2 sets of tap coefficients PB are used as a learning pair, and using the L2 sets of learning pairs, a tap coefficient PC=[A B] that statistically minimizes the error E=(PB—PB′)² between a tap coefficient PB′ that is a prediction value of a tap coefficient PB obtained by the coefficient conversion expression PB′=A·PA+B and the true value of the tap coefficient PB is obtained by a least-squares method or the like.

Here, it is assumed that each conversion coefficient of the set “A” of conversion coefficients is represented by “a” and each conversion coefficient of a set “B” of conversion coefficients is represented by “b.”

In the conversion coefficient learning, a tap coefficient PC=[A B] that is a set of conversion coefficients “a” and “b” with which both a partial differentiation ∂E/∂a of the error E with the conversion coefficient “a” and a partial differentiation ∂E/∂b of the error E with the conversion coefficient “b” become zero is calculated.

Using the tap coefficient PC, coefficient conversion of converting the tap coefficient PA into the tap coefficient PB′ is performed according to the coefficient conversion expression PB′=A·PA+B.

According to the coefficient conversion expression PB′=A·PA+B, various coefficient conversions can be performed. In particular, for example, a tap coefficient PA can be converted into a tap coefficient PB′ having a tap number (of prediction taps) different from that of the tap coefficient PA. Further, for example, a tap coefficient PA can be converted into a tap coefficient PB′ included in a prediction expression different from a prediction expression configured using the tap coefficient PA. Furthermore, for example, a tap coefficient PA can be converted into a tap coefficient PB′ of a class number different from that of the tap coefficient PA.

Here, in coefficient conversion that uses a conversion coefficient PC obtained by performing conversion coefficient learning using tap coefficients PA and PB as a learning pair, although, in a strict sense, the tap coefficient PA is converted into a tap coefficient PB′ that is a prediction value of the tap coefficient PB, such coefficient conversion can also be expressed that a tap coefficient PA is converted into a tap coefficient PB, for the convenience of description. Similarly, the coefficient conversion expression PB′=A·PA+B for converting a tap coefficient PA into a tap coefficient PB′ that is a prediction value of a tap coefficient PB is also represented as a coefficient conversion expression PB=A·PA+B.

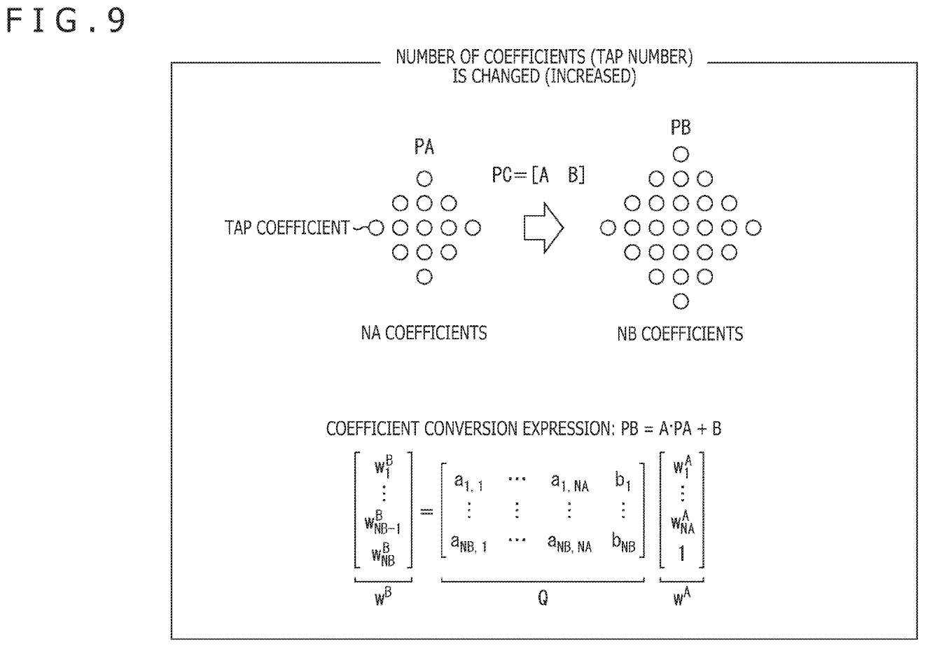

FIG. 9 is a view illustrating a coefficient conversion expression for converting a tap coefficient PA into a tap coefficient PB whose tap number is different from that of the tap coefficient PA.

It is to be noted that, in FIG. 9, in order to simplify the description, the classes of the tap coefficients PA and PB are not to be taken into consideration. In other words, the number of classes of the tap coefficients PA and PB is assumed to be one.

Further, it is assumed that, in the following description, the tap number (of prediction taps) of the tap coefficients PA is NM and the tap number of the tap coefficients PB is NB.

If column vectors that include the tap coefficients PA and PB as elements are represented by W^{A} and W^{B}, respectively, then, the coefficient conversion expression for converting the tap coefficient PA into (a tap coefficient PB′ that is a prediction value of) the tap coefficient PB can be presented by an expression W^{B}=QW^{A} as depicted in FIG. 9.

Referring to FIG. 9, W^{B} represents a column vector whose elements are NB tap coefficients w^{B}i. The tap coefficient w^{B}ᵢ is an ith tap coefficient in the set PB of tap coefficients. Assumed by i is an integer value within the range of 1 to NB.

Referring to FIG. 9, W^{A} represents a column vector whose elements are NA tap coefficients w^{A}ⱼ and one integer 1. The column vector W^{A} includes NA tap coefficient w^{A}ⱼ and one integer 1 arranged in this order. The tap coefficient w^{A}ⱼ is a jth tap coefficient in the set PA of tap coefficients. j assumes an integer value within a range of 1 to NA.

In FIG. 9, Q represents a matrix of NB rows and NA+1 columns whose elements are conversion coefficients a_{i,j} and bᵢ. The conversion coefficient a_{i,j} is an individual conversion coefficient of the set “A” of conversion coefficients and is a conversion coefficient to be multiplied with the jth tap coefficients w^{A}ⱼ for calculating the ith tap coefficients w^{B}ᵢ The conversion coefficient bᵢ is a conversion coefficient as an ith constant term of the set “B” of conversion coefficients. In the matrix Q, the conversion coefficient a_{i,j} is an element at row i and column j, and the conversion coefficient bᵢ is an element at row i and column NA+1.

According to such a coefficient conversion expression W^{B}=QW^{A} as described above, tap coefficients PA whose tap number is NA can be converted into tap coefficients PB whose tap number is NB.

It is to be noted that, although NA and NB in FIG. 9 have a relation of NA<NB, tap coefficients PA can be converted into tap coefficients PB even if NA and NB have a relation of NA>NB.

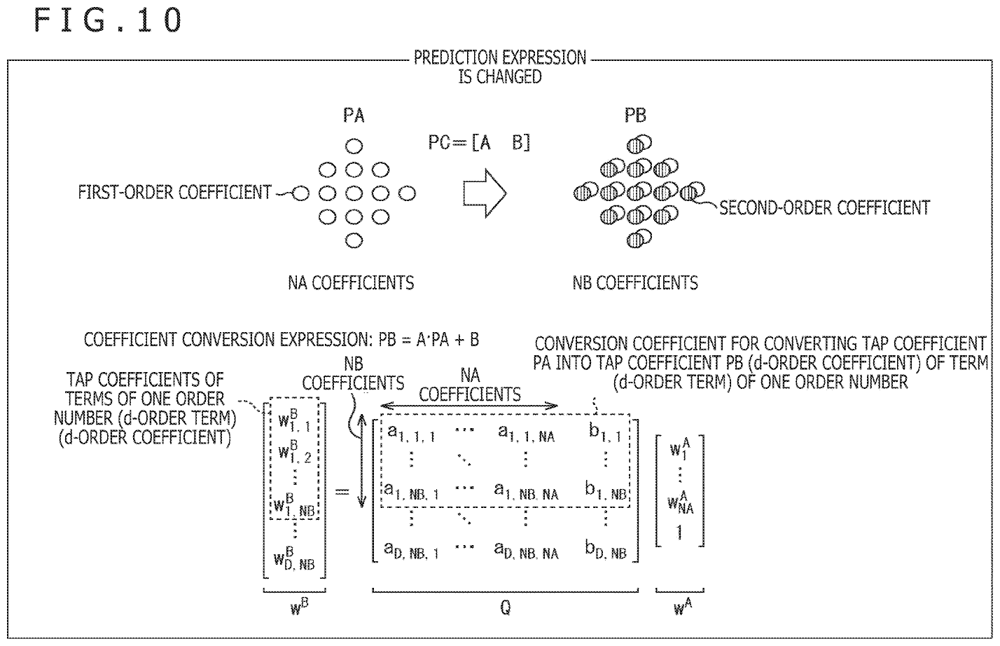

FIG. 10 is a view illustrating a coefficient conversion expression for converting a tap coefficient PA into a tap coefficient PB included in a prediction expression different from a prediction expression configured using the tap coefficient PA.

It is to be noted that, in FIG. 10, in order to simplify the description, the classes of the tap coefficients PA and PB are not to be taken into consideration similarly as in the case of FIG. 9.

Now, it is assumed that the prediction expression configured using a tap coefficient PB is a second-order or higher D-order prediction expression. It is to be noted that, in order to simplify the description, it is assumed that the numbers of tap coefficients (first-order coefficients and b-order coefficients) of order numbers of the D-order prediction expression are NB and equal to each other. In FIG. 10, the prediction expression configured using tap coefficients PA is a first-order prediction expression having tap coefficients of only first-order coefficients and the prediction expression configured using tap coefficients PB is a second-order prediction expression having tap coefficients of first-order coefficients and second-order coefficients.

If column vectors whose elements are tap coefficients PA and PB are each to be represented by W^{A} and W^{B}, then, the coefficient conversion expression for converting a tap coefficient PA into a tap coefficient PB can be represented by an expression W^{B}=QW^{A} as depicted in FIG. 10.

Referring to FIG. 10, W^{B} represents a column vector whose elements are NB x D tap coefficients w^{B}_{d,i}. The tap coefficient w^{B}_{d,i} is an ith tap coefficient configuring a d-order term (d-order coefficient) in the set PB of tap coefficients. Assumed by d is an integer value within the range from 1 to D, and assumed by i is an integer value within the range from 1 to NB.

In FIG. 10, W^{A} represents a column vector whose elements are NA tap coefficients w^{A}ⱼ and one integer 1 similarly as in the case of FIG. 9.

In FIG. 10, Q represents a matrix of NB x D rows and NA+1 columns and has elements given by the conversion coefficients and b_{d,i}. The conversion coefficient a_{d,i}, is an individual conversion coefficient of the set “A” of conversion coefficients and is a conversion coefficient to be multiplied with the jth tap coefficient w^{A}ⱼ for calculating the ith tap coefficients w^{B}_{d,i} configuring the d-order term. The conversion coefficient b_{d,i} is a conversion coefficient as the ((d−1)×NB+i)th constant term of the set “B” of conversion coefficients. In the matrix Q, the conversion coefficient aₐ,i, is an element of the ((d−1)×NB+i)th row and the jth column, and the conversion coefficient b_{d,i} is an element of the ((d−1)×NB+i)th row and the (NA+1)th column.

The conversion coefficients a_{d,1,1} to a_{d,NB,NA} and the conversion coefficients b_{d,1} to b_{d,NB} are conversion coefficients for converting (the column vector including as elements thereof) the tap coefficients W^{A} into tap coefficients (d-order coefficients) w^{B}_{d,1} to W^{B}_{d,NB} that configure the d-order terms.

According to such a coefficient conversion expression W^{B}=QW^{A} as described above, tap coefficients PA can be converted into tap coefficients PB configuring a prediction expression different from a prediction expression configured using the tap coefficients PA.

It is to be noted that, while, in FIG. 10, the prediction expression configured using tap coefficients PA is a first-order prediction expression and the prediction expression configured using tap coefficients PB is a second-order prediction expression, the prediction expression configured using tap coefficients PA and the prediction expression configured using tap coefficients PB are not limited to a first-order prediction expression or a second-order prediction expression.

Further, the prediction expression being different includes, in addition to the case in which the order numbers of prediction expressions are different from each other as described above, any case in which the prediction expressions are different in “form.” Accordingly, even if prediction expressions are of the same order number, in the case where they are different in tap number (term number), the prediction expressions having the different tap numbers are different prediction expressions. Accordingly, the coefficient conversion expression for converting tap coefficients PA into tap coefficients PB having a tap number different from that of the tap coefficients PA described hereinabove with reference to FIG. 9 is also a coefficient conversion expression for converting tap coefficients PA into tap coefficients PB configuring a prediction expression different from a prediction expression configured using the tap coefficients PA described hereinabove with reference to FIG. 10. Similarly, the coefficient conversion expression for converting tap coefficients PA into tap coefficients PB configuring a prediction expression different from a prediction expression configured using the tap coefficients PA described hereinabove with reference to FIG. 10 is also a coefficient conversion expression for converting tap coefficients PA into tap coefficients PB having a tap number different from that of the tap coefficients PA described hereinabove with reference to FIG. 9.

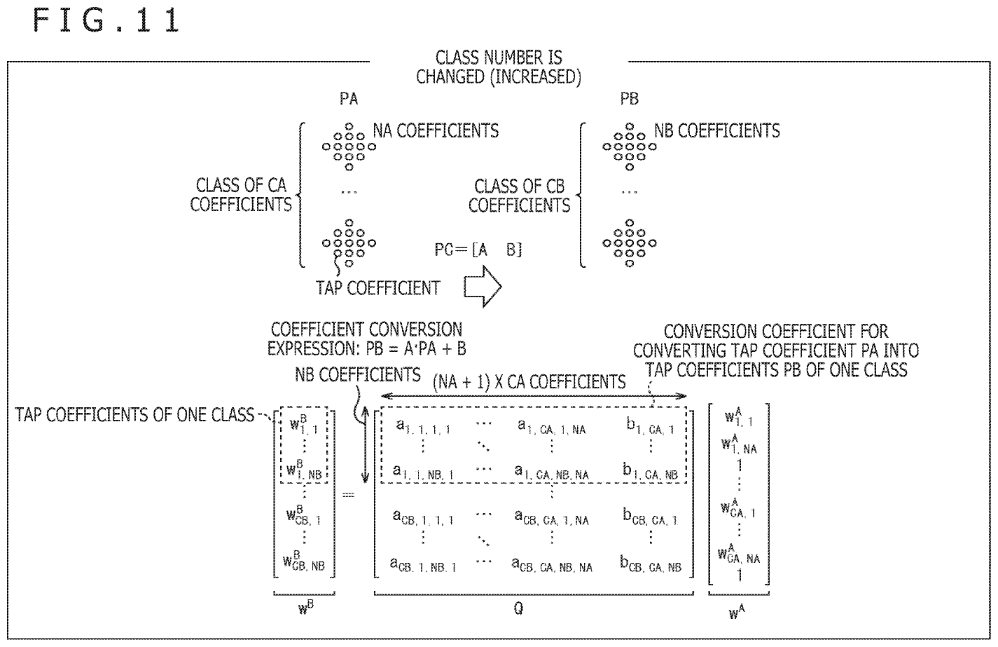

FIG. 11 is a view illustrating a coefficient conversion expression for converting tap coefficients PA into tap coefficients PB′ of a class number different from that of the tap coefficients PA.

In FIG. 11, the class number of tap coefficients PA is CA, and the class number of tap coefficients PB is CB (0 CA). Further, in FIG. 11, NA represents a tap number (of prediction taps) of tap coefficients PA of one class, and NB represents a tap number of tap coefficients PB of one class. In this case, the total number of tap coefficients PA is CA×NA, and the total number of tap coefficients PB is CB×NB.

If column vectors that include the tap coefficients PA and PB as elements are each to be represented by W^{A} and W^{B}, then, the coefficient conversion expression for converting the tap coefficients PA into the tap coefficients PB can be represented by the expression W^{B}=QW^{A} as depicted in FIG. 11.

Referring to FIG. 11, W^{B} represents a column vector whose elements are NB x CB tap coefficients w^{B}_{cb,i}. The tap coefficient w^{B}_{cb,i} is an ith tap coefficient of the class cb in the set PB of tap coefficients. Assumed by cb is an integer value within the range from 1 to CB, and assumed by i is an integer value within the range from 1 to NB.

In FIG. 11, W^{A} represents a column vector whose elements are, for example, NA×CA tap coefficients w^{A}_{ca,i} and CA integers of 1. The column vector W^{A} includes the number of sets of NA tap coefficients W^{A}_{ca,i} and one integer of 1 arranged repeatedly in an ascending order of ca, the number being equal to CA. The tap coefficient W^{A}_{ca,i} is a jth tap coefficient of the class ca in the set PA of tap coefficients. Assumed by ca is an integer value within the range from 1 to CA, and assumed by j is an integer value within the range from 1 to NA.

In FIG. 11, Q represents a matrix of NB x CB rows and (NA+1)×CA columns and has elements given by the conversion coefficients a_{cb,ca,i,j} and the constituent element b_{cb,ca,i} of conversion coefficients of constant terms. The conversion coefficient a_{cb,ca,i,j} is an individual conversion coefficient of the set “A” of conversion coefficients and is a conversion coefficient to be multiplied with the jth tap coefficient w^{A}_{ca,i} of the class ca for calculating the ith tap coefficients w^{B}_{cb,i} of the class cb. The constituent element b_{cb,ca,i} is a (ca)th constituent element of the conversion coefficients b_{cb,i,i,}+b_{cb,2,i,}+ . . . +b_{cb,CA,i} as a ((cb−1)×NB+i)th constant term of the set “B” of conversion coefficients. In the matrix Q, in the (cb−1)×NB+i rows, the conversion coefficients a_{cb,ca,i,j} and the constituent elements b_{cb,ca,i} are arranged in the order of a_{cb,1,1,1}, a_{cb,1,1,2}, . . . , a_{cb,1,i,NA}, b_{cb,1,i}, a_{cb,2,i,1}, a_{cb,2,i,2}, . . . , a_{cb,2,i,NA}, b_{cb,2,i,}, . . . a_{cb,CA,i,1}, a_{cb,CA,i,2}, . . . , a_{cb,CA,i,NA}, b_{cb,CA,i}.

It is assumed that NB rows when the matrix Q is divided for each NB rows are referred to as a partial matrix of the matrix Q. A partial matrix of the matrix Q is a matrix of NB rows and (NA+1)×CA columns, and by this partial matrix, tap coefficients PA of CA classes in each of which the tap number is NA, i.e., NA×CA tap coefficients W^{A}_{ca,j}, are converted into NB tap coefficients PB for one class, i.e., into tap coefficients w^{B}_{cb,1}, w^{B}_{cb,2}, . . . , w^{B}_{cb,NB}.

According to such a coefficient conversion expression W^{B}=QW^{A} as given hereinabove, tap coefficients PA can be converted into tap coefficients PB of a class number different from that of the tap coefficients PA.

Such coefficient conversion as described above can be applied not only to a case in which tap coefficients PA that are first filter coefficients are converted into tap coefficients PB that are second filter coefficients different from the first filter coefficients but also to another case in which coefficients other than filter coefficients are converted into filter coefficients and a further case in which filter coefficients are converted into coefficients other than filter coefficients.

Therefore, coefficient conversion for converting a tap coefficient PA into a seed coefficient is described.

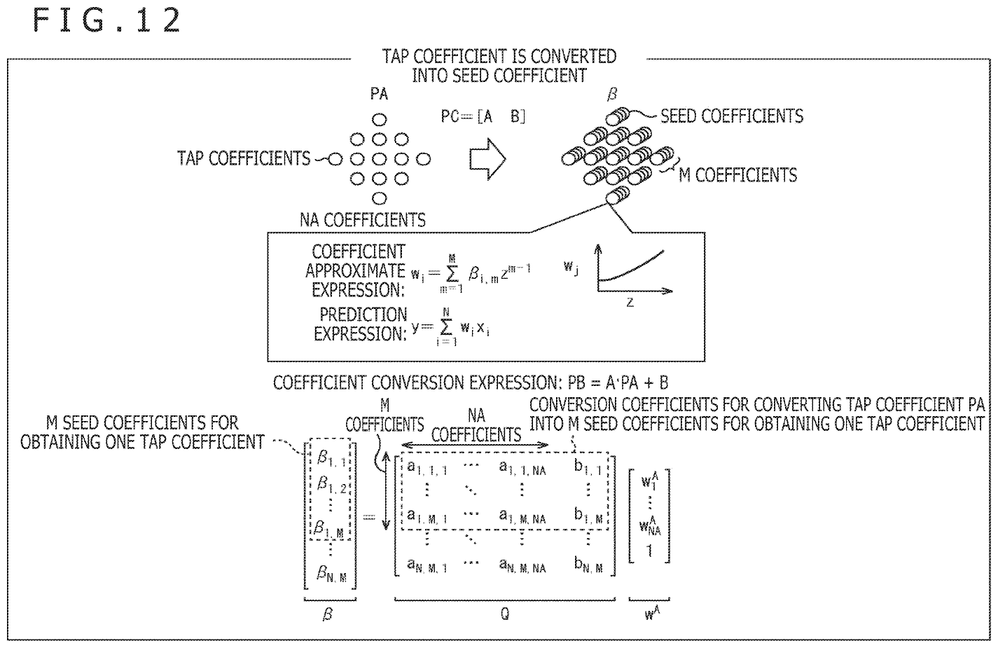

FIG. 12 is a view illustrating a coefficient conversion expression (seed coefficient conversion expression) for converting a tap coefficient PA into (a prediction value of) a seed coefficient R.

It is to be noted that, in FIG. 12, in order to simplify the description, classes of the tap coefficient PA and the seed coefficients 13 are not to be taken into consideration similarly as in the case of FIG. 9.

According to the seed coefficient β_{i,m}, if a parameter z is given, then, tap coefficients wᵢ that configure, for example, a prediction expression y=Σwᵢxᵢ can be calculated according to the coefficient approximate expression wᵢ=Σβ_{i,m}z^{m-1}.

Here, the seed coefficient β_{i,m} is an mth seed coefficient 3, used to calculate the ith tap coefficient wᵢ.

If it is assumed that M seed coefficients β_{i,m} are used in order to calculate the ith tap coefficient wᵢ, then, the summation (Σ) of the coefficient approximate expression wᵢ=Σβ_{i,m}z^{m-1} represents a summation with the variable m changed into integer values within the range from 1 to M.

Further, if it is assumed that N tap coefficients w₁, w₂, . . . , w_{N} are calculated by the coefficient approximate expression wᵢ=Σβ_{i,m}z^{m-1}, then, the summation of the prediction expression y=Σwᵢxᵢ configured using the tap coefficients wᵢ calculated by the coefficient approximate expression wᵢ=Σβ_{i,m}z^{m-1} represents a summation with the variable i changed to integers within the range from 1 to N.

It is assumed now that the tap number of tap coefficients PA is NA and the tap coefficients PA are converted into seed coefficients β that are approximated to tap coefficients including the tap coefficients w₁, w₂, . . . , w_{N}. It is possible to cause a tap coefficient PA to be included or not to be included into a tap coefficient wᵢ, to which a seed coefficient β is approximated, by a learning pair (set of a seed coefficient and a tap coefficient) that is used in conversion coefficient learning for calculating a conversion coefficient for converting a tap coefficient PA into a seed coefficient.

Here, in a strict sense, β represents a set of M×N seed coefficients R, that is, for example, a column vector whose elements are seed coefficients β_{i,m}.

If a column vector including tap coefficients PA as elements thereof is represented by W^{A}, then, a coefficient conversion expression for converting tap coefficients PA into seed coefficients β can be represented by the expression β=QW^{A} as depicted in FIG. 12.

Referring to FIG. 12, β represents a column vector whose elements are N×M seed coefficients β_{i,m}. Assumed by m is an integer value within the range from 1 to M, and assumed by i is an integer value within the range from 1 to N.

In FIG. 12, W^{A} represents a column vector whose elements are NA tap coefficient w^{A}ⱼ and one integer 1 similarly as in the case of FIG. 9.

In FIG. 12, Q represents a matrix of N×M rows and NA+1 columns whose elements are conversion coefficients a_{i,m,j} and b_{i,m}. The conversion coefficient a_{i,m,j} is an individual conversion coefficient of the set “A” of conversion coefficients and is a conversion coefficient to be multiplied with the jth tap coefficient w^{A}ⱼ for calculating the mth seed coefficient β_{i,m} that is used to calculate the ith tap coefficient wᵢ. The conversion coefficient b_{i,m} is a conversion coefficient as an ((i−1)×M+m)th constant term of the set “B” of conversion coefficients. In the matrix Q, the conversion coefficient a_{i,m,j} is an element in the ((i−1)×M+m)th row and the jth column, and the conversion coefficient b_{i,m} is an element in the ((i−1)×M+m)th row and the (NA+1)th column.

The conversion coefficients a_{i,1,1} to a_{i,M,NA} and the conversion coefficients b_{i,1} to b_{i,m} are conversion coefficients for converting (the column vector including as elements) tap coefficients W^{A} into M seed coefficients β_{i,1} to β_{i,m} that are used to calculate the ith tap coefficient wᵢ.

According to such a coefficient conversion expression 13=QW^{A}, a tap coefficient PA can be converted into a seed coefficient β included in a coefficient approximate expression for approximating the tap coefficient wᵢ.

It is to be noted that the coefficient conversion expression 13=QW^{A} is a seed coefficient conversion expression.

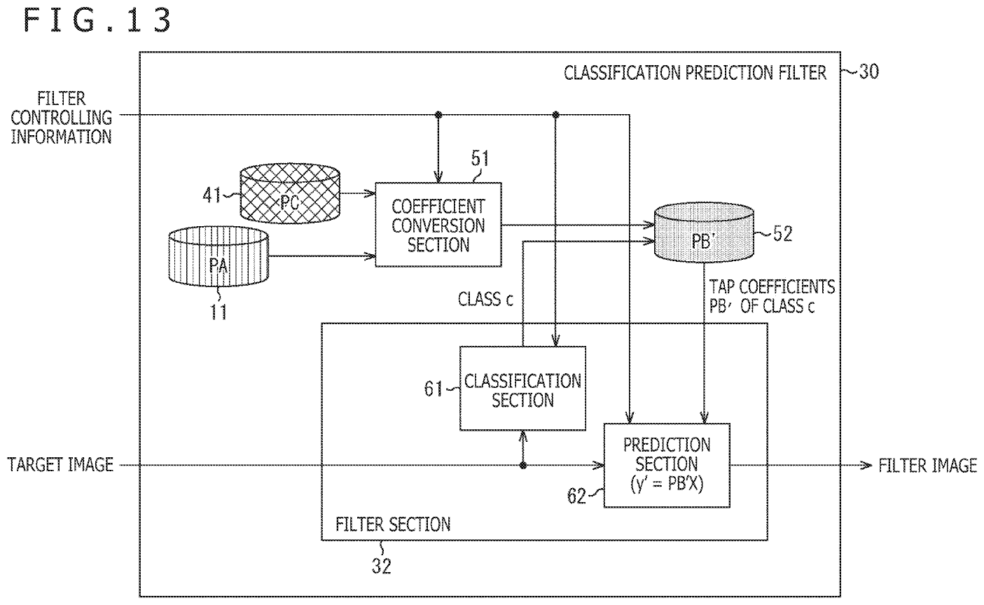

FIG. 13 is a block diagram depicting an example of a detailed configuration of the classification prediction filter 30.

In particular, FIG. 13 depicts an example of a detailed configuration of the classification prediction filter 30 that has such functions of coefficient conversion for converting a tap coefficient PA into (a tap coefficient PB′ that is a prediction value of) a tap coefficient PB and of coefficient conversion for converting a tap coefficient PA into a seed coefficient β.

It is to be noted that, in FIG. 13, portions corresponding to those in the case of FIG. 7 are denoted by identical reference signs, and in the following description, description of them is omitted suitably.

The classification prediction filter 30 includes a DB 11, a filter section 32, a DB 41, a coefficient conversion section 51, and a DB 52. The filter section 32 includes a classification section 61 and a prediction section 62.

A target image and filter controlling information are supplied to the classification prediction filter 30. The target image is an image that is made a target of a filter process as a classification prediction process, and the filter controlling information is information used to control a filter process as a classification prediction process and representing a tap number, a tap structure, a classification method, (a form of) a prediction expression and so forth. The filter controlling information includes prediction related information and classification related information. The prediction related information is information related to a prediction process and includes, for example, information for specifying processing contents of the prediction process such as a tap number or a tap structure of a prediction tap and a prediction expression to be used in a prediction process. The classification related information is information related to classification and includes information for specifying the processing contents of classification such as a classification method, a class number, a tap number and a tap structure of class taps and so forth.

The target image is supplied to the classification section 61 and the prediction section 62, and the filter controlling information is supplied to the coefficient conversion section 51, the classification section 61, and the prediction section 62.

The coefficient conversion section 51 recognizes (analyzes) a class number and so forth of tap coefficients PB′ to be calculated according to a coefficient conversion expression from the filter controlling information and converts the tap coefficients PA stored in the DB 11 into tap coefficients PB′ according to a coefficient conversion expression stored in the DB 41 and configured using the conversion coefficient PC=[A B], on the basis of a result of the recognition. The coefficient conversion section 51 supplies the tap coefficients PB′ to the DB 52 so as to be stored into the DB 52.

On the other hand, the classification section 61 recognizes a method of classification and so forth from the filter controlling information. Further, the classification section 61 sequentially selects the pixels of the target image as a noticed pixel and performs classification of the noticed pixel on the basis of a result of the recognition of the method of classification and so forth from the filter controlling information. In particular, for example, the classification section 61 selects a pixel that becomes a class tap of the noticed pixel from the target image and performs classification using the class tap. Then, the classification section 61 supplies a class c of the noticed pixel to the DB 52.

The DB 52 reads out tap coefficients PB′ of the class c of the noticed pixel from the tap coefficients PB′ (of the individual classes) stored therein and supplies the tap coefficients PB′ to the prediction section 62.

The prediction section 62 recognizes a prediction expression and so forth from the filter controlling information and performs, for the target image, a filter process as a prediction process for applying a prediction expression including the tap coefficients PB′ of the class of the noticed pixel from the DB 52, on the basis of a result of the recognition, to generate a filter image.

In particular, the prediction section 62 selects a pixel that becomes a prediction tap of the noticed pixel from the target image and calculates a prediction expression including the prediction tap and the tap coefficients PB′ of the class of the noticed pixel from the DB 52, to obtain a prediction value y′ of an image, which corresponds to a teacher image used in tap coefficient learning of the tap coefficient PB, as a pixel value of a pixel of the filter image corresponding to the noticed pixel.

Here, if it is assumed that PB′ represents a row vector whose elements are tap coefficients and X represents a column vector whose elements are (pixel values of the pixels of) the prediction taps, then, a first-order prediction expression including the prediction taps and the tap coefficients PB′ of the class of the noticed pixel is represented by the expression y′=PB′X.

By converting tap coefficients PA into tap coefficients PB′ in such a manner as described above, the classification prediction filter 30 can selectively perform a filter process as a prediction process using the tap coefficients PA and a filter process as a prediction process that uses the tap coefficients PB′ as occasion demands. Thus, a filter process of a high degree of freedom can be achieved.

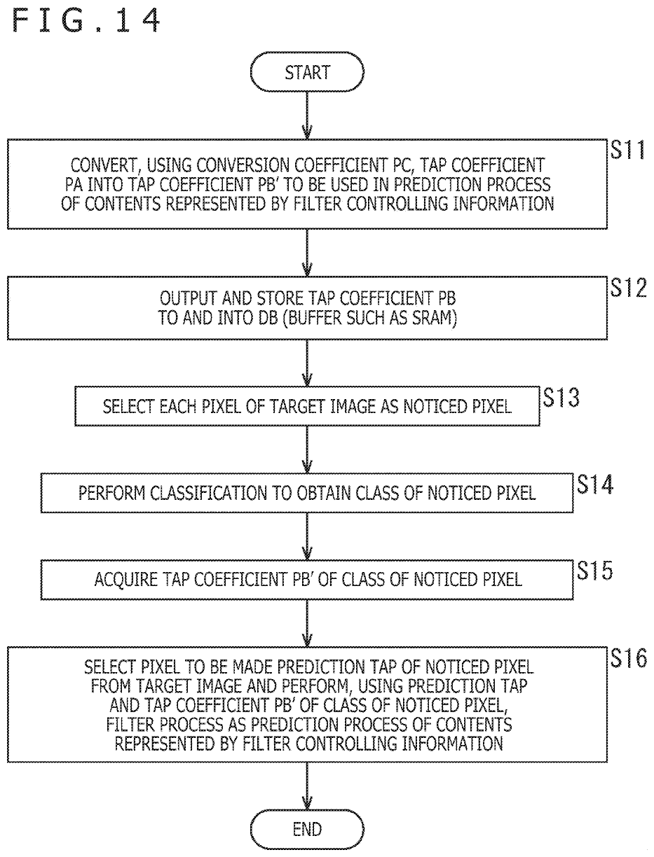

FIG. 14 is a flowchart illustrating processing of the classification prediction filter 30 of FIG. 13.

In step S11, the coefficient conversion section 51 converts tap coefficients PA stored in the DB 11 into tap coefficients PB′, which are to be used in a prediction process of the substance represented by filter controlling information, with use of conversion coefficients PC stored in the DB 41, and the processing advances to step S12.

In step S12, the coefficient conversion section 51 supplies the tap coefficients PB′ to the DB 52 so as to be stored, and the processing advances to step S13.

In step S13, the classification section 61 sequentially selects the pixels of a target image as a noticed pixel, and the processing advances to step S14.

In step S14, the classification section 61 performs classification of the substance represented by the filter controlling information in regard to the noticed pixel to obtain the class of the noticed pixel and supplies the class of the noticed pixel to the DB 52. Then, the processing advances to step S15.

In step S15, the DB 52 acquires a tap coefficient PB′ of a class of the noticed pixel from among the tap coefficients PB′ stored in step S12 and supplies the tap coefficient PB′ to the prediction section 62, and the processing advances to step S16.

In step S16, the prediction section 62 selects pixels that become prediction taps of the noticed pixel from within the target image according to the filter controlling information. Further, the prediction section 62 performs a filter process as a prediction process represented by the filter controlling information, by using the prediction taps of the noticed pixel and the tap coefficients PB′ of the class of the noticed pixel from the DB 52. In particular, the prediction section 62 calculates a prediction expression including the prediction taps of the noticed pixel and the tap coefficients PB′ of the class of the noticed pixel from the DB 52 and specified (in form) by the filter controlling information. The prediction section 62 outputs a filter image obtained by the filter process as a prediction process, i.e., by calculation of the prediction expression, and the processing is ended.

It is to be noted that, in FIG. 13, it is possible for the coefficient conversion section 51 to not only calculate the tap coefficients PB′ of all classes in advance but to also calculate only the tap coefficients PB′ of the class of the noticed pixel every time. Where the tap coefficients PB′ of all classes are calculated in advance, the calculation cost for coefficient conversion can be reduced in comparison with that in the case where only tap coefficients PB′ of the class of the noticed pixel are calculated every time.

Further, although the coefficient conversion section 51 in FIG. 13 converts a tap coefficient PA into a tap coefficient PB′, the tap coefficient PA can be converted into a seed coefficient β. In the case where a tap coefficient PA is converted into a seed coefficient the seed coefficient β of the class of the noticed pixel is supplied to the prediction section 62. In this case, the prediction section 62 calculates tap coefficients from a coefficient approximate expression including the seed coefficient β and performs a filter process as a prediction process for applying a prediction expression including the tap coefficients to the target image.

In the following, an image processing system to which the classification prediction filter 30 is applied is described. It is to be noted that, although the following description is directed to a case in which a certain filter coefficient (first filter coefficient) is converted into a filter coefficient (second filter coefficient) different from the filter coefficient in order to simplify the description, the image processing system can be applied not only to the case where a certain filter coefficient is converted into a filter coefficient different from the filter coefficient but also to a case in which a tap coefficient is converted into a seed coefficient.

<First Example of Configuration of Image Processing System to which Classification Prediction Filter 30 is Applied>

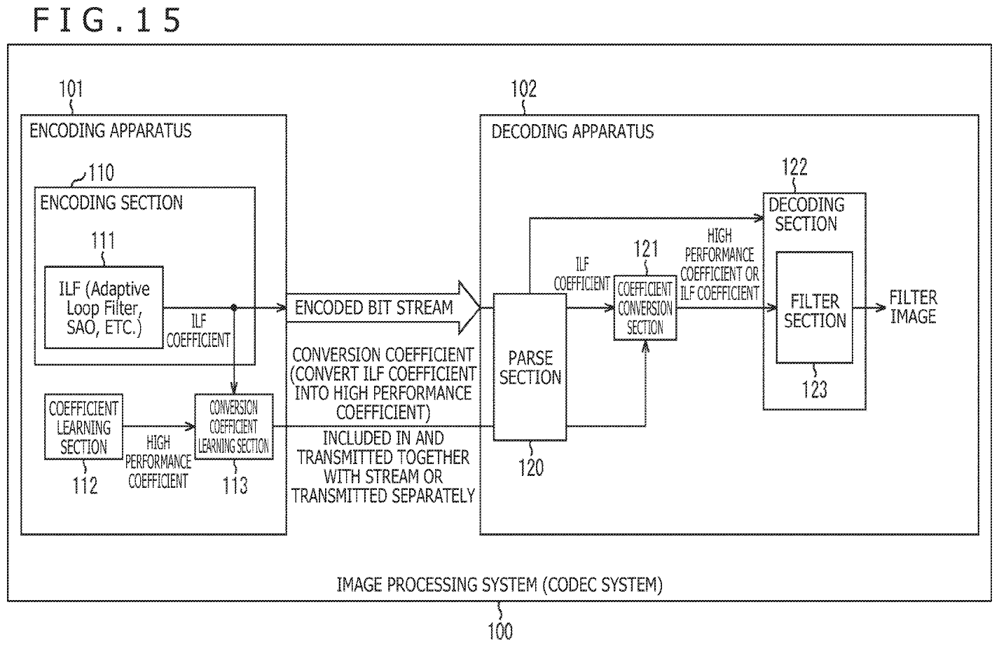

FIG. 15 is a block diagram depicting a first example of a configuration of the image processing system to which the classification prediction filter 30 is applied.

Referring to FIG. 15, an image processing system 100 is a codec system that encodes and decodes an image and includes an encoding apparatus 101 and a decoding apparatus 102.

The encoding apparatus 101 includes an encoding section 110, a coefficient learning section 112, and a conversion coefficient learning section 113.

The encoding section 110 includes an ILF 111 and performs prediction encoding of a source image of an encoding target. While, in the prediction encoding, local decoding is performed, in the local decoding, a decoded image is filter-processed by the ILF 111. Then, a prediction image of the source image is generated using an ILF image, which is an image obtained by the filter process, as a reference image.

The encoding section 110 generates an encoded bit stream that includes encoded data obtained by the prediction encoding of the source image and ILF coefficients (for example, ALF filter coefficients or the like) that are filter coefficients of the ILF 111, and sends (transmits) the encoded bit stream to the decoding apparatus 102.

Here, the ILF 111 is an existing ILF and is, for example, one or more of a deblocking filter, an adaptive offset filter, a bilateral filter, and an ALF. In the case where the ILF 111 is caused to function as two or more filters among a deblocking filter, an adaptive offset filter, a bilateral filter, and an ALF, the arrangement order of the two or more filters can be selected freely.

The coefficient learning section 112 uses the source image and the decoded image of the target of the filter process of the ILF 111 respectively as a teacher image and a student image, to perform tap coefficient learning and obtain tap coefficients (hereinafter also referred to as high performance coefficients) of a higher level of performance (than that of the ILF coefficients), and supplies the high performance coefficients to the conversion coefficient learning section 113.

To the conversion coefficient learning section 113, not only the high performance coefficients are supplied from the coefficient learning section 112, but also ILF coefficients are supplied from the encoding section 110. The conversion coefficient learning section 113 uses the high performance coefficients from the coefficient learning section 112 and the ILF coefficients from the ILF 111 respectively as teacher data and student data, to perform conversion efficient learning and thereby obtain conversion coefficients for converting the ILF coefficients into high performance coefficients.

The conversion coefficients are transmitted separately from the encoded bit stream or placed into and transmitted together with the encoded bit stream to the decoding apparatus 102.

The decoding apparatus 102 includes a parse section 120, a coefficient conversion section 121, and a decoding section 122.

The parse section 120 supplies encoded data included in the encoded bit stream from the encoding apparatus 101 to the decoding section 122. Further, the parse section 120 parses ILF coefficients included in the encoded bit stream and supplies the ILF coefficients to the coefficient conversion section 121. Furthermore, in the case where conversion coefficients are included in the encoded bit stream, the parse section 120 parses the conversion coefficients included in the encoded bit stream and supplies the conversion coefficients to the coefficient conversion section 121.

It is to be noted that, in the case where conversion coefficients are not included in the encoded bit stream and are transmitted separately, the parse section 120 receives and supplies the conversion coefficients to the coefficient conversion section 121.

The coefficient conversion section 121 is equivalent to the coefficient conversion section 51 of the classification prediction filter 30 (FIG. 13). The coefficient conversion section 121 uses a coefficient conversion expression including the conversion coefficients supplied from the parse section 120 similarly to the ILF coefficients supplied from the parse section 120, to convert the ILF coefficients into (prediction values of) high performance coefficients (for which a filter process is to be performed) that are higher in degree of improvement of picture quality than the ILF coefficients. The coefficient conversion section 121 selects the ILF coefficients from the parse section 120 or high performance coefficients according to an operation of a user, an instruction from the outside or the like, and supplies the selected coefficient to the decoding section 122.

The decoding section 122 includes a filter section 123 equivalent to the filter section 32 of the classification prediction filter 30 (FIG. 13). The decoding section 122 decodes the encoded data supplied from the parse section 120, to generate a decoded image. Further, in the decoding section 122, the filter section 123 performs a filter process for the decoded image by using the ILF coefficients or high performance coefficients from the coefficient conversion section 121 to generate a filter image and outputs the filter image as a final decoded image.

In particular, in the case where ILF coefficients are supplied from the coefficient conversion section 121 to the decoding section 122, the filter section 123 uses the ILF coefficients to perform a filter process same as that of the ILF 111, but in the case where high performance coefficients are supplied from the coefficient conversion section 121 to the decoding section 122, the filter section 123 uses the high performance coefficients to perform a filter process as a classification prediction process.

Accordingly, in the case where high performance coefficients are supplied from the coefficient conversion section 121 to the decoding section 122, since the high performance coefficients are used to perform a filter process as a classification prediction process, a final decoded image having picture quality of good appearance can be obtained.

It is to be noted that the coefficient learning section 112 of the encoding apparatus 101 can perform seed coefficient learning to obtain seed coefficients configuring a coefficient approximate expression that approximates high performance coefficients, and the conversion coefficient learning section 113 can perform conversion coefficient learning of obtaining conversion coefficients for converting ILF coefficients into seed coefficients. In this case, the coefficient conversion section 121 of the decoding apparatus 102 uses a coefficient conversion expression including conversion coefficients, to convert the ILF coefficients into (prediction values of) seed coefficients. Then, the filter section 123 uses the coefficient approximate expression including the seed components, to obtain high performance coefficients, and performs a filter process using the high performance coefficients.

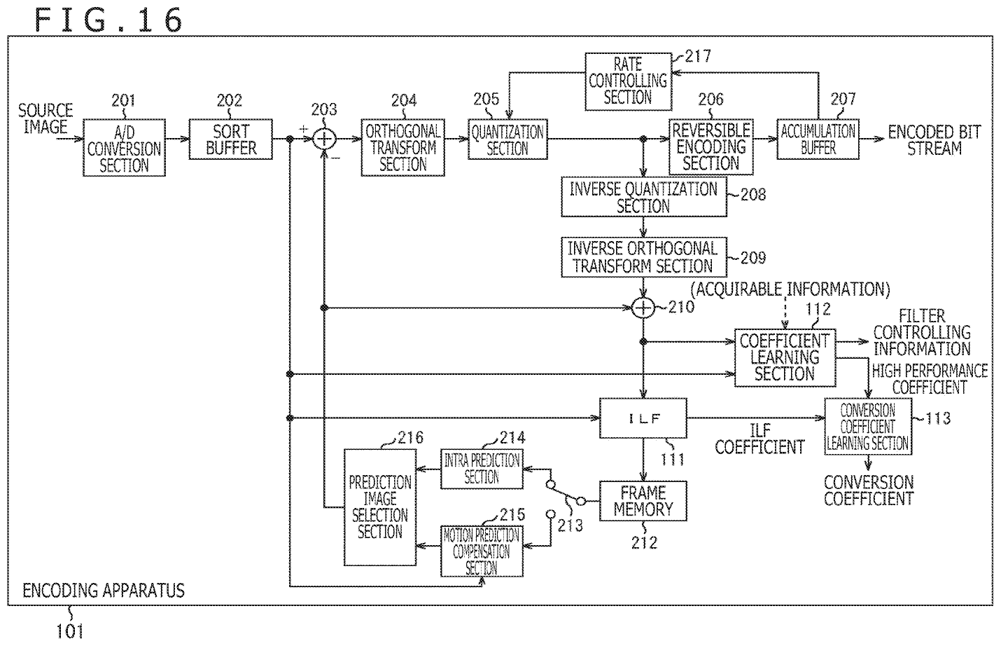

FIG. 16 is a block diagram depicting an example of a detailed configuration of the encoding apparatus 101 of FIG. 15.

Referring to FIG. 16, the encoding apparatus 101 includes an ILF 111, a coefficient learning section 112, and a conversion coefficient learning section 113. The encoding apparatus 101 further includes an A/D conversion section 201, a sort buffer 202, a calculation section 203, an orthogonal transform section 204, a quantization section 205, a reversible encoding section 206, an accumulation buffer 207, an inverse quantization section 208, an inverse orthogonal transform section 209, a calculation section 210, a frame memory 212, a selection section 213, an intra prediction section 214, a motion prediction compensation section 215, a prediction image selection section 216, and a rate controlling section 217.

To the ILF 111, a source image is supplied from the sort buffer 202 and a decoded image is supplied from the calculation section 210. The ILF 111 calculates ILF coefficients necessary for a filter process by using the source image and the decoded image as occasion demands and performs a filter process for the decoded image from the calculation section 210 by using the ILF coefficients. Further, the ILF 111 supplies an ILF image obtained by the filter process to the frame memory 212 and supplies the ILF coefficients used in the filter process to the conversion coefficient learning section 113.

To the coefficient learning section 112, the source image is supplied from the sort buffer 202 and the decoded image is supplied from the calculation section 210. The coefficient learning section 112 performs tap coefficient learning using the source image and the decoded image respectively as a teacher image and a student image, to obtain high performance coefficients (tap coefficients of high performance) and supplies them to the conversion coefficient learning section 113. Further, the coefficient learning section 112 generates filter controlling information including prediction related information and classification related information, that is, filter controlling information for a filter process as a classification prediction process to be performed using the high performance coefficients obtained by the tap coefficient learning.

It is to be noted that the coefficient learning section 112 can perform seed coefficient learning to obtain seed coefficients. In the seed coefficient learning, while parameter z included in the coefficient approximate expression wᵢ=Σβ_{m,i}z^{m-1} is necessary, as the parameter z, an image feature amount of the decoded image to be used in learning of seed coefficients or a value corresponding to acquirable information such as encoded information (quantization parameter QP and so forth) related to the decoded image can be adopted. Since the acquirable information can be acquired by the decoding apparatus 102, in the case where the coefficient learning section 112 obtains seed coefficients, when a value corresponding to the acquirable information is adopted as the parameter z, there is no necessity to transmit the parameter z from the encoding apparatus 101 to the decoding apparatus 102.

Further, as the parameter z, information other than the acquirable information, for example, a value obtained using information related to the source image such as, a difference in an S/N (Signal to Noise ratio) between the source image and the decoded image that are used in learning of seed coefficients can be adopted. However, since the information related to the source image cannot be acquired by the decoding apparatus 102, in the case where a value obtained using information related to the source image is adopted as the parameter z, it is necessary to transmit the parameter z separately from an encoded bit stream or together with an encoded bit stream by being included therein from the encoding apparatus 101 to the decoding apparatus 102.

The conversion coefficient learning section 113 performs conversion coefficient learning using the high performance coefficients from the coefficient learning section 112 and the ILF coefficients from the ILF 111 respectively as teacher data and student data, to calculate conversion coefficients for converting the ILF coefficients into high performance coefficients. The conversion coefficients and the filter controlling information are transmitted separately from an encoded bit stream or together with an encoded bit stream by being included therein to the decoding apparatus 102.

The A/D conversion section 201 performs A/D conversion of the source image in the form of an analog signal into a source image in the form of a digital signal and supplies the source image of the digital signal to the sort buffer 202 so as to be stored into the sort buffer 202.

The sort buffer 202 sorts frames of the source image from a displaying order to an encoding (decoding) order according to the GOPs (Group of Picture) and supplies the resulting original image to the ILF 111, the coefficient learning section 112, the calculation section 203, the intra prediction section 214, and the motion prediction compensation section 215.

The calculation section 203 subtracts the prediction image supplied from the intra prediction section 214 or the motion prediction compensation section 215 through the prediction image selection section 216 from the source image from the sort buffer 202 and supplies residuals (prediction residuals) obtained by the subtraction to the orthogonal transform section 204.

For example, in the case of an image for which inter encoding is to be performed, the calculation section 203 subtracts the prediction image supplied from the motion prediction compensation section 215 from the source image read out from the sort buffer 202.

The orthogonal transform section 204 performs orthogonal transform such as discrete cosine transform or Karhunen-Loeve transform for the residuals supplied from the calculation section 203. It is to be noted that any method may be used for the orthogonal transform. The orthogonal transform section 204 supplies orthogonal transform coefficients obtained by the orthogonal transform to the quantization section 205.

The quantization section 205 quantizes the orthogonal transform coefficients supplied from the orthogonal transform section 204. The quantization section 205 sets a quantization parameter QP on the basis of a target value for the code amount (code amount target value) or the like supplied from the rate controlling section 217 and performs quantization of the orthogonal transform coefficients. It is to be noted that any method may be used for the quantization. The quantization section 205 supplies encoded data that is quantized orthogonal transform coefficients to the reversible encoding section 206.

The reversible encoding section 206 encodes the quantized orthogonal transform coefficients as the encoded data from the quantization section 205 by a predetermined reversible encoding method. Since the orthogonal transform coefficients are in a quantized state under the control of the rate controlling section 217, the code amount of an encoded bit stream obtained by the reversible encoding by the reversible encoding section 206 becomes the code amount target value (or is approximated to the code amount target value) set by the rate controlling section 217.

Further, the reversible encoding section 206 acquires encoded information necessary for decoding by the decoding apparatus 102 within the encoded information related to the prediction encoding by the encoding apparatus 101 from the individual blocks.

Here, as the encoded information, for example, a prediction mode such as intra prediction or inter prediction, motion information such as a motion vector, a quantization parameter QP, a picture type (I, P, B), information regarding a CU (Coding Unit) or a CTU (Coding Tree Unit) and so forth are available.

For example, the prediction mode can be acquired from the intra prediction section 214 and the motion prediction compensation section 215. Further, for example, the motion information can be acquired from the motion prediction compensation section 215.

Furthermore, the reversible encoding section 206 acquires ILF coefficients used in the filter process of the ILF 111, as part of the encoded information, from the ILF 111.

The reversible encoding section 206 encodes the encoded information, for example, by variable length encoding such as CAVLC (Context-Adaptive Variable Length Coding) or CABAC (Context-Adaptive Binary Arithmetic Coding), arithmetic coding, or some other reversible encoding method, generates an encoded bit stream including the encoded information obtained after the encoding and the encoded data from the quantization section 205, and supplies the encoded bit stream to the accumulation buffer 207.

It is to be noted that the reversible encoding section 206 can encode filter controlling information generated by the coefficient learning section 112 and conversion coefficients obtained by the conversion coefficient learning section 113 by a reversible encoding method as occasion demands and place resulting encoded data into the encoded bit stream.

The accumulation buffer 207 temporarily accumulates the encoded bit stream supplied from the reversible encoding section 206. The encoded bit stream accumulated in the accumulation buffer 207 is read out and transmitted at a predetermined timing.

The encoded data that is orthogonal transform coefficients quantized by the quantization section 205 is supplied to the reversible encoding section 206 and also to the inverse quantization section 208. The inverse quantization section 208 inversely quantizes the quantized orthogonal transform coefficients by a method corresponding to that of the quantization by the quantization section 205 and supplies orthogonal transform coefficients obtained by the inverse quantization to the inverse orthogonal transform section 209.

The inverse orthogonal transform section 209 performs inverse orthogonal transform on the orthogonal transform coefficients supplied from the inverse quantization section 208, by a method corresponding to that of the orthogonal transform process by the orthogonal transform section 204, and supplies residuals obtained as a result of the inverse orthogonal transform to the calculation section 210.

The calculation section 210 adds a prediction image supplied from the intra prediction section 214 or the motion prediction compensation section 215 through the prediction image selection section 216 to the residuals supplied from the inverse orthogonal transform section 209, to obtain (a block of part of) a decoded image decoded from the source image, and supplies the decoded image to the ILF 111 and the coefficient learning section 112.

The frame memory 212 temporarily stores the ILF image supplied from the ILF 111. The ILF image stored in the frame memory 212 is supplied as a reference image to be used in generation of a prediction image to the selection section 213 at a necessary timing.

The selection section 213 selects a supply destination of the reference image supplied from the frame memory 212. For example, in the case where intra prediction is to be performed by the intra prediction section 214, the selection section 213 supplies the reference image supplied from the frame memory 212 to the intra prediction section 214. On the other hand, for example, in the case where inter prediction is to be performed by the motion prediction compensation section 215, the selection section 213 supplies the reference image supplied from the frame memory 212 to the motion prediction compensation section 215.

The intra prediction section 214 performs intra prediction (in-screen prediction) with use of the source image supplied from the sort buffer 202 and the reference image supplied from the frame memory 212 through the selection section 213, for example, using a PU (Prediction Unit) as a processing unit. The intra prediction section 214 selects an optimum intra prediction mode on the basis of a predetermined cost function (for example, the RD cost or the like) and supplies a prediction image generated by the optimum intra prediction mode to the prediction image selection section 216. Further, as described above, the intra prediction section 214 suitably supplies a prediction mode indicative of the intra prediction mode selected on the basis of the cost function to the reversible encoding section 206 and so forth.

The motion prediction compensation section 215 performs motion prediction (inter prediction) by use of the source image supplied from the sort buffer 202 and the reference image supplied from the frame memory 212 through the selection section 213, for example, using a PU as a processing unit. Further, the motion prediction compensation section 215 performs motion compensation according to a motion vector detected by the motion prediction, to generate a prediction image. The motion prediction compensation section 215 performs inter prediction by plural inter prediction modes prepared in advance, to generate prediction images.

The motion prediction compensation section 215 selects an optimum inter prediction mode on the basis of a predetermined cost function for a prediction image obtained for each of the plural inter prediction modes. Further, the motion prediction compensation section 215 supplies a prediction image generated by the optimum inter prediction mode to the prediction image selection section 216.

Further, the motion prediction compensation section 215 supplies a prediction mode indicative of the inter prediction mode selected on the basis of the cost function, motion information such as the motion vectors necessary when the encoded data encoded in the inter prediction mode is to be decoded, and so forth to the reversible encoding section 206.

The prediction image selection section 216 selects a supplying source (intra prediction section 214 or motion prediction compensation section 215) of a prediction image to be supplied to the calculation sections 203 and 210 and supplies the prediction image supplied from the selected supplying source to the calculation sections 203 and 210.

The rate controlling section 217 controls the rate of the quantization operation of the quantization section 205 on the basis of the code amount of the encoded bit stream accumulated in the accumulation buffer 207 such that overflow or underflow does not occur. In particular, the rate controlling section 217 sets a target code amount for the encoded bit amount such that overflow and underflow of the accumulation buffer 207 do not occur and supplies the target code amount to the quantization section 205.

It is to be noted that, in FIG. 16, the ILF 111 and the blocks ranging from the calculation section 203 to the rate controlling section 217 correspond to the encoding section 110 of FIG. 15.

Now, an encoding process performed by the encoding apparatus 101 of FIG. 16 is described.

First, the A/D conversion section 201 performs A/D conversion on a source image and supplies a resulting image to the sort buffer 202. The sort buffer 202 stores the source image from the A/D conversion section 201, sorts the source image into an encoding order, and outputs a resulting image. The intra prediction section 214 performs an intra prediction process of an intra prediction mode, and the motion prediction compensation section 215 performs an inter motion prediction process in which motion prediction and motion compensation in an inter prediction mode are performed. In the intra prediction process of the intra prediction section 214 and the inter motion prediction process of the motion prediction compensation section 215, a cost function of various prediction modes is calculated, and a prediction image is generated.

The prediction image selection section 216 determines an optimum prediction mode on the basis of cost functions individually obtained by the intra prediction section 214 and the motion prediction compensation section 215. Then, the prediction image selection section 216 selects a prediction image of the optimum prediction mode from between the prediction image generated by the intra prediction section 214 and the prediction image generated by the motion prediction compensation section 215 and outputs the selected prediction image.

The calculation section 203 calculates residuals between the source image outputted from the sort buffer 202 and the prediction image outputted from the prediction image selection section 216 and supplies the residuals to the orthogonal transform section 204. The orthogonal transform section 204 orthogonally transforms the residuals from the calculation section 203 and supplies orthogonal transform coefficients obtained as a result of the orthogonal transform to the quantization section 205. The quantization section 205 quantizes the orthogonal transform coefficients from the orthogonal transform section 204 and supplies quantization coefficients obtained as a result of the quantization to the reversible encoding section 206 and the inverse quantization section 208. The inverse quantization section 208 inversely quantizes the quantization coefficients from the quantization section 205 and supplies orthogonal transform coefficients obtained as a result of the inverse quantization to the inverse orthogonal transform section 209. The inverse orthogonal transform section 209 performs inverse orthogonal transform on the orthogonal transform coefficients from the inverse quantization section 208 and supplies residuals obtained as a result of the inverse orthogonal transform to the calculation section 210. The calculation section 210 adds the residuals from the inverse orthogonal transform section 209 and the prediction image outputted from the prediction image selection section 216, to generate a decoded image corresponding to the source image that is a target of the calculation of the residuals by the calculation section 203. The calculation section 210 supplies the decoded image to the ILF 111 and the coefficient learning section 112.

The ILF 111 calculates ILF coefficients by using the decoded image from the calculation section 210 and using the source image outputted from the sort buffer 202 and corresponding to the decoded image as occasion demands. Further, the ILF 111 performs a filter process for the decoded image from the calculation section 210 by using the ILF coefficients and supplies an ILF image obtained by the filter process to the frame memory 212. Furthermore, the ILF 111 supplies the ILF coefficients to the conversion coefficient learning section 113.

The coefficient learning section 112 performs tap coefficient learning by using the decoded image from the calculation section 210 and the source image outputted from the sort buffer 202 and corresponding to the decoded image, to obtain high performance coefficients, and outputs the high performance coefficients to the conversion coefficient learning section 113. Further, the coefficient learning section 112 generates filter controlling information for a filter process as a classification prediction process that is performed using the high performance coefficients obtained by the tap coefficient learning.

The conversion coefficient learning section 113 uses the high performance coefficients from the coefficient learning section 112 and the ILF coefficients from the ILF 111 respectively as teacher data and student data, to perform conversion coefficient learning and obtain conversion coefficients for converting the ILF coefficients into high performance coefficients. The conversion coefficients and the filter controlling information are transmitted separately from the encoded bit stream or are transmitted together with the encoded bit stream by being included therein by the reversible encoding section 206, to the decoding apparatus 102.

The frame memory 212 stores the ILF image supplied from the ILF 111. The ILF image stored in the frame memory 212 is used as a reference image on the basis of which a prediction image is to be generated.

The reversible encoding section 206 encodes the encoded data that is the quantization coefficients from the quantization section 205, to generate an encoded bit stream including the encoded data. Further, the reversible encoding section 206 encodes encoded information such as the ILF coefficients obtained by the ILF 111, the quantization parameters QP used in the quantization by the quantization section 205, the prediction mode obtained by the intra prediction process by the intra prediction section 214, the prediction mode and the motion information obtained by the inter motion prediction process by the motion prediction compensation section 215 and so forth as occasion demands and places the encoded information into the encoded bit stream. Then, the reversible encoding section 206 supplies the encoded bit stream to the accumulation buffer 207. The accumulation buffer 207 accumulates the encoded bit stream from the reversible encoding section 206. The encoded bit stream accumulated in the accumulation buffer 207 is read out and transmitted suitably.

The rate controlling section 217 controls the rate of the quantization operation of the quantization section 205 on the basis of the code amount (generated code amount) of the encoded bit stream accumulated in the accumulation buffer 207, such that overflow or underflow does not occur. Then, the encoding process ends.

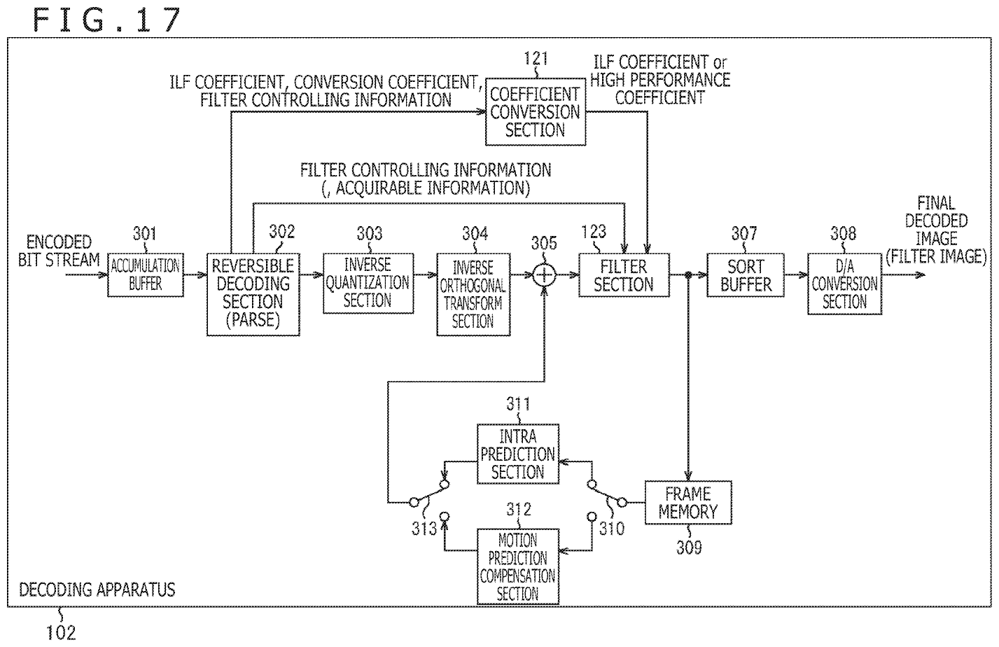

FIG. 17 is a block diagram depicting an example of a detailed configuration of the decoding apparatus 102 of FIG. 15.

Referring to FIG. 17, the decoding apparatus 102 includes a coefficient conversion section 121 and a filter section 123. The decoding apparatus 102 further includes an accumulation buffer 301, a reversible decoding section 302, an inverse quantization section 303, an inverse orthogonal transform section 304, a calculation section 305, a sort buffer 307, a D/A conversion section 308, a frame memory 309, a selection section 310, an intra prediction section 311, a motion prediction compensation section 312, and a selection section 313.

It is to be noted here that conversion coefficients and filter controlling information are placed into an encoded bit stream by the encoding apparatus 101.

To the coefficient conversion section 121, ILF coefficients, conversion coefficients, and filter controlling information are supplied from the reversible decoding section 302.

The coefficient conversion section 121 converts the ILF coefficients from the reversible decoding section 302 into (prediction values of) high performance coefficients by using the conversion coefficients from the reversible decoding section 302, according to the filter controlling information from the reversible decoding section 302. In particular, the coefficient conversion section 121 recognizes a tap number, a class number and so forth of the high performance coefficients from the filter controlling information and converts the ILF coefficients into high performance coefficients of the tap number, class number and so forth recognized from the filter controlling information, by using the conversion coefficients.

The coefficient conversion section 121 selects the ILF coefficients from the reversible decoding section 302 or the high performance coefficients converted from the ILF coefficients and supplies the selected coefficients to the filter section 123.

To the filter section 123, not only the ILF coefficients or the high performance coefficients are supplied from the coefficient conversion section 121, but also the filter controlling information and necessary acquirable information are supplied from the reversible decoding section 302, and further, the decoded image is supplied from the calculation section 305.

In the case where the ILF coefficients are supplied from the coefficient conversion section 121, the filter section 123 uses the ILF coefficients to perform a filter process same as that of the ILF 111, but in the case where the high performance coefficients are supplied from the coefficient conversion section 121, the filter section 123 uses the high performance coefficients to perform a filter process as a classification prediction process. The filter section 123 supplies a filter image obtained by the filter process to the sort buffer 307 and the frame memory 309. In the case where the filter section 123 performs a filter process as a classification prediction process by using the high performance coefficients, a filter image having picture quality of good appearance in comparison with that in the case where a filter process same as that of the ILF 111 is performed can be obtained by using the ILF coefficients.

Here, the filter section 123 recognizes a classification method, a prediction expression and so forth on the basis of the filter controlling information supplied from the reversible decoding section 302, to perform a classification prediction process.

It is to be noted that the encoding apparatus 101 can obtain seed coefficients and conversion coefficients for converting ILF coefficients into seed coefficients in place of the high performance coefficients and the conversion coefficients for converting ILF coefficients into high performance coefficients, respectively.

In this case, the coefficient conversion section 121 converts ILF coefficients into (prediction values of) seed coefficients by using conversion coefficients. Then, the filter section 123 obtains high performance coefficients by using a coefficient approximate expression including the seed coefficients and performs a filter process using the high performance coefficients.

In the case where a coefficient approximate expression including seed coefficients is used to obtain high performance coefficients, when a value obtained using information related to a source image is adopted as the parameter z configuring the coefficient approximate expression, the parameter z is included in an encoded bit stream. In this case, the reversible decoding section 302 parses the parameter z included in the encoded bit stream and supplies the parameter z to the filter section 123. Then, the filter section 123 obtains high performance coefficients by using the parameter z supplied from the reversible decoding section 302.

On the other hand, when a value corresponding to acquirable information is adopted as the parameter z configuring the coefficient approximate expression, the filter section 123 obtains high performance coefficients, by using a value corresponding to the acquirable information supplied from the reversible decoding section 302, as the parameter z.

Information regarding whether a value obtained using information related to a source image is adopted or a value corresponding to acquirable information is adopted as the parameter z configuring the coefficient approximate expression can be placed as a kind of prediction related information into the filter controlling information. In this case, the filter section 123 recognizes, on the basis of the filter controlling information, whether a value obtained using information related to a source image is adopted or a value corresponding to acquirable information is adopted as the parameter z configuring the coefficient approximate expression.

The accumulation buffer 301 temporarily accumulates an encoded bit stream transmitted from the encoding apparatus 101 and supplies the encoded bit stream to the reversible decoding section 302 at a predetermined timing.

The reversible decoding section 302 receives the encoded bit stream from the accumulation buffer 301 and decodes the encoded bit stream by a method corresponding to the encoding method of the reversible encoding section 206 of FIG. 16.

Then, the reversible decoding section 302 supplies quantization coefficients as encoded data included in a result of the decoding of the encoded bit stream to the inverse quantization section 303.

Further, the reversible decoding section 302 has a function of performing parsing. The reversible decoding section 302 parses acquirable information such as necessary encoding information, filter controlling information, conversion coefficients and so forth included in the result of the decoding of the encoded bit stream and supplies resulting information to necessary blocks.

For example, ILF coefficients and conversion coefficients within the acquirable information are supplied to the coefficient conversion section 121. The filter controlling information is supplied to the coefficient conversion section 121 and the filter section 123. The acquirable information is supplied to the filter section 123. The encoded information regarding a prediction mode, motion information and so forth in the acquirable information is supplied to the intra prediction section 311 and the motion prediction compensation section 312.

The inverse quantization section 303 inversely quantizes quantization coefficients as the encoded data from the reversible decoding section 302 by a method corresponding to the quantization method of the quantization section 205 of FIG. 16 and supplies orthogonal transform coefficients obtained by the inverse quantization to the inverse orthogonal transform section 304.

The inverse orthogonal transform section 304 performs inverse orthogonal transform on the orthogonal transform coefficients supplied from the inverse quantization section 303, by a method corresponding to the orthogonal transform method of the orthogonal transform section 204 of FIG. 16, and supplies residuals obtained as a result of the inverse orthogonal transform to the calculation section 305.

To the calculation section 305, not only the residuals are supplied from the inverse orthogonal transform section 304 but also a prediction image is supplied from the intra prediction section 311 or the motion prediction compensation section 312 through the selection section 313.

The calculation section 305 adds the residuals from the inverse orthogonal transform section 304 and the prediction image from the selection section 313 to generate a decoded image and supplies the decoded image to the filter section 123.

The sort buffer 307 temporarily stores the filter image supplied from the filter section 123, sorts frames (pictures) of the filter image from the encoding (decoding) order to the displaying order, and supplies a resulting filter image to the D/A conversion section 308.

The D/A conversion section 308 performs D/A conversion on the filter image supplied from the sort buffer 307 and outputs the resulting filter image to an unillustrated display so as to be displayed on the display.

The frame memory 309 temporarily stores the filter image supplied from the filter section 123. Further, the frame memory 309 supplies the filter image as a reference image to be used for generation of a prediction image to the selection section 310 at a predetermined timing or on the basis of a request from the outside such as the intra prediction section 311 or the motion prediction compensation section 312.

The selection section 310 selects a supplying destination of the reference image supplied from the frame memory 309. In the case where an intra-encoded image is to be decoded, the selection section 310 supplies the reference image supplied from the frame memory 309, to the intra prediction section 311. On the other hand, in the case where an inter-encoded image is to be decoded, the selection section 310 supplies the reference image supplied from the frame memory 309 to the motion prediction compensation section 312.

The intra prediction section 311 performs intra prediction using the reference image supplied from the frame memory 309 through the selection section 310, in an intra prediction mode used in the intra prediction section 214 of FIG. 16, according to a prediction mode included in the encoded information supplied from the reversible decoding section 302. Then, the intra prediction section 311 supplies a prediction image obtained by the intra prediction to the selection section 313.

The motion prediction compensation section 312 performs inter prediction using the reference image supplied from the frame memory 309 through the selection section 310, in an inter prediction mode used in the motion prediction compensation section 215 of FIG. 16, according to a prediction mode included in the encoded information supplied from the reversible decoding section 302. The inter prediction is performed using motion information included in the encoded information supplied from the reversible decoding section 302 or like information as occasion demands.

The motion prediction compensation section 312 supplies a prediction image obtained by the inter prediction to the selection section 313.

The selection section 313 selects the prediction image supplied from the intra prediction section 311 or the prediction image supplied from the motion prediction compensation section 312 and supplies the selected prediction image to the calculation section 305.

It is to be noted that, in FIG. 17, the reversible decoding section 302 is equivalent to the parse section 120 of FIG. 15 and the filter section 123 and the blocks ranging from the inverse quantization section 303 to the selection section 313 are equivalent to the decoding section 122 of FIG. 15.

Now, a decoding process performed by the decoding apparatus 102 of FIG. 17 is described.

First, the accumulation buffer 301 temporarily accumulates an encoded bit stream transmitted from the encoding apparatus 101 and suitably supplies the encoded bit stream to the reversible decoding section 302. The reversible decoding section 302 receives and decodes the encoded bit stream supplied from the accumulation buffer 301 and supplies quantization coefficients as encoded data included in a result of the decoding of the encoded bit stream to the inverse quantization section 303. Further, the reversible decoding section 302 parses acquirable information, conversion coefficients, and filter controlling information included in the result of the decoding of the encoded bit stream. Then, the reversible decoding section 302 supplies necessary acquirable information to the intra prediction section 311, the motion prediction compensation section 312, and other necessary blocks. Further, the reversible decoding section 302 supplies ILF coefficients, conversion coefficients, and filter controlling information within the acquirable information to the coefficient conversion section 121. Furthermore, the reversible decoding section 302 supplies the filter controlling information and the acquirable information to the filter section 123. The coefficient conversion section 121 converts the ILF coefficients supplied from the reversible decoding section 302 into high performance coefficients by using the conversion coefficients similarly supplied from the reversible decoding section 302 and supplies the high performance coefficients or the ILF coefficients from the reversible decoding section 302 to the filter section 123.

The inverse quantization section 303 inversely quantizes the quantization coefficients from the reversible decoding section 302 and supplies orthogonal transform coefficients obtained as a result of the inverse quantization to the inverse orthogonal transform section 304. The inverse orthogonal transform section 304 performs inverse orthogonal transform on the orthogonal transform coefficients from the inverse quantization section 303 and supplies residuals obtained as a result of the inverse orthogonal transform to the calculation section 305.

The intra prediction section 311 or the motion prediction compensation section 312 performs an intra prediction process or an inter motion prediction process for generating a prediction image, by using the reference image supplied from the frame memory 309 through the selection section 310 and the acquirable information supplied form the reversible decoding section 302. Then, the intra prediction section 311 or the motion prediction compensation section 312 supplies a prediction image obtained by the intra prediction process or the inter motion prediction process to the selection section 313. The selection section 313 selects the prediction image supplied from the intra prediction section 311 or the motion prediction compensation section 312 and supplies the selected prediction image to the calculation section 305. The calculation section 305 adds the residuals from the inverse orthogonal transform section 304 and the prediction image from the selection section 313 to generate a decoded image. Then, the calculation section 305 supplies the decoded image to the filter section 123.

The filter section 123 recognizes a method, a prediction expression and so forth of classification on the basis of the filter controlling information supplied from the reversible decoding section 302 and performs a classification prediction process using the high performance coefficients from the coefficient conversion section 121 or performs a filter process same as that by the ILF 111 by using the ILF coefficients from the coefficient conversion section 121. A filter image obtained by the filter process of the filter section 123 is supplied to the sort buffer 307 and the frame memory 309.

The sort buffer 307 temporarily stores the filter image supplied from the filter section 123, sorts the filter image into a displaying order, and supplies the filter image to the D/A conversion section 308. The D/A conversion section 308 performs D/A conversion on the filter image from the sort buffer 307. The filter image subjected to the D/A conversion is outputted to and displayed on an unillustrated display.

Further, the frame memory 309 stores the filter image supplied from the filter section 123, and then, the decoding process ends. The decoded image stored in the frame memory 309 is used as a reference image on the basis of which a prediction image is to be generated by an intra prediction process or an inter motion prediction process.

It is to be noted that, in the case where conversion coefficients are transmitted from the encoding apparatus 101 to the decoding apparatus 102, the coefficient conversion section 121 converts the ILF coefficients into high performance coefficients (or seed coefficients) by using the conversion coefficients, and the filter section 123 can perform a classification prediction process using the high performance coefficients.

On the other hand, in the case where conversion coefficients are not transmitted from the encoding apparatus 101 to the decoding apparatus 102, the filter section 123 can perform a filter process same as that by the ILF 111 by using the ILF coefficients.

Here, also in an image processing system described below, seed coefficients can be used in place of high performance coefficients similarly as in the image processing system 100 described hereinabove with reference to FIGS. 15 to 17. However, in the image processing system described below, description of a case in which seed coefficients are used in place of high performance coefficients is suitably omitted.

<Second Example of Configuration of Image Processing System to which Classification Prediction Filter 30 is Applied>

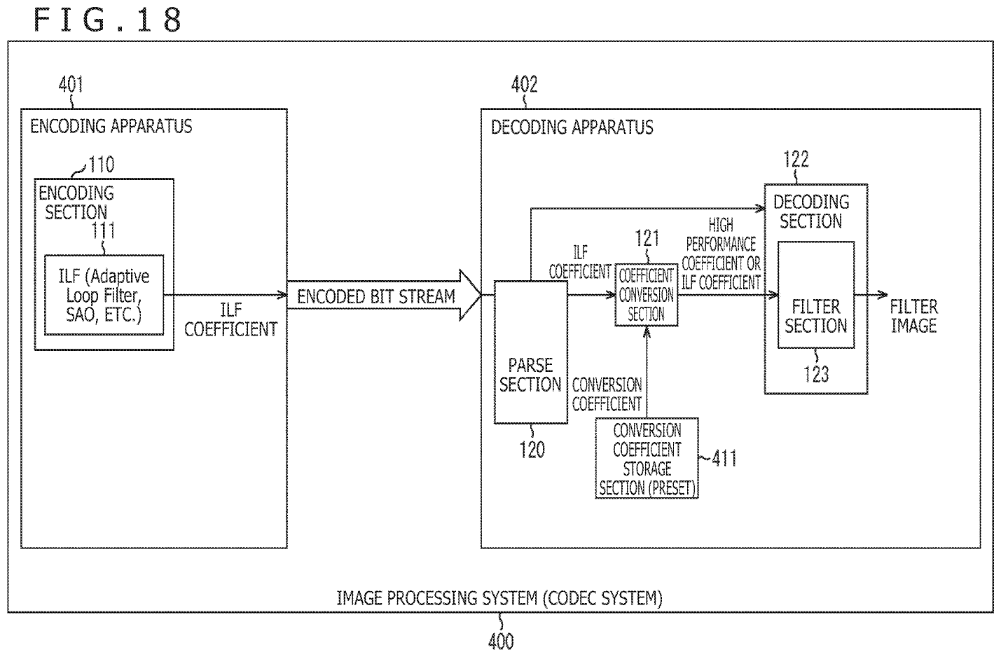

FIG. 18 is a block diagram depicting a second example of a configuration of an image processing system to which the classification prediction filter 30 is applied.

It is to be noted that, in FIG. 18, portions corresponding to those in the image processing system 100 of FIG. 15 are denoted by identical reference signs, and in the following description, description of them is omitted suitably.

Referring to FIG. 18, an image processing system 400 is a codec system that encodes and decodes an image and includes an encoding apparatus 401 and a decoding apparatus 402.

The encoding apparatus 401 includes an encoding section 110. Accordingly, the encoding apparatus 401 is similar to the encoding apparatus 101 of FIG. 15 in that it includes the encoding section 110 and is different from the encoding apparatus 101 in that it does not include any of the coefficient learning section 112 and the conversion coefficient learning section 113.

The decoding apparatus 402 includes a parse section 120, a coefficient conversion section 121, a decoding section 122, and a conversion coefficient storage section 411. Accordingly, the decoding apparatus 402 is similar to the decoding apparatus 102 of FIG. 15 in that it includes the blocks ranging from the parse section 120 to the decoding section 122 and is different from the decoding apparatus 102 in that it newly includes the conversion coefficient storage section 411.

In the conversion coefficient storage section 411, conversion coefficients for converting ILF coefficients into high performance coefficients included in a prediction expression for predicting an image equivalent to a source image (hereinafter referred to as an equivalent source image) from an image equivalent to a decoded image (hereinafter referred to as an equivalent decoded image) obtained by locally decoding encoded data obtained by prediction encoding of the source image by the encoding apparatus 401 are stored in advance (preset).

Here, conversion coefficients for converting ILF coefficients into high performance coefficients included in a prediction expression for predicting an equivalent source image from an equivalent decoded image are, in a strict sense, obtained by performing conversion coefficient learning using ILF coefficients obtained using an equivalent decoded image and an equivalent source image and tap coefficients obtained by performing tap coefficient learning using the equivalent decoded image and the equivalent source image as a learning pair respectively as student data and teacher data. However, in the following description, such conversion coefficients are also represented as conversion coefficients that are obtained by conversion coefficient learning using an equivalent source image and an equivalent decoded image as a learning pair and that convert ILF coefficients into high performance coefficients.

Further, conversion coefficients stored in the conversion coefficient storage section 411 in advance are also referred to as preset conversion coefficients. The preset conversion coefficients stored in the conversion coefficient storage section 411 are supplied to the coefficient conversion section 121.

Accordingly, in FIG. 18, the coefficient conversion section 121 converts ILF coefficients into high performance coefficients by using the preset conversion coefficients.

In particular, although the decoding apparatus 102 of FIG. 15 converts ILF coefficients into high performance coefficients by using conversion coefficients that are obtained by performing conversion coefficient learning using a source image itself and a decoded image itself as a learning pair and are used to convert ILF coefficients into high performance coefficients, the decoding apparatus 402 of FIG. 18 converts ILF coefficients into high performance coefficients by using preset conversion coefficients that are obtained by performing conversion coefficient learning using an equivalent source image and an equivalent decoded image as a learning pair in place of a source image itself and a decoded image itself and are used to convert ILF coefficients into high performance coefficients.

In the decoding apparatus 402 of FIG. 18, in the case where high performance coefficients are supplied from the coefficient conversion section 121 to the decoding section 122, a filter process as a classification prediction process is performed using the high performance coefficients similarly as in the decoding apparatus 102 of FIG. 15, and therefore, a final decoded image having picture quality of good appearance can be obtained.

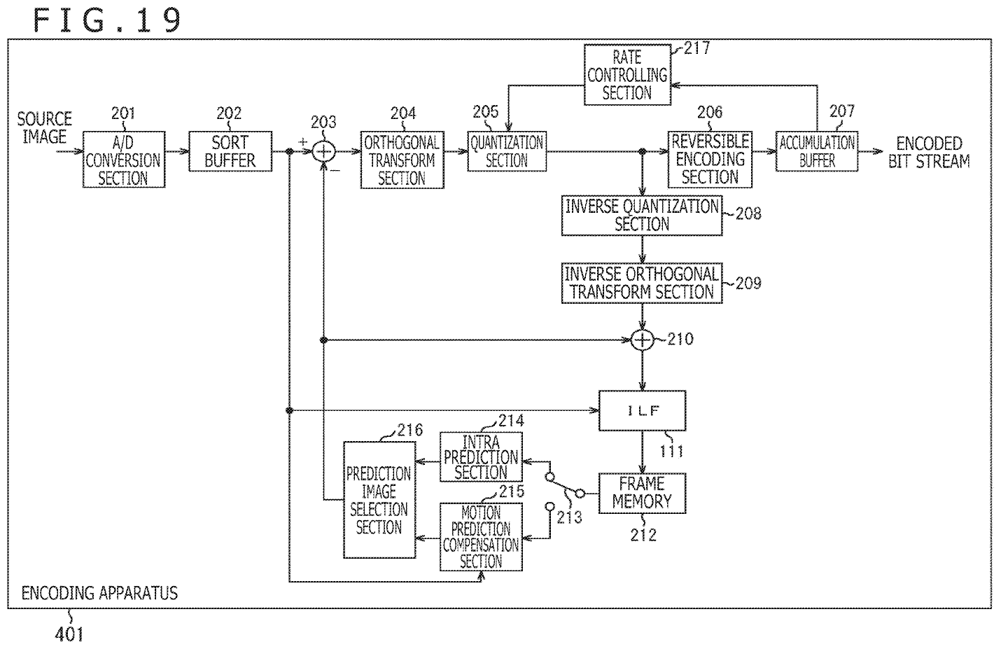

FIG. 19 is a block diagram depicting an example of a detailed configuration of the encoding apparatus 401 of FIG. 18.

It is to be noted that, in FIG. 19, portions corresponding to those in the encoding apparatus 101 of FIG. 16 are denoted by identical reference signs, and in the following description, description of them is omitted suitably.

Referring to FIG. 19, the encoding apparatus 401 includes an ILF 111, blocks ranging from an A/D conversion section 201 to a calculation section 210, and blocks ranging from a frame memory 212 to a rate controlling section 217.

Accordingly, the encoding apparatus 401 is similar to the encoding apparatus 101 in that it includes the ILF 111, blocks ranging from the A/D conversion section 201 to the calculation section 210, and blocks ranging from the frame memory 212 to the rate controlling section 217. However, the encoding apparatus 401 is different from the encoding apparatus 101 in that it does not include any of the coefficient learning section 112 and the conversion coefficient learning section 113.

Since the encoding apparatus 401 does not include any of the coefficient learning section 112 and the conversion coefficient learning section 113, it cannot calculate a conversion coefficient.

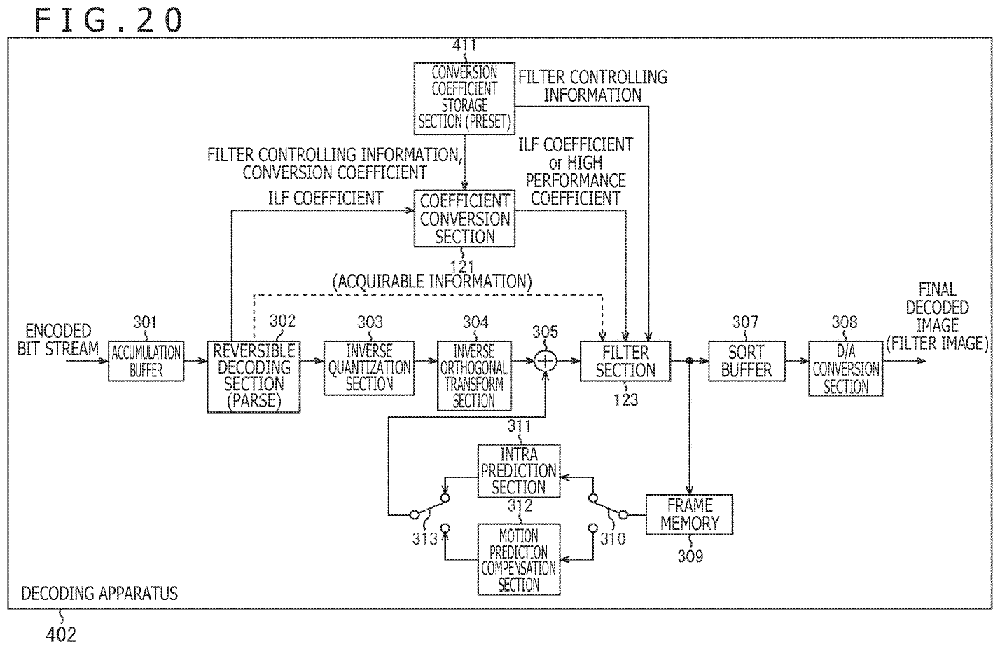

FIG. 20 is a block diagram depicting an example of a detailed configuration of the decoding apparatus 402 of FIG. 18.

It is to be noted that, in FIG. 20, portions corresponding to those in the decoding apparatus 102 of FIG. 17 are denoted by identical reference signs, and in the following description, description of them is omitted suitably.

Referring to FIG. 20, the decoding apparatus 402 includes a coefficient conversion section 121, a filter section 123, blocks ranging from an accumulation buffer 301 to a calculation section 305, blocks ranging from a sort buffer 307 to a selection section 313, and a conversion coefficient storage section 411.

Accordingly, the decoding apparatus 402 is similar to the decoding apparatus 102 in that it includes the coefficient conversion section 121, the filter section 123, blocks ranging from the accumulation buffer 301 to the calculation section 305, and blocks ranging from the sort buffer 307 to the selection section 313. However, the decoding apparatus 402 is different from the decoding apparatus 102 in that it newly includes the conversion coefficient storage section 411.

The conversion coefficient storage section 411 has stored therein conversion coefficients for converting ILF coefficients into high performance coefficients. Further, the conversion coefficient storage section 411 has stored therein filter controlling information for controlling a filter process as a classification prediction process using high performance coefficients obtained by coefficient conversion using the conversion coefficients.

Referring to FIG. 20, the coefficient conversion section 121 recognizes a tap number, a class number and so forth of high performance coefficients from the filter controlling information stored in the conversion coefficient storage section 411 and converts ILF coefficients from the reversible decoding section 302 into (prediction values of) high performance coefficients by using the conversion coefficients stored in the conversion coefficient storage section 411.

The coefficient conversion section 121 selects the ILF coefficients from the reversible decoding section 302 or the high performance coefficients converted from the ILF coefficients to the filter section 123.

The filter section 123 either performs a filter process same as that by the ILF 111 by using the ILF coefficients from the coefficient conversion section 121 or performs a filter process as a classification prediction process by using the high performance coefficients from the coefficient conversion section 121, similarly as in the case of FIG. 17.

In the case where, also in the decoding apparatus 402, the filter section 123 performs a filter process as a classification prediction process by using the high performance coefficients similarly as in the case of the decoding apparatus 102 of FIG. 17, a filter image of picture quality of good appearance in comparison with that in the case where a filter process same as that by the ILF 111 is performed, by using the ILF coefficients can be obtained.

<Third Example of Configuration of Image Processing System to which Classification Prediction Filter 30 is Applied.

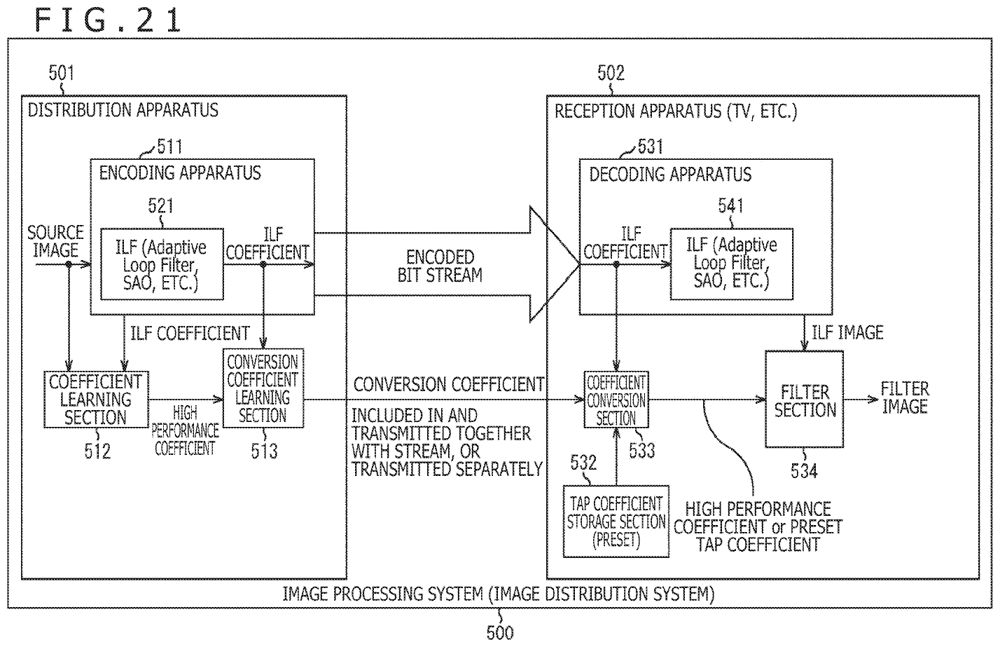

FIG. 21 is a block diagram depicting a third example of a configuration of an image processing system to which the classification prediction filter 30 is applied.

Referring to FIG. 21, an image processing system 500 is an image distribution system which may be applied to a streaming service of distributing images, and includes a distribution apparatus 501 and a reception apparatus 502.

The distribution apparatus 501 includes an encoding apparatus 511, a coefficient learning section 512, and a conversion coefficient learning section 513.

The encoding apparatus 511 includes an ILF 521 and performs prediction encoding on a source image that is an encoding target. In the prediction encoding, local decoding is performed, and in the local decoding, a decoded image is filter-processed by the ILF 521 and a prediction image of the source image is generated using an ILF image, which is an image obtained after the filter process, as a reference image.

The encoding apparatus 511 generates an encoded bit stream including encoded data obtained by the prediction encoding of the source image and ILF coefficients (for example, ALF filter coefficients or the like) that are filter coefficients of the ILF 521 and transmits (sends) the encoded bit stream to the reception apparatus 502.

Here, the encoding apparatus 511 is configured similarly to the encoding apparatus 401 of FIG. 19, and therefore, illustration of an example of a detailed description of it is omitted. Accordingly, the ILF 521 the encoding apparatus 511 includes is an existing ILF similar to that in the case of FIG. 19.

The coefficient learning section 512 performs tap coefficient learning using the source image and an ILF image obtained by a filter process of the ILF 521 as a teacher image and a student image, respectively, to calculate high performance coefficients that are tap coefficients of high performance, and supplies the high performance coefficients to the conversion coefficient learning section 513. Here, the high performance coefficients calculated by the coefficient learning section 512 are tap coefficients configuring a prediction expression for predicting the source image from the ILF image.

To the conversion coefficient learning section 513, not only the high performance coefficients are supplied from the coefficient learning section 512 but also the ILF coefficients are supplied from the encoding apparatus 511. The conversion coefficient learning section 513 performs conversion coefficient learning using the high performance coefficients from the coefficient learning section 512 and the ILF coefficients from the ILF 521 as teacher data and student data, respectively, to calculate conversion coefficients for converting the ILF coefficients into the high performance coefficients.

The conversion coefficients are either transmitted separately from an encoded bit stream or are placed into and transmitted together with an encoded bit stream to the reception apparatus 502.

The reception apparatus 502 is, for example, a TV (television receiver) and includes a decoding apparatus 531, a tap coefficient storage section 532, a coefficient conversion section 533, and a filter section 534. Here, the decoding apparatus 531 can be provided as an apparatus separate from the reception apparatus 502 on the outside of the reception apparatus 502.

The decoding apparatus 531 includes an ILF 541 configured similarly to the ILF 521. The decoding apparatus 531 decodes encoded data included in an encoded bit stream transmitted from the distribution apparatus 501, to generate a decoded image. Further, in the decoding apparatus 531, the ILF 541 performs a filter process for the decoded image by using ILF coefficients included in the encoded bit stream and outputs an ILF image obtained by the filter process as a final decoded image.

Here, in FIG. 21, since the ILF image is a final decoded image outputted from the decoding apparatus 531, the image equivalent to the ILF image is also referred to as an equivalent decoded image similarly to an image equivalent to a decoded image.

The tap coefficient storage section 532 has stored in advance therein tap coefficients obtained by performing tap coefficient learning using an equivalent decoded image and an equivalent source image as a learning pair. The tap coefficients stored in advance in the tap coefficient storage section 532 are also referred to as preset tap coefficients.

Here, although the high performance coefficients are obtained by tap coefficient learning using an ILF image (final decoded image) itself and a source image as a learning pair, the preset tap coefficients stored in the tap coefficient storage section 532 are obtained by tap coefficient learning using an equivalent decoded image and an equivalent source image as a learning pair.

Accordingly, by the filter process as a classification prediction process targeting a final decoded image obtained by encoding and decoding a source image, a filter image of higher picture quality is obtained where high performance coefficients are used than where preset tap coefficients are used. From this, it can be said that the high performance coefficients are tap coefficients of higher performance that indicate a higher degree of improvement of the picture quality than the preset tap coefficients.

The coefficient conversion section 533 receives conversion coefficients included in and transmitted together with an encoded bit stream or transmitted separately from an encoded bit stream from the distribution apparatus 501, to acquire the conversion coefficients. Further, to the coefficient conversion section 533, ILF coefficients included in the encoded bit stream are supplied from the decoding apparatus 531.

The coefficient conversion section 533 is equivalent to the coefficient conversion section 51 of the classification prediction filter 30 (FIG. 13). The coefficient conversion section 533 converts ILF coefficients from the decoding apparatus 531 into (prediction values of) high performance coefficients that indicate a higher degree of improvement of picture quality than the ILF coefficients, by using a coefficient conversion expression including conversion coefficients from the distribution apparatus 501. Then, the coefficient conversion section 533 selects the preset tap coefficients stored in the tap coefficient storage section 532 or the high performance coefficients, according to an operation of a user, an instruction from the outside or the like, and supplies the result of the selection to the filter section 534.

The filter section 534 is equivalent to the filter section 32 of the classification prediction filter 30 (FIG. 13) and functions as a post filter in a succeeding stage of the decoding apparatus 531. The filter section 534 performs a filter process as a classification prediction process for an ILF image outputted as a final decoded image from the decoding apparatus 531, by using the preset tap coefficients or the high performance coefficients from the coefficient conversion section 533, to generate a filter image and outputs the filter image.

In particular, in the case where the preset tap coefficients are supplied from the coefficient conversion section 533, the filter section 534 uses the preset tap coefficients to perform a classification prediction process, but in the case where the high performance coefficients are supplied from the coefficient conversion section 533, the filter section 534 uses the high performance coefficients to perform a classification prediction process.

As described above, the high performance coefficients are tap coefficient of performance higher than that of the preset tap coefficients, and in the case where the high performance coefficients are supplied to the filter section 534 from the coefficient conversion section 533, the high performance coefficients are used to perform a filter process as a classification prediction process. In other words, the filter section 534 performs, as a post filter, a filter process that indicates a higher degree of improvement of the picture quality. Therefore, a filter image having good picture quality can be obtained in comparison with an alternative case in which the preset tap coefficients are used to perform a classification prediction process.

Accordingly, if the user of the reception apparatus 502 selects whether the preset tap coefficients are to be used or the high performance coefficients are to be used for the filter process to be performed by the filter section 534, depending upon the details of the contract for the user of the reception apparatus 502 to receive distribution of an image from the distribution apparatus 501, then, this gives rise to a difference in picture quality of the filter image. In other words, a difference may be provided in picture quality of the filter image, for example, depending upon the price.

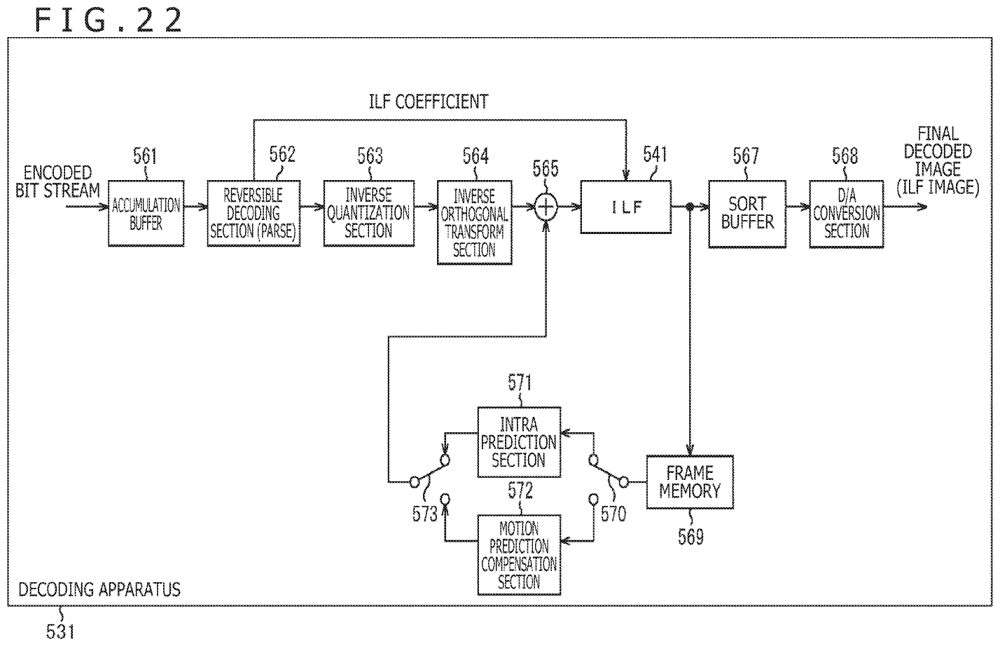

FIG. 22 is a block diagram depicting an example of a configuration of the decoding apparatus 531 of FIG. 21.

The decoding apparatus 531 includes an ILF 541, an accumulation buffer 561, a reversible decoding section 562, an inverse quantization section 563, an inverse orthogonal transform section 564, a calculation section 565, a sort buffer 567, a D/A conversion section 568, a frame memory 569, a selection section 570, an intra prediction section 571, a motion prediction compensation section 572, and a selection section 573.

The blocks ranging from the accumulation buffer 561 to the calculation section 565 and the blocks ranging from the sort buffer 567 to the selection section 573 are configured similarly to the blocks ranging from the accumulation buffer 301 to the calculation section 305 and the blocks ranging from the sort buffer 307 to the selection section 313 of FIG. 17, respectively.

To the ILF 541, ILF coefficients are supplied from the reversible decoding section 562 and a decoded image is supplied from the calculation section 565. The ILF 541 performs a filter process using the ILF coefficients from the reversible decoding section 562 for the decoded image from the calculation section 565. An ILF image obtained by the filter process of the ILF 541 is supplied to the filter section 534 of FIG. 21.

<Fourth Example of Configuration of Image Processing System to which Classification Prediction Filter 30 is Applied>

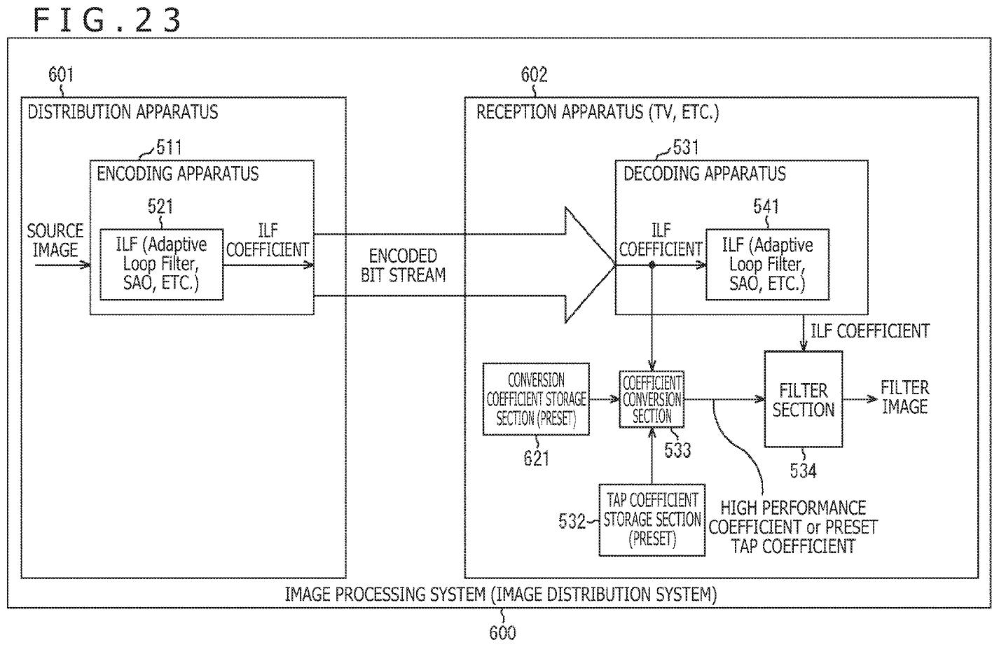

FIG. 23 is a block diagram depicting a fourth example of a configuration of an image processing system to which the classification prediction filter 30 is applied.

It is to be noted that, in FIG. 23, portions corresponding to those in the case of the image processing system 500 of FIG. 21 are denoted by identical reference signs, and in the following description, description of them is omitted suitably.

Referring to FIG. 23, an image processing system 600 is an image distribution system that can be applied to a streaming service for distributing images and includes a distribution apparatus 601 and a reception apparatus 602.

The distribution apparatus 601 includes an encoding apparatus 511.

Accordingly, the image processing system 600 is similar to the distribution apparatus 501 of FIG. 21 in that it includes the encoding apparatus 511. However, the distribution apparatus 601 is different from the distribution apparatus 501 in that it does not include any of the coefficient learning section 512 and the conversion coefficient learning section 513.

In the distribution apparatus 601, an encoded bit stream is transmitted to the reception apparatus 602 similarly as in the distribution apparatus 501.

The reception apparatus 602 is, for example, a TV and incudes a decoding apparatus 531, a tap coefficient storage section 532, a coefficient conversion section 533, a filter section 534, and a conversion coefficient storage section 621. Here, the decoding apparatus 531 can be provided as an apparatus separate from the reception apparatus 602 on the outside of the reception apparatus 602.

The reception apparatus 602 is similar to the reception apparatus 502 of FIG. 21 in that it includes the blocks ranging from the decoding apparatus 531 to the filter section 534. However, the reception apparatus 602 is different from the reception apparatus 502 in that the conversion coefficient storage section 621 is newly provided.

The conversion coefficient storage section 621 has stored in advance therein preset conversion coefficients for converting ILF coefficients into high performance coefficients included in a prediction expression for predicting an equivalent source image (image equivalent to the source image) from an equivalent decoded image (image equivalent to an ILF image as a final decoded image) similarly as in the conversion coefficient storage section 411 of FIG. 18.

The preset conversion coefficients stored in the conversion coefficient storage section 621 are supplied to the coefficient conversion section 533.

Accordingly, the coefficient conversion section 533 uses the preset conversion coefficients stored in the conversion coefficient storage section 621 to convert the ILF coefficients supplied from the decoding apparatus 531 into high performance coefficients.

In particular, although the reception apparatus 502 of FIG. 21 converts ILF coefficients into high performance coefficients by using conversion coefficients that are obtained by performing conversion coefficient learning using a source image itself and a final decoded image (ILF image) itself as a learning pair and are used to convert ILF coefficients into high performance coefficients, the reception apparatus 602 of FIG. 23 converts ILS coefficients into high performance coefficients by using preset conversion coefficients that are obtained by performing conversion coefficient learning using an equivalent source image and an equivalent decoded image as a learning pair in place of a source image itself and a final decoded image itself and are used to convert ILF coefficients into high performance coefficients.

Then, the coefficient conversion section 533 selects the high performance coefficients obtained by converting ILF coefficients with use of the preset conversion coefficients or the preset tap coefficients stored in the tap coefficient storage section 532 and outputs the selected coefficients to the filter section 534.

Here, the coefficient conversion section 533 can adopt tap coefficients of different levels of performance as the high performance coefficients obtained by converting ILF coefficients with use of the preset conversion coefficients and the preset tap coefficients stored in the tap coefficient storage section 532.

In particular, the coefficient conversion section 533 can adopt, for example, prediction expressions different from each other as the prediction expression including high performance coefficients and the prediction expression including preset tap coefficients. For example, it is possible to adopt a first-order prediction expression as one of the prediction expression including high performance coefficients or the prediction expression including preset tap coefficients and adopt (a higher-order prediction expression such as) a second-order prediction expression as the other prediction expression.

If a first-order prediction expression is adopted, then, especially, a flat portion of an image (portion that indicates little variation in pixel value) can be restored with high accuracy, but if a second-order prediction expression is adopted, then, especially, details of an image can be restored with high accuracy.

It is to be noted that the preset tap coefficients to be stored in the tap coefficient storage section 532 are not limited to tap coefficients obtained by performing tap coefficient learning using an equivalent decoded image and an equivalent source image as a learning pair. In particular, as the preset tap coefficients, for example, tap coefficients obtained by performing tap coefficient learning using an image having a good S/N and using an image having a decreased S/N as a learning pair or like tap coefficients can be adopted.

<Fifth Example of Configuration of Image Processing System to which Classification Prediction Filter 30 is Applied>

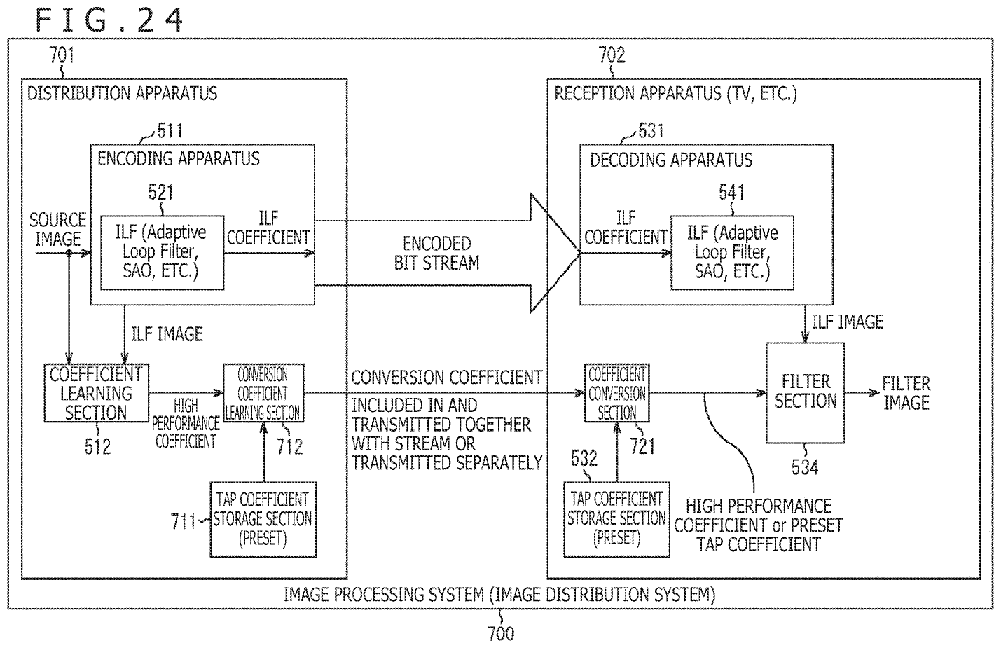

FIG. 24 is a block diagram depicting a fifth example of a configuration of an image processing system to which the classification prediction filter 30 is applied.

It is to be noted that, in FIG. 24, portions corresponding to those in the case of the image processing system 500 of FIG. 21 are denoted by identical reference signs, and in the following description, description of them is omitted suitably.

Referring to FIG. 24, an image processing system 700 is an image distribution system that can be applied to a streaming service for distributing images and includes a distribution apparatus 701 and a reception apparatus 702.

The distribution apparatus 701 includes an encoding apparatus 511, a coefficient learning section 512, a tap coefficient storage section 711, and a conversion coefficient learning section 712.

Accordingly, the distribution apparatus 701 is similar to the distribution apparatus 501 of FIG. 21 in that it includes the encoding apparatus 511 and the coefficient learning section 512. However, the distribution apparatus 701 is different from the distribution apparatus 501 in that the tap coefficient storage section 711 is provided newly and the conversion coefficient learning section 712 is provided in place of the conversion coefficient learning section 513.

Similarly to the distribution apparatus 501, the distribution apparatus 701 transmits an encoded bit stream to the reception apparatus 702.

Further, in the distribution apparatus 701, similarly as in the distribution apparatus 501, the coefficient learning section 512 obtains high performance coefficients by performing tap coefficient learning using a source image and an ILF image as a final decoded image obtained by a filter process of the ILF 521 in the encoding apparatus 511 as a teacher image and a student image, respectively, and supplies the high performance coefficients to the conversion coefficient learning section 712.

As described above with reference to FIG. 21, the high performance coefficients obtained by the coefficient learning section 512 are tap coefficients (second tap coefficients) included in a prediction expression for predicting the source image from the ILF image.

The tap coefficient storage section 711 has stored in advance therein tap coefficients same as preset tap coefficients stored in the tap coefficient storage section 532 the reception apparatus 702 hereinafter described includes, that is, for example, tap coefficients (first tap coefficients) obtained by performing tap coefficient learning using an equivalent decoded image and an equivalent source image, as a learning pair. The tap coefficients stored in advance in the tap coefficient storage section 711 are also referred to as preset tap coefficients.

The conversion coefficient learning section 712 performs conversion coefficient learning using the high performance coefficients from the coefficient learning section 512 and the preset tap coefficients stored in the tap coefficient storage section 711 as teacher data and student data, respectively, to obtain conversion coefficients for converting the preset tap coefficients into high performance coefficients.

The conversion coefficients are transmitted separately from an encoded bit stream or placed into and transmitted together with an encoded bit stream to the reception apparatus 702.

The reception apparatus 702 is, for example, a TV and includes a decoding apparatus 531, a tap coefficient storage section 532, a filter section 534, and a coefficient conversion section 721. Here, the decoding apparatus 531 can be provided as an apparatus separate from the reception apparatus 702 on the outside of the reception apparatus 702.

The reception apparatus 702 is similar to the reception apparatus 502 of FIG. 21 in that it includes the decoding apparatus 531, the tap coefficient storage section 532, and the filter section 534. However, the reception apparatus 702 is different from the reception apparatus 502 in that the coefficient conversion section 721 is provided in place of the coefficient conversion section 533.

The coefficient conversion section 721 receives conversion coefficients transmitted by being placed in an encoded bit stream or transmitted separately from an encoded bit stream from the distribution apparatus 701, to acquire the conversion coefficients.

The coefficient conversion section 721 is equivalent to the coefficient conversion section 51 of the classification prediction filter 30 (FIG. 13). The coefficient conversion section 721 converts the preset tap coefficients stored in the tap coefficient storage section 532 into (prediction values of) high performance coefficients obtained by the coefficient learning section 512, by using a coefficient conversion expression including the conversion coefficients from the distribution apparatus 701. Then, the coefficient conversion section 721 selects the preset tap coefficients stored in the tap coefficient storage section 532 or the high performance coefficients, according to an operation of the user or an instruction or the like from the outside, and supplies the selected coefficients to the filter section 534.

Here, while the high performance coefficients are obtained by tap coefficient learning using an ILF image (final decoded image) itself and a source image as a learning pair, the preset type coefficients stored in the tap coefficient storage sections 532 and 711 are obtained by tap coefficient learning using an equivalent decoded image and an equivalent source image as a learning pair.

Accordingly, by the filter process as a classification prediction process targeting a final decoded image obtained by encoding and decoding a source image, a filter image of higher picture quality is obtained where high performance coefficients are used than where preset tap coefficients are used. From this, it can be said that the high performance coefficients are tap coefficients of higher performance that indicate a higher degree of improvement of the picture quality than the preset tap coefficients.

The filter section 534 performs a filter process as a classification prediction process for an ILF image outputted as a final decoded image from the decoding apparatus 531, by using preset tap coefficients or high performance coefficients from the coefficient conversion section 721, to generate a filter image and outputs the filter image.

In particular, in the case where preset type coefficients are supplied from the coefficient conversion section 721, the filter section 534 uses the preset tap coefficients to perform a classification prediction process, but in the case where high performance coefficients are supplied from the coefficient conversion section 721, the filter section 534 uses the high performance coefficients to perform a classification prediction process.

As described hereinabove, the high performance coefficients are tap coefficients of higher performance than the preset tap coefficients, and in the case where the high performance coefficients are supplied from the coefficient conversion section 721 to the filter section 534, a filter process as a classification prediction process is performed using the high performance coefficients, i.e., the filter section 534 performs, as a post filter, a filter process having a high degree of improvement in picture quality. Therefore, a filter image having good picture quality can be obtained in comparison with an alternative case in which a classification prediction process is performed using the preset type coefficients.

Accordingly, if the user of the reception apparatus 702 selects whether the preset tap coefficients are to be used or the high performance coefficients are to be used in the filter process to be performed by the filter section 534, depending upon the details of the contract for the user of the reception apparatus 702 to receive distribution of an image from the distribution apparatus 701, then, this gives rise to a difference in picture quality of the filter image. In other words, a difference may be provided in picture quality of the filter image, for example, depending upon the price.

It is to be noted that, in FIG. 24, as the encoding apparatus 511 the distribution apparatus 701 includes, an encoding apparatus that does not perform encoding that is not prediction encoding, i.e., does not perform local decoding for generating a prediction image, can be adopted. In the encoding apparatus that does not perform local decoding, the ILF 521 used for local decoding is not required. In other words, in the encoding apparatus 511, the ILF 521 is not essentially required. In the case where the encoding apparatus 511 is configured without the ILF 521, the decoding apparatus 531 is also configured without the ILF 541. However, in the distribution apparatus 701, since it is necessary to use, in tap coefficient learning of the coefficient learning section 512, a source image and a final decoded image same as that obtained in the case where encoded data obtained by encoding the source image is decoded by the decoding apparatus 531 as a learning pair, in the case where the encoding apparatus 511 adopts an encoding apparatus that does not perform local decoding, a function for decoding encoded data obtained by the encoding apparatus 511 similarly as in the decoding apparatus 531 is required.

<Sixth Example of Configuration of Image Processing System to which Classification Prediction Filter 30 is Applied>

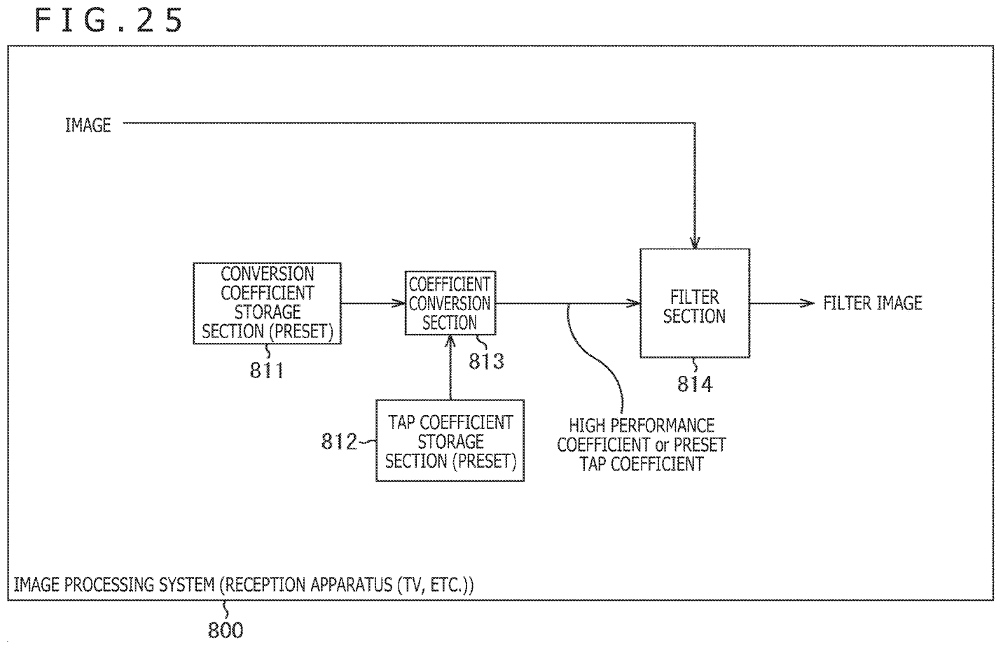

FIG. 25 is a block diagram depicting a sixth example of a configuration of an image processing system to which the classification prediction filter 30 is applied.

Referring to FIG. 25, an image processing system 800 is, for example, a reception apparatus such as a TV for receiving an image and includes a conversion coefficient storage section 811, a tap coefficient storage section 812, a coefficient conversion section 813, and a filter section 814.

The conversion coefficient storage section 811 has stored in advance therein conversion coefficients for converting preset tap coefficients (first tap coefficients) that are tap coefficients stored in the tap coefficient storage section 812 into high performance coefficients configuring a prediction expression for predicting a second image from a first image. The conversion coefficients stored in advance in the conversion coefficient storage section 811 are also referred to as preset conversion coefficients.

Here, as the second image, a predetermined image can be adopted, and as the first image, for example, an image obtained by degrading the picture quality of the second image such as an image obtained by reducing the S/N of the second image, a decoded image obtained by encoding and decoding the second image, an image obtained by blurring the second image or the like can be adopted.

The tap coefficient storage section 812 has stored in advance therein tap coefficients obtained, for example, by performing tap coefficient learning using the first image and the second image as a student image and a teacher image, respectively. The tap coefficients stored in advance in the tap coefficient storage section 812 are also referred to as preset tap coefficients.

The coefficient conversion section 813 is equivalent to the coefficient conversion section 51 of the classification prediction filter 30 (FIG. 13). The coefficient conversion section 813 uses the preset conversion coefficients stored in the conversion coefficient storage section 811, to convert the preset tap coefficients stored in the tap coefficient storage section 812 into, for example, (prediction values of) high performance coefficients having a higher degree of improvement in picture quality than the preset tap coefficients.

Then, the coefficient conversion section 813 selects the high performance coefficients obtained by converting the preset tap coefficients with use of the preset conversion coefficients or the preset tap coefficients stored in the tap coefficient storage section 812, according to an operation of the user or an instruction or the like from the outside, and supplies the selected coefficients to the filter section 814.

The filter section 814 is equivalent to the filter section 32 of the classification prediction filter 30 (FIG. 13) and functions as a post filter in a succeeding stage of an unillustrated outputting apparatus (for example, a reproduction apparatus or a decoding apparatus) that outputs an image to the image processing system 800.

The filter section 814 uses an image outputted from the outputting apparatus to the image processing system 800, as a target image of a target of a filter process, performs a filter process as a classification prediction process by using the preset tap coefficients or the high performance coefficients from the coefficient conversion section 813 to generate a filter image, and then, outputs the filter image.

In particular, in the case where the preset tap coefficients are supplied from the coefficient conversion section 813, the filter section 814 uses the preset tap coefficients to perform a classification prediction process, but in the case where the high performance coefficients are supplied from the coefficient conversion section 813, the filter section 814 uses the high performance coefficients to perform a classification prediction process.

Here, the coefficient conversion section 813 can adopt tap coefficients of different levels of performance as the high performance coefficients obtained by conversion of the preset tap coefficients using the preset conversion coefficients and the preset tap coefficients stored in the tap coefficient storage section 812.

In particular, for example, as the prediction expression including the high performance coefficients and the prediction expression including the preset tap coefficients, prediction expressions different from each other can be adopted. For example, as one of the prediction expression including the high performance coefficients or the prediction expression including the preset tap coefficients, a first-order prediction expression may be adopted, and as the other prediction expression, (a higher-order prediction expression such as) a second-order prediction expression can be adopted.

Further, as the high performance coefficients and the preset tap coefficients, tap coefficients obtained by tap coefficient learning using a learning pair in which the picture quality of at least one of a teacher image or a student image is different can be adopted.

For example, as the high performance coefficients, tap coefficients obtained by tap coefficient learning using a learning pair in which the S/N of the student image is reduced from that in a learning pair used in tap coefficient learning of the preset tap coefficients can be adopted.

It is to be noted that the preset conversion coefficients stored in the conversion coefficient storage section 811 and the preset tap coefficients stored in the tap coefficient storage section 812 can be updated as occasion demands.

<Filter Controlling Information>

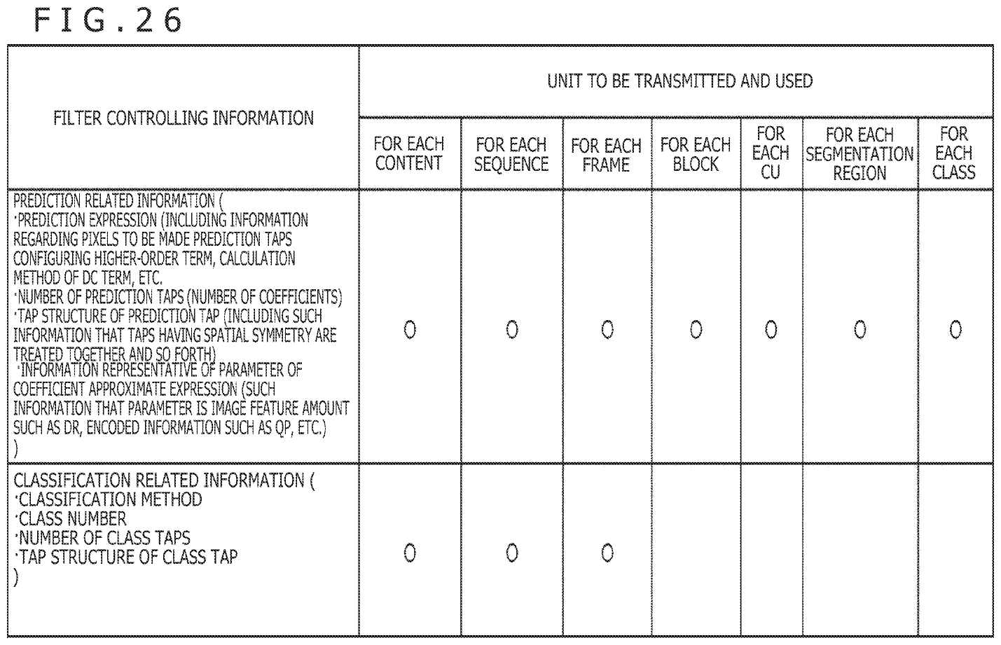

FIG. 26 is a view illustrating the filter controlling information regarding a filter process as a classification prediction process.

As the filter controlling information for a filter process as a classification prediction process, prediction related information related to a prediction process in a classification prediction process and classification related information related to classification in a classification prediction process are available.

As the prediction related information, information regarding a prediction expression (including information regarding pixels that become prediction taps configuring higher-order terms, a determination method of DC terms and so forth), the number of prediction taps (number of tap coefficients), information regarding the tap structure of prediction taps, information representative of the parameter z of a coefficient approximate expression including seed coefficients in the case where tap coefficients are calculated from such seed coefficients (information that the parameter z is an image feature amount such as a DR, that the parameter z is encoded information such as a QP or the like) and like information are available. The information regarding the tap structure of prediction taps includes such information that taps having spatial symmetry are to be treated together.

Here, in the case where prediction taps have a tap structure having spatial symmetry, for example, in the case where prediction taps have a rectangular tap structure of line symmetry vertically and horizontally, same tap coefficients can be adopted for tap coefficients to be multiplied with prediction taps at vertically line symmetrical positions or prediction taps at horizontally line symmetrical positions among prediction taps of a rectangular tap structure in a prediction expression. The information that taps having spatial symmetry are to be treated together is information representing that, in a prediction expression, same tap coefficients are adopted as tap coefficients to be multiplied with prediction taps at vertically line symmetrical positions or prediction taps at horizontally line symmetrical positions.

As the classification related information, a method of classification (classification method), information regarding a class number, the number of class taps, a tap structure of class taps and so forth are available.

For example, if the image processing system 100 that is a codec system of FIG. 15 is taken as an example, then, the prediction related information is transmitted from the encoding apparatus 101 to the decoding apparatus 102, for example, for each content of an image, for each sequence, for each frame, for each block other than a CU, for each CU, or for each segmentation region that is a segmented region of an image such as a region of an object appearing in an image. Consequently, the prediction related information can be used by the decoding apparatus 102. Further, the prediction related information can be transmitted from the encoding apparatus 101 to the decoding apparatus 102, for example, for each class and can be used in the decoding apparatus 102. In particular, for example, for the tap structure of prediction taps, tap structures that are different among different classes can be adopted.

The classification related information can, for example, be transmitted for each content, for each sequence, or for each frame of an image from the encoding apparatus 101 to the decoding apparatus 102 and can be used by the decoding apparatus 102. It is to be noted that, although the classification related information can otherwise be transmitted in a unit of an image smaller than a frame, such as for each block other than a CU, for each CU, or for each segmentation region, from the encoding apparatus 101 to the decoding apparatus 102 and can be used by the decoding apparatus 102, in the case where the classification related information is transmitted in a unit of an image smaller than a frame from the encoding apparatus 101 to the decoding apparatus 102 and used by the decoding apparatus 102, specifications of the classification are changed in such a unit of an image smaller than a frame, i.e., at a high frequency. In the case where specifications of the classification are changed at a high frequency, since the processing becomes cumbersome, it is desirable to transmit the classification related information in a unit of a size equal to or greater than that of a frame from the encoding apparatus 101 to the decoding apparatus 102 so as to be used by the decoding apparatus 102.

It is to be noted that the present technology can be applied not only to a prediction process that uses tap coefficients but also to a filter process other than a prediction process, i.e., to a filter process that uses filter coefficients other than tap coefficients.

Further, the present technology can be applied not only to a filter process that targets an image but also to a filter process that targets not an image but, for example, sound (acoustic).

In this manner, in the case where first filter coefficients are converted into second filter coefficients and a filter process is performed using the second filter coefficients or in the case where tap coefficients are converted into seed coefficients and a filter process as a classification prediction process is performed using tap coefficients obtained from a coefficient approximate expression including the seed coefficients, a filter process of a high degree of freedom depending upon what filter coefficients or seed coefficients are adopted as the second filter coefficients or the seed coefficients can be performed.

Further, by applying the classification prediction filter (FIG. 13) that converts first filter coefficients into second filter coefficients and performs a filter process using the second filter coefficients or the classification prediction filter 30 that converts tap coefficients into seed coefficients and performs a filter process as a classification prediction process using tap coefficients obtained from a coefficient approximate expression including the seed coefficients to a codec system, an image distribution system, or a reception apparatus such as a TV, the picture quality of, for example, an image outputted from an outputting apparatus or an image outputted from a post filter in a succeeding state of an outputting apparatus can be improved.

Further, by implementing a filter section for performing a classification prediction process by using a flexible hardware configuration such that a classification prediction process using various tap coefficients can be performed, a filter process as a classification prediction process having various effects of improvement of the picture quality can be performed using various conversion coefficients.

Further, since the filter section implemented by a flexible hardware configuration can perform a classification prediction process using various tap coefficients, it can be used for a long period of time.

Furthermore, where first filter coefficients standardized so as to be included into an encoded bit stream such as ILF coefficients of an existing ILF are adopted as a target of coefficient conversion and the first filter coefficients are converted into second filter coefficients unique to a manufacturer, by transmitting the conversion coefficients for converting the first filter coefficients into the second filter coefficients separately from an encoded bit stream, the reception side of the encoded bit stream can convert the first filter coefficients into the second filter coefficients without including second filter coefficients unique to the manufacturer into the encoded bit stream.

<Description of Computer to which Present Technology is Applied>

While the series of processes described above can be executed by hardware, it can otherwise be executed by software as well. In the case where the series of processes is executed by software, a program that constructs the software is installed into a computer for universal use or the like.

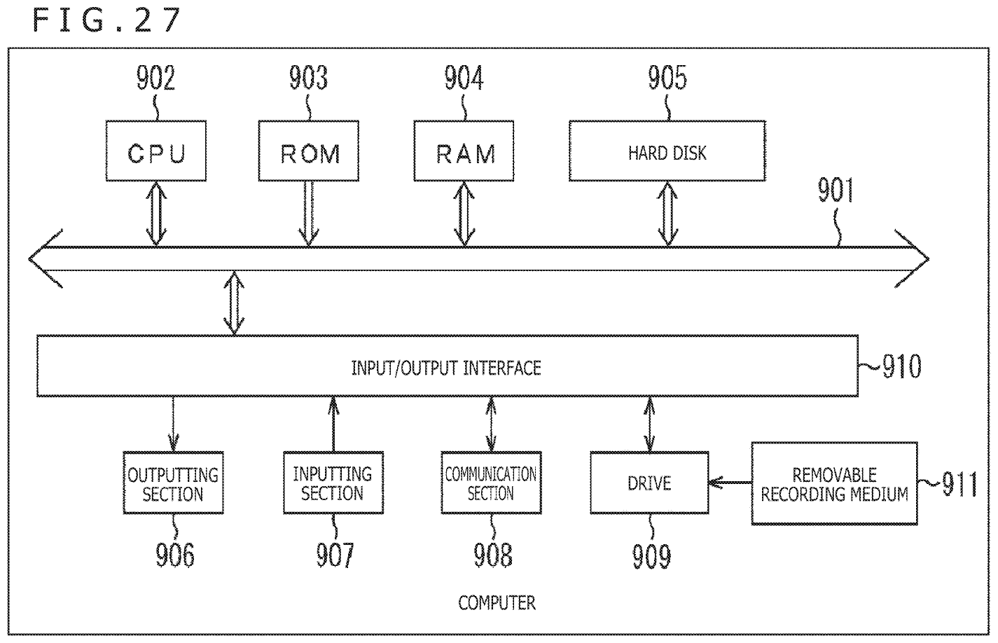

FIG. 27 is a block diagram depicting an example of a configuration of a computer into which a program for executing the series of processes described above is installed.

The program can be recorded in advance into a hard disk 905 or a ROM 903 as a recording medium built in the computer.

Alternatively, the program can be stored (recorded) in advance into a removable recording medium 911 that is driven by a drive 909. Such a removable recording medium 911 as just described can be provided as what is generally called package software. Here, as the removable recording medium 911, for example, a flexible disk, a CD-ROM (Compact Disc Read Only Memory), an MO (Magneto Optical) disk, a DVD (Digital Versatile Disc), a magnetic disk, a semiconductor memory and so forth are available.

It is to be noted that the program can not only be installed from such a removable recording medium 911 as described above into the computer but can also be downloaded into the computer through a communication network or a broadcasting network and installed into the hard disk 905 built in the computer. In particular, the program can be transferred wirelessly to the computer, for example, from a download side through an artificial satellite for digital satellite broadcasting or can be transferred by wire to the computer through a network such as a LAN (Local Area Network) or the Internet.

The computer has a CPU (Central Processing Unit) 902 built therein, and an input/output interface 910 is connected to the CPU 902 through a bus 901.

If an inputting section 907 is operated by a user or the like to input an instruction to the CPU 902 through the input/output interface 910, then, the CPU 902 executes the program stored in the ROM (Read Only Memory) 903, according to the instruction. Otherwise, the CPU 902 loads the program stored in the hard disk 905 into a RAM (Random Access Memory) 904 and executes the program.

Consequently, the CPU 902 performs the processes based on the flowcharts described hereinabove or processes performed by the configurations of the block diagrams described hereinabove. Then, the CPU 902 outputs a result of the processes from an outputting section 906, transmits the result from a communication section 908, or causes the result to be recorded on the hard disk 905, for example, through the input/output interface 910, as occasion demands.

It is to be noted that the inputting section 907 includes a keyboard, a mouse, a microphone and so forth. Meanwhile, the outputting section 906 includes an LCD (Liquid Crystal Display), a speaker and so forth.

Here, in the present specification, the processes performed according to the program by the computer need not necessarily be performed in a time series based on an order described in the flowcharts. In other words, the processes performed according to the program by the computer also include processes to be executed in parallel or individually (for example, parallel processes or processes by objects).

Further, the program may be processed by a single computer (processor) or may be processed by distributed processing by a plurality of computers. Further, the program may be transferred to and executed by a remote computer.

Furthermore, in the present specification, the term system is used to signify an aggregation of a plurality of components (devices, modules (parts) and so forth), and it does not matter whether or not all components are accommodated in the same housing. Accordingly, plural apparatuses accommodated in separate housings and connected to each other through a network are a system, and also one apparatus in which plural modules are accommodated in a single housing is a system.

It is to be noted that the embodiment of the present technology is not limited to the embodiment described hereinabove and allows various alterations without departing from the subject matter of the present technology.

For example, the present technology can assume a configuration for cloud computing by which one function is shared and cooperatively processed by plural apparatuses through a network.

Further, each of the steps described hereinabove in connection with the flowcharts can not only be executed by a single apparatus but can also be shared and executed by plural apparatuses.

Further, in the case where plural processes are included in one step, the plural processes included in the one step can not only be executed by one apparatus but can also be shared and executed by plural apparatuses.

Further, the effects described in the present specification are exemplary to the last and not limitative, and other effects may be applicable.

<Application Target of Present Technology>

The present technology can be applied to any image encoding-decoding method. In particular, specifications of various processes relating to image encoding and decoding such as conversion (inverse conversion), quantization (inverse quantization), encoding (decoding) and prediction can be selected freely and are not restricted to the examples described hereinabove unless they are contradictory to the present technology described hereinabove. Further, part of the processes may be omitted unless this is contradictory to the present technology described hereinabove.

<Processing Unit>

The data units in which various kinds of information descried hereinabove are set or the data units targeted by the various processes are exemplary and are not restricted to the examples described hereinabove. For example, such information or process may be set for each TU (Transform Unit), for each TB (Transform Block), for each PU (Prediction Unit), for each PB (Prediction Block), for each CU (Coding Unit), for each LCU (Largest Coding Unit), for each sub block, for each block, for each tile, for each slice, for each picture, for each sequence, or for each component, or data regarding such data units may be targeted. Naturally, such data unit can be set for each piece of information or for each process, and the data units for all information or all processes need not be unified. It is to be noted that the placement location of such information can be selected freely, and such information may be placed into a header, a parameter set or the like of the data units described above. Otherwise, the information may be placed in a plurality of locations.

<Control Information>

Control information relating to the present technology described hereinabove in connection with the foregoing embodiments may be transmitted from the encoding side to the decoding side. For example, control information (for example, enabled_flag) for controlling whether or not application of the present technology described above is to be permitted (or inhibited) may be transmitted. Further, for example, control information indicative of a target to which the present technology described above is to be applied (or not to be applied) may be transmitted. For example, control information for designating a block size (upper limit or lower limit or both of them), a frame, a component, a layer or the like to which the present technology is to be applied (or whether or not application is to be permitted or inhibited) may be transmitted.

<Block Size Information>

In designation of a size of a block to which the present technology is applied, a block size may be designated not only directly but also indirectly. For example, identification information for identifying a size may be used to designate a block size. Alternatively, a block size may be designated by a ratio or a difference in size to or from a block of a reference (for example, an LCU or an SCU). For example, in the case where information for designating a block size is transmitted as a syntax element or the like, as this information, information for designating a size indirectly as described hereinabove may be used. This sometimes makes it possible to reduce the information amount of the information and improve the encoding efficiency. Further, the designation of a block size includes designation of a range of the block size (for example, designation of a permissible range of the block size or the like).

<Others>

It is to be noted that the term “flag” in the present specification signifies information for identifying a plurality of states and includes not only information to be used when two states of the true (1) and the false (0) are to be identified but also information by which three or more states can be identified. Accordingly, the value that can be taken by the “flag” may be, for example, two values of I/O or may be three values or more. In other words, the bit number configuring the “flag” can be selected freely and may be 1 bit or a plurality of bits. Further, the identification information (including a flag) is assumed to have not only a form in which the identification information is included in a bit stream but also a form in which difference information of the identification information with respect to information that becomes a certain reference is included in a bit stream. Therefore, in the present specification, the “flag” and the “identification information” include not only such information as described above but also difference information of such information with respect to reference information.

It is to be noted that the present technology can assume the following configurations.

<1>

A data processing apparatus including:

a coefficient conversion section configured to convert a first filter coefficient into a second filter coefficient different from the first filter coefficient; and

a filter section configured to perform a filter process using the second filter coefficient.

<2>

The data processing apparatus according to <1>, in which

the coefficient conversion section converts the first filter coefficient into the second filter coefficient by using a conversion coefficient for converting the first filter coefficient into the second filter coefficient, and

the conversion coefficient is obtained by conversion coefficient learning that statistically minimizes an error of the second filter coefficient obtained using the conversion coefficient.

<3>

The data processing apparatus according to <1> or <2>, in which

the filter section performs, as the filter process, a prediction process of applying, to an image, a prediction expression for performing a product sum calculation between the second filter coefficient and a prediction tap that is a pixel of the image, to generate a filter image.

<4>

The data processing apparatus according to <3>, in which

the coefficient conversion section converts the first filter coefficient into the second filter coefficient whose number of the prediction taps is different from that of the first filter coefficient.

<5>

The data processing apparatus according to <3>, in which

the coefficient conversion section converts the first filter coefficient into the second filter coefficient included in a prediction expression different from a prediction expression including the first filter coefficient.

<6>

The data processing apparatus according to <3>, further including:

a classification section configured to perform classification of classifying a noticed pixel of the image into one of plural classes, in which

the coefficient conversion section converts the first filter coefficient for each class into the second filter coefficient of a class number different from that of the first filter coefficient.

<7>

The data processing apparatus according to any one of <3> to <6>, further including:

a parse section configured to parse an ILF coefficient of an ILF (In Loop Filter) used in local decoding of prediction encoding of a source image, the ILF coefficient being included in an encoded bit stream; and

a decoding section configured to decode encoded data included in the encoded bit stream and obtained by prediction encoding of the source image, to generate a decoded image, in which

the first filter coefficient includes the ILF coefficient,

the second filter coefficient includes a tap coefficient included in a prediction expression for predicting the source image from the decoded image obtained by the local decoding,

the coefficient conversion section converts the ILF coefficient into the tap coefficient, and

the decoding section includes the filter section that performs the filter process for the decoded image by using the tap coefficient.

<8>

The data processing apparatus according to <7>, in which

the parse section further parses a conversion coefficient included in the encoding bit stream and used to convert the ILF coefficient into the tap coefficient, and

the coefficient conversion section converts the ILF coefficient into the tap coefficient by using the conversion coefficient.

<9>

The data processing apparatus according to any one of <3> to <6>, further including:

a parse section configured to parse an ILF coefficient of an ILF (In Loop Filter) used in local decoding of prediction encoding of a source image, the ILF coefficient being included in an encoded bit stream,

a decoding section configured to decode encoded data included in the encoded bit stream and obtained by prediction encoding of the source image, to generate a decoded image; and

a conversion coefficient storage section configured to store a conversion coefficient for converting the first filter coefficient into the second filter coefficient, in which

the first filter coefficient includes the ILF coefficient,

the second filter coefficient includes a tap coefficient included in a prediction expression for predicting an image equivalent to the source image from an image equivalent to the decoded image obtained by the local decoding,

the coefficient conversion section converts the ILF coefficient into the tap coefficient by using the conversion coefficient stored in the conversion coefficient storage section, and

the decoding section includes the filter section that performs the filter process for the decoded image by using the tap coefficients.

<10>

The data processing apparatus according to any one of <3> to <6>, in which

the first filter coefficient includes an ILF coefficient of an ILF (In Loop Filter) of a decoding apparatus that includes the ILF for decoding encoded data obtained by prediction encoding of a source image and included in an encoded bit stream,

the second filter coefficient includes a tap coefficient included in a prediction expression for predicting the source image from a decoded image obtained by decoding the encoded data,

the coefficient conversion section converts the ILF coefficient into the tap coefficient, and

the filter section performs the filter process for the decoded image outputted from the decoding apparatus, by using the tap coefficient.

<11>

The data processing apparatus according to any one of <3> to <6>, further including:

a conversion coefficient storage section configured to store a conversion coefficient for converting the first filter coefficient into the second filter coefficient, in which

the first filter coefficient includes an ILF coefficient of an ILF (In Loop Filter) of a decoding apparatus that includes the ILF and decodes encoded data included in an encoded bit stream and obtained by prediction encoding of a source image,

the second filter coefficient includes a tap coefficient included in a prediction expression for predicting an image equivalent to the source image from an image equivalent to a decoded image obtained by decoding the encoded data,

the coefficient conversion section converts the ILF coefficient into the tap coefficient by using the conversion coefficient stored in the conversion coefficient storage section, and

the filter section performs the filter process for the decoded image outputted from the decoding apparatus, by using the tap coefficient.

<12>

The data processing apparatus according to any one of <3> to <6>, further including:

a tap coefficient storage section configured to store a first tap coefficient included in a prediction expression for predicting an image equivalent to a source image from an image equivalent to a decoded image obtained by decoding encoded data obtained by encoding the source image, in which

the first filter coefficient includes the first tap coefficient,

the second filter coefficient includes a second tap coefficient included in a prediction expression for predicting the source image from the decoded image,

the coefficient conversion section converts the first tap coefficient into the second tap coefficient, and

the filter section performs the filter process for the decoded image by using the second tap coefficient.

<13>

The data processing apparatus according to any one of <3> to <6>, further including:

a tap coefficient storage section configured to store, from between a first tap coefficient and a second tap coefficient that are included in a prediction expression for predicting a second image from a first image, the first tap coefficient; and

a conversion coefficient storage section configured to store a conversion coefficient for converting the first filter coefficient into the second filter coefficient, in which

the first filter coefficient includes the first tap coefficient,

the second filter coefficient includes the second tap coefficient,

the coefficient conversion section converts the first tap coefficient into the second tap coefficient by using the conversion coefficient stored in the conversion coefficient storage section, and

the filter section performs the filter process for the first image by using the second tap coefficient.

<14>

A data processing method including:

converting a first filter coefficient into a second filter coefficient different from the first filter coefficient; and

performing a filter process using the second filter coefficient.

<15>

A data processing apparatus including:

a coefficient conversion section configured to convert a tap coefficient included in a prediction expression that is a polynomial for predicting second data from first data into a seed coefficient included in a coefficient approximate expression that is a polynomial for approximating the tap coefficient; and

a filter section configured to perform a filter process for applying, to data, a prediction expression for performing a product sum calculation with the tap coefficient obtained from the coefficient approximate expression including the seed coefficient.

<16>

The data processing apparatus according to <15>, in which

the coefficient conversion section converts the tap coefficient included in the prediction expression for predicting a second image from a first image into the seed coefficient, and

the filter section performs the filter process that applies, to an image, the prediction expression for performing a product sum calculation between the tap coefficient obtained from the coefficient approximate expression including the seed coefficient and a prediction tap that is a pixel of the image.

<17>

A data processing method including:

converting a tap coefficient included in a prediction expression that is a polynomial for predicting second data from first data into a seed coefficient included in a coefficient approximate expression that is a polynomial for approximating the tap coefficient; and

performing a filter process for applying, to data, a prediction expression for performing a product sum calculation with the tap coefficient obtained from the coefficient approximate expression including the seed coefficient.

### REFERENCE SIGNS LIST

10 Classification prediction filter, 11 DB, 12 Filter section, 20 Classification prediction filter, 21 DB, 22 Filter section, 30 Classification prediction filter, 32 Filter section, 40 Conversion coefficient learning section, 41 DB, 51 Coefficient conversion section, 52 DB, 61 Classification section, 62 Prediction section, 100 Image processing system, 101 Encoding apparatus, 102 Decoding apparatus, 110 Encoding section, 111 ILF, 112 Coefficient learning section, 113 Conversion coefficient learning section, 120 Parse section, 121 Coefficient conversion section, 122 Decoding section, 123 Filter section, 201 A/D conversion section, 202 Sort buffer, 203 Calculation section, 204 Orthogonal transform section, 205 Quantization section, 206 Reversible encoding section, 207 Accumulation buffer, 208 Inverse quantization section, 209 Inverse orthogonal transform section, 210 Calculation section, 212 Frame memory, 213 Selection section, 214 Intra prediction section, 215 Motion prediction compensation section, 216 Prediction image selection section, 217 Rate controlling section, 301 Accumulation buffer, 302 Reversible decoding section, 303 Inverse quantization section, 304 Inverse orthogonal transform section, 305 Calculation section, 307 Sort buffer, 308 D/A conversion section, 309 Frame memory, 310 Selection section, 311 Intra prediction section, 312 Motion prediction compensation section, 313 Selection section, 400 Image processing system, 401 Encoding apparatus, 402 Decoding apparatus, 411 Conversion coefficient storage section, 500 Image processing system, 501 Distribution apparatus, 502 Reception apparatus, 511 Encoding apparatus, 521 ILF, 512 Coefficient learning section, 513 Conversion coefficient learning section, 531 Decoding apparatus, 532 Tap coefficient storage section, 541 ILF, 533 Coefficient conversion section, 534 Filter section, 561 Accumulation buffer, 562 Reversible decoding section, 563 Inverse quantization section, 564 Inverse orthogonal transform section, 565 Calculation section, 567 Sort buffer, 568 D/A conversion section, 569 Frame memory, 570 Selection section, 571 Intra prediction section, 572 Motion prediction compensation section, 573 Selection section, 600 Image processing system, 601 Distribution apparatus, 602 Reception apparatus, 621 Conversion coefficient storage section, 700 Image processing system, 701 Distribution apparatus, 702 Reception apparatus, 711 Tap coefficient storage section, 712 Conversion coefficient learning section, 721 Coefficient conversion section, 800 Image processing system, 811 Conversion coefficient storage section, 812 Tap coefficient storage section, 813 Coefficient conversion section, 814 Filter section, 901 Bus, 902 CPU, 903 ROM, 904 RAM, 905 Hard disk, 906 Outputting section, 907 Inputting section, 908 Communication section, 909 Drive, 910 Input/output interface, 911 Removable recording medium

1. A data processing apparatus comprising:
a coefficient conversion section configured to convert a first filter coefficient into a second filter coefficient different from the first filter coefficient; and
a filter section configured to perform a filter process using the second filter coefficient.

2. The data processing apparatus according to claim 1, wherein
the coefficient conversion section converts the first filter coefficient into the second filter coefficient by using a conversion coefficient for converting the first filter coefficient into the second filter coefficient, and
the conversion coefficient is obtained by conversion coefficient learning that statistically minimizes an error of the second filter coefficient obtained using the conversion coefficient.

3. The data processing apparatus according to claim 1, wherein
the filter section performs, as the filter process, a prediction process of applying, to an image, a prediction expression for performing a product sum calculation between the second filter coefficient and a prediction tap that is a pixel of the image, to generate a filter image.

4. The data processing apparatus according to claim 3, wherein
the coefficient conversion section converts the first filter coefficient into the second filter coefficient whose number of the prediction taps is different from that of the first filter coefficient.

5. The data processing apparatus according to claim 3, wherein
the coefficient conversion section converts the first filter coefficient into the second filter coefficient included in a prediction expression different from a prediction expression including the first filter coefficient.

6. The data processing apparatus according to claim 3, further comprising:
a classification section configured to perform classification of classifying a noticed pixel of the image into one of plural classes, wherein
the coefficient conversion section converts the first filter coefficient for each class into the second filter coefficient of a class number different from that of the first filter coefficient.

7. The data processing apparatus according to claim 3, further comprising:
a parse section configured to parse an ILF coefficient of an ILF (In Loop Filter) used in local decoding of prediction encoding of a source image, the ILF coefficient being included in an encoded bit stream; and
a decoding section configured to decode encoded data included in the encoded bit stream and obtained by prediction encoding of the source image, to generate a decoded image, wherein
the first filter coefficient includes the ILF coefficient,
the second filter coefficient includes a tap coefficient included in a prediction expression for predicting the source image from the decoded image obtained by the local decoding,
the coefficient conversion section converts the ILF coefficient into the tap coefficient, and
the decoding section includes the filter section that performs the filter process for the decoded image by using the tap coefficient.

8. The data processing apparatus according to claim 7, wherein
the parse section further parses a conversion coefficient included in the encoding bit stream and used to convert the ILF coefficient into the tap coefficient, and
the coefficient conversion section converts the ILF coefficient into the tap coefficient by using the conversion coefficient.

9. The data processing apparatus according to claim 3, further comprising:
a parse section configured to parse an ILF coefficient of an ILF (In Loop Filter) used in local decoding of prediction encoding of a source image, the ILF coefficient being included in an encoded bit stream,
a decoding section configured to decode encoded data included in the encoded bit stream and obtained by prediction encoding of the source image, to generate a decoded image; and
a conversion coefficient storage section configured to store a conversion coefficient for converting the first filter coefficient into the second filter coefficient, wherein
the first filter coefficient includes the ILF coefficient,
the second filter coefficient includes a tap coefficient included in a prediction expression for predicting an image equivalent to the source image from an image equivalent to the decoded image obtained by the local decoding,
the coefficient conversion section converts the ILF coefficient into the tap coefficient by using the conversion coefficient stored in the conversion coefficient storage section, and
the decoding section includes the filter section that performs the filter process for the decoded image by using the tap coefficients.

10. The data processing apparatus according to claim 3, wherein
the first filter coefficient includes an ILF coefficient of an ILF (In Loop Filter) of a decoding apparatus that includes the ILF for decoding encoded data obtained by prediction encoding of a source image and included in an encoded bit stream,
the second filter coefficient includes a tap coefficient included in a prediction expression for predicting the source image from a decoded image obtained by decoding the encoded data,
the coefficient conversion section converts the ILF coefficient into the tap coefficient, and
the filter section performs the filter process for the decoded image outputted from the decoding apparatus, by using the tap coefficient.

11. The data processing apparatus according to claim 3, further comprising:
a conversion coefficient storage section configured to store a conversion coefficient for converting the first filter coefficient into the second filter coefficient, wherein
the first filter coefficient includes an ILF coefficient of an ILF (In Loop Filter) of a decoding apparatus that includes the ILF and decodes encoded data included in an encoded bit stream and obtained by prediction encoding of a source image,
the second filter coefficient includes a tap coefficient included in a prediction expression for predicting an image equivalent to the source image from an image equivalent to a decoded image obtained by decoding the encoded data,
the coefficient conversion section converts the ILF coefficient into the tap coefficient by using the conversion coefficient stored in the conversion coefficient storage section, and
the filter section performs the filter process for the decoded image outputted from the decoding apparatus, by using the tap coefficient.

12. The data processing apparatus according to claim 3, further comprising:
a tap coefficient storage section configured to store a first tap coefficient included in a prediction expression for predicting an image equivalent to a source image from an image equivalent to a decoded image obtained by decoding encoded data obtained by encoding the source image, wherein
the first filter coefficient includes the first tap coefficient,
the second filter coefficient includes a second tap coefficient included in a prediction expression for predicting the source image from the decoded image,
the coefficient conversion section converts the first tap coefficient into the second tap coefficient, and
the filter section performs the filter process for the decoded image by using the second tap coefficient.

13. The data processing apparatus according to claim 3, further comprising:
a tap coefficient storage section configured to store, from between a first tap coefficient and a second tap coefficient that are included in a prediction expression for predicting a second image from a first image, the first tap coefficient; and
a conversion coefficient storage section configured to store a conversion coefficient for converting the first filter coefficient into the second filter coefficient, wherein
the first filter coefficient includes the first tap coefficient,
the second filter coefficient includes the second tap coefficient,
the coefficient conversion section converts the first tap coefficient into the second tap coefficient by using the conversion coefficient stored in the conversion coefficient storage section, and
the filter section performs the filter process for the first image by using the second tap coefficient.

14. A data processing method comprising:
converting a first filter coefficient into a second filter coefficient different from the first filter coefficient; and
performing a filter process using the second filter coefficient.

15. A data processing apparatus comprising:
a coefficient conversion section configured to convert a tap coefficient included in a prediction expression that is a polynomial for predicting second data from first data into a seed coefficient included in a coefficient approximate expression that is a polynomial for approximating the tap coefficient; and
a filter section configured to perform a filter process for applying, to data, a prediction expression for performing a product sum calculation with the tap coefficient obtained from the coefficient approximate expression including the seed coefficient.

16. The data processing apparatus according to claim 15, wherein
the coefficient conversion section converts the tap coefficient included in the prediction expression for predicting a second image from a first image into the seed coefficient, and
the filter section performs the filter process that applies, to an image, the prediction expression for performing a product sum calculation between the tap coefficient obtained from the coefficient approximate expression including the seed coefficient and a prediction tap that is a pixel of the image.

17. A data processing method comprising:
converting a tap coefficient included in a prediction expression that is a polynomial for predicting second data from first data into a seed coefficient included in a coefficient approximate expression that is a polynomial for approximating the tap coefficient; and
performing a filter process for applying, to data, a prediction expression for performing a product sum calculation with the tap coefficient obtained from the coefficient approximate expression including the seed coefficient.
